(19) United States
(12) Patent Application Publication
(10) Pub. No.: US 2023/0052638 A1
(43) Pub. Date: Feb. 16, 2023

(54) SYSTEMS AND METHODS FOR PROPOSAL COMMUNICATION IN A TASK DETERMINATION SYSTEM

(71) Applicant: Yohana LLC, Palo Alto, CA (US)

(72) Inventors: Yoky Matsuoka, Los Altos Hills, CA (US); Defne Civelekoglu, Berkeley, CA (US); Gwendolyn W. van der Linden, Redwood City, CA (US); Nitin Viswanathan, San Francisco, CA (US); David L. Warner, Woodside, CA (US); Lingyun Liu, Sunnyvale, CA (US); Benjamin Deming, Campbell, CA (US); Sean Paterson, Mountain View, CA (US)

(21) Appl. No.: 17/819,432

(22) Filed: Aug. 12, 2022

Related U.S. Application Data
(60) Provisional application No. 63/232,416, filed on Aug. 12, 2021.

(51) Int. Cl. G06Q 10/06

(52) U.S. Cl. CPC G06Q 10/063112

(57) ABSTRACT

Systems and methods for communicating proposals in a task determination system are provided. The task determination system can generate in real-time a set of proposals corresponding to a task. The set of proposals are generated based on a task type and a member profile associated with a member for whom the task is being performed. The task determination system generates a ranking of the set of proposals based on suitability metrics between the task and the set of proposals. Based on the ranking and these suitability metrics, one or more proposals are selected for presentation to the member. The member profile associated with the member can be updated in real-time as the member interacts with the one or more proposals.

### CROSS-REFERENCE TO RELATED APPLICATIONS

The present patent application claims the priority benefit of U.S. Provisional Patent Application 63/232,416 Filed Aug. 12, 2021, the disclosures of which are incorporated by reference herein.

### FIELD

The present disclosure relates generally to determination and delegation of tasks and the communication of proposals for satisfying requirements associated with those tasks. In one example, the systems and methods described herein may be used to communicate, to a member, proposals for performing tasks that may be performed for the benefit of the member. Further, the systems and methods described herein may be used to provide automated coordination for the communication of proposals to perform tasks for the benefit of the member.

### SUMMARY

Disclosed embodiments may provide a framework to communicate proposals linked to tasks so that various actions may be performed for the benefit of a member. According to some embodiments, a computer-implemented method is provided. The computer-implemented method comprises receiving a completed task template corresponding to a task associated with a member. The completed task template is associated with a task type. The computer-implemented method further comprises automatically generating in real-time a set of proposals corresponding to the task. The set of proposals are automatically generated based on the task type and a member profile associated with the member. The computer-implemented method further comprises generating a ranking of the set of proposals. The ranking is generated based on suitability metrics between the task and the set of proposals. The computer-implemented method further comprises selecting one or more proposals from the set of proposals. The one or more proposals are selected based on the ranking and the suitability metrics. The computer-implemented method further comprises providing the one or more proposals. The computer-implemented method further comprises updating the member profile in real-time based on member interaction with the one or more proposals.

In some embodiments, the computer-implemented method further comprises automatically processing the member profile in real-time to determine the suitability metrics between the task and the set of proposals.

In some embodiments, the one or more proposals are further selected based on a pre-defined number of proposals presentable for the task. Further, the pre-defined number is determined based on the member profile.

In some embodiments, the computer-implemented method further comprises automatically designating a preferred proposal from the one or more proposals. The preferred proposal is automatically designated based on the ranking, the suitability metrics, and the member profile

In some embodiments, the computer-implemented method further comprises providing the suitability metrics with the one or more proposals.

In some embodiments, the computer-implemented method further comprises monitoring the member interaction with the one or more proposals in real-time to determine one or more preferences corresponding to a presentation of the one or more proposals. The computer-implemented method further comprises automatically updating the member profile based on the one or more preferences.

In some embodiments, the computer-implemented method further comprises detecting a modification to a subset of the set of proposals. The computer-implemented method further comprises automatically updating the ranking in real-time based on the modification.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a task facilitation service assigns a representative to a member through which various tasks performable for the benefit of the member can be recommended for performance by the representative and/or one or more third-party services in accordance with various embodiments;

FIG. 2 shows an illustrative example of an environment in which task-related data is collected and aggregated from a member area to identify one or more tasks that can be recommended to the member for performance by a representative and/or third-party services in accordance with at least one embodiment;

FIG. 3 shows an illustrative example of an environment in which a task coordination system assigns and monitors performance of a task for the benefit of a member by a representative and/or one or more third-party services in accordance with at least one embodiment;

FIG. 4 shows an illustrative example of a process for generating a proposal and monitoring member interaction with the generated proposal in accordance with at least one embodiment;

FIG. 5 shows an illustrative example of an environment in which a proposal related to a task is generated in accordance with at least one embodiment;

FIG. 6 shows an illustrative example of an environment in which relationships between projects, task components, proposal options, proposal templates, and proposal recommendations are shown in accordance with at least one embodiment;

FIG. 7 shows an illustrative example of an environment in which relationships between projects, tasks, proposals, and proposal recommendations are shown in accordance with at least one embodiment;

FIGS. 8A-8B show an illustrative example of an environment in which ranked proposals are communicated to a member in accordance with at least one embodiment;

FIG. 9 shows an illustrative example of a process for communicating proposal recommendations in accordance with at least one embodiment;

FIG. 10 shows an illustrative example of an environment in which in which a proposal is generated in accordance with at least one embodiment;

FIG. 11 shows an illustrative example of an environment in which proposal recommendations are edited in accordance with at least one embodiment;

FIG. 12 shows an illustrative example of an environment in which proposals are compared and ranked in accordance with at least one embodiment;

FIG. 13 shows an illustrative example of an environment in which preferred and alternate proposals are communicated to a member in accordance with at least one embodiment;

FIG. 14 shows an illustrative example of an environment in which proposals and the associated project are communicated to a member in accordance with at least one embodiment;

FIG. 15 shows an illustrative example of a process for ranking and communicating proposals to a member in accordance with at least one embodiment;

FIG. 16 shows an illustrative example of an environment in which communicated proposals are received by a member in accordance with at least one embodiment;

FIG. 17 shows an illustrative example of an environment in which a communicated proposal is received by a member in accordance with at least one embodiment; and

FIG. 18 shows a computing system architecture, including various components in electrical communication with each other, in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

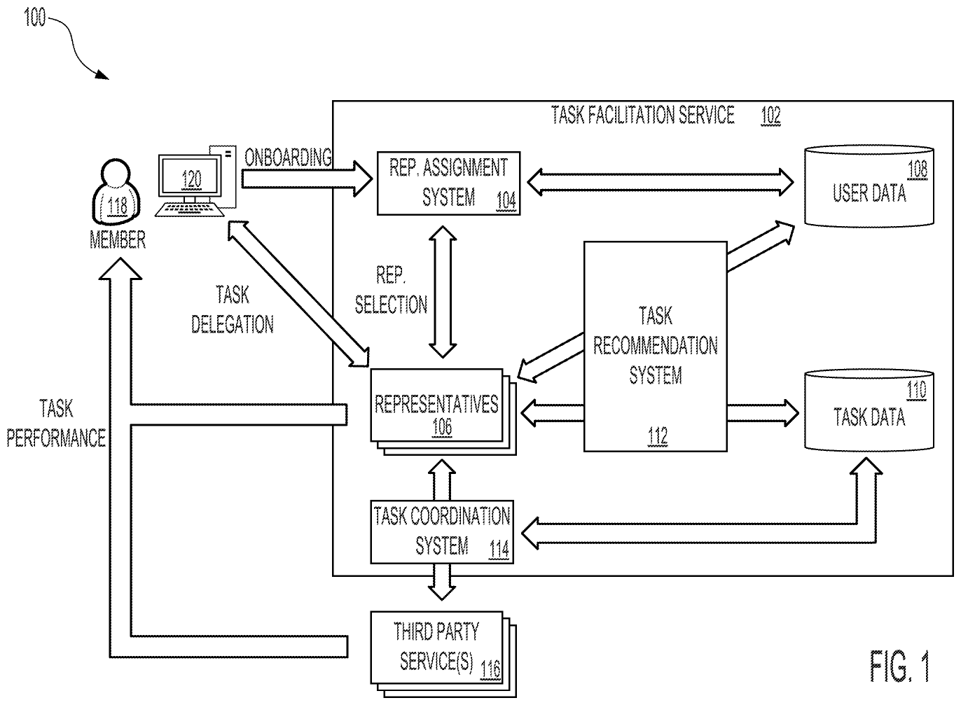

Additionally, in the appended figures, similar components and/or features may refer back to an earlier described component. For example, a component and/or feature may be described as “ . . . the representative 406 (which is the same as the representative 106 described herein at least in connection with FIG. 1) . . . ” Such references are bi-directional in that, a later reference back such as “ . . . the representative 706 (which is the same as the representative 106 described herein at least in connection with FIG. 1) . . . ” is indicative that components and/or features described with respect to representative 106 and with respect to representative 406 are both incorporated into the components and/or features of representative 706 and vice versa.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to communicate proposals linked to tasks so that various actions may be performed for the benefit of a member. Through this framework, a member may be assigned with a representative that, over time, may learn about the member's preferences and behavior. Those preferences and behaviors can then be used to communicate recommended proposals for performing tasks, whereupon the proposals can be used to guide actions that can be performed on the member's behalf, thereby reducing the member's cognitive load for accomplishing tasks. Further, as the representative develops a relationship with the member over time, the representative can also communicate proposals curated specifically to the member's preferences, propose curated experiences for the member, and propose actions to assist the member in achieving personal goals and ambitions.

FIG. 1 shows an illustrative example of an environment 100 in which a task facilitation service 102 assigns a representative 106 to a member 118 through which various tasks performable for the benefit of the member 118 can be recommended for performance by the representative 106 and/or one or more third-party services 116 in accordance with various embodiments. The task facilitation service 102 may be implemented to reduce the cognitive load on members and their families in performing various tasks in and around their homes by identifying and delegating tasks to representatives 106 that may coordinate performance of these tasks for the benefit of these members. In an embodiment, a member 118, via a computing device 120 (e.g., a laptop computer, smartphone, etc.), may submit a request to the task facilitation service 102 to initiate an onboarding process for assignment of a representative 106 to the member 118 and to initiate identification of tasks that are performable for the benefit of the member 118. For instance, the member 118 may access the task facilitation service 102 via an application provided by the task facilitation service 102 and installed onto a computing device 120. Additionally, or alternatively, the task facilitation service 102 may maintain a web server (not shown) that hosts one or more websites configured to present or otherwise make available an interface through which the member 118 may access the task facilitation service 102 and initiate the onboarding process.

During the onboarding process, the task facilitation service 102 may collect identifying information of the member 118, which may be used by a representative assignment system 104 to identify and assign a representative 106 to the member 118. For instance, the task facilitation service 102 may provide, to the member 118, a survey or questionnaire through which the member 118 may provide identifying information usable by the representative assignment system 104 to select a representative 106 for the member 118. For instance, the task facilitation service 102 may prompt the member 118 to provide detailed information with regard to the composition of the member's family (e.g., number of inhabitants in the member's home, the number of children in the member's home, the number and types of pets in the member's home, etc.), the physical location of the member's home, any special needs or requirements of the member 118 (e.g., physical or emotional disabilities, etc.), and the like. In some instances, the member 118 may be prompted to provide demographic information (e.g., age, ethnicity, race, languages written/spoken, etc.). The member 118 may also be prompted to indicate any personal interests or hobbies that may be used to identify possible experiences that may be of interest to the member 118 (described in greater detail herein).

In an embodiment, the member's identifying information, as well as any information related to the member's level of comfort or interest in delegating different categories of tasks to others, is provided to a representative assignment system 104 of the task facilitation service 102 to identify a representative 106 that may be assigned to the member 118. The representative assignment system 104 may be implemented using a computer system or as an application or other executable code implemented on a computer system of the task facilitation service 102. The representative assignment system 104, in an embodiment, uses the member's identifying information, any information related to the member's level of comfort or interest in delegating tasks to others, and any other information obtained during the onboarding process as input to a classification or clustering algorithm configured to identify representatives that may be well-suited to interact and communicate with the member 118 in a productive manner.

Once the representative assignment system 104 has identified a set of representatives 106 that may be assigned to the member 118 to serve as an assistant or concierge for the member 118, the representative assignment system 104 may evaluate data corresponding to each representative of the set of representatives 106 to identify a particular representative that can be assigned to the member 118. For instance, the representative assignment system 104 may rank each representative of the set of representatives 106 according to degrees or vectors of similarity between the member's and representative's demographic information. For instance, if a member and a particular representative share a similar background (e.g., attended university in the same city, are from the same hometown, share particular interests, etc.), the representative assignment system 104 may rank the particular representative higher compared to other representatives that may have less similar backgrounds. Similarly, if a member and a particular representative are within geographic proximity to one another, the representative assignment system 104 may rank the particular representative higher compared to other representatives that may be further away from the member 118. Each factor, in some instances, may be weighted based on the impact of the factor on the creation of a positive, long-term relationship between members and representatives.

In an embodiment, the representative assignment system 104 uses the ranking of the set of representatives 106 to select a representative that may be assigned to the member 118. For instance, the representative assignment system 104 may select the highest ranked representative and determine the representative's availability to engage the member 118 in identifying and recommending tasks, coordinating resolution of tasks, and otherwise communicating with the member 118 to assure that their needs are addressed. If the selected representative is unavailable (e.g., the representative is already engaged with one or more other members, etc.), the representative assignment system 104 may select another representative according to the aforementioned ranking and determine the availability of this representative to engage the member 118. This process may be repeated until a representative is identified from the set of representatives 106 that is available to engage the member 118.

In an embodiment, the representative assignment system 104 can select a representative from the set of representatives 106 based on information corresponding to the availability of each representative. For instance, the representative assignment system 104 may automatically select the first available representative from the set of representatives 106. In some instances, the representative assignment system 104 may automatically select the first available representative that satisfies one or more criteria corresponding to the member's identifying information. For example, the representative assignment system 104 may automatically select an available representative that is within geographic proximity of the member 118, shares a similar background as that of the member 118, and the like.

In an embodiment, the data associated with the member 118 is used by the task facilitation service 102 to create a member profile corresponding to the member 118. As noted above, the task facilitation service 102 may provide, to the member 118, a survey or questionnaire through which the member 118 may provide identifying information associated with the member 118. The responses provided by the member 118 to this survey or questionnaire may be used by the task facilitation service 102 to generate an initial member profile corresponding to the member 118. In an embodiment, once the representative assignment system 104 has assigned a representative to the member 118, the task facilitation service 102 can prompt the member 118 to generate a new member profile corresponding to the member 118. For instance, the task facilitation service 102 may provide the member 118 with a survey or questionnaire that includes a set of questions that may be used to supplement the information previously provided during the aforementioned onboarding process. For example, through the survey or questionnaire, the task facilitation service 102 may prompt the member 118 to provide additional information about family members, important dates (e.g., birthdays, etc.), dietary restrictions, and the like. Based on the responses provided by the member 118, the task facilitation service 102 may update the member profile corresponding to the member 118.

In an embodiment, once the representative assignment system 104 has assigned a particular representative to the member 118, the representative assignment system 104 notifies the member 118 and the particular representative of the pairing. Further, the representative assignment system 104 may establish a chat session or other communications session between the member 118 and the assigned representative to facilitate communications between the member 118 and representative. For instance, via an application provided by the task facilitation service 102 and installed on the computing device 120 or through a web portal provided by the task facilitation service 102, the member 118 may exchange messages with the assigned representative over the chat session or other communication session. Similarly, the representative may be provided with an interface through which the representative may exchange messages with the member 118.

In some instances, the member 118 may initiate or otherwise resume a chat session with an assigned representative. For example, via the application provided by the task facilitation service 102 or through a web portal provided by the task facilitation service 102, the member may transmit a message to the representative over the chat session or other communication session to communicate with the representative. The member 118 can submit a message to the representative to indicate that the member 118 would like assistance with a particular task or project. As an illustrative example, the member 118 can submit a message to the representative to indicate that the member 118 would like the representative's assistance with regard to an upcoming move to Bayamon in the coming months. The representative, via an interface provided by the task facilitation service 102, may be presented with the submitted message. Accordingly, the representative may evaluate the message and generate a corresponding task that is to be performed to assist the member 118. For instance, the representative, via the interface provided by the task facilitation service 102, may access a task template, through which the representative may provide information related to the task or project. The information may include information related to the member 118 (e.g., member name, member address, etc.) as well as various parameters of the task itself (e.g., allocated budget, timeframe for completion of the task, and the like). The parameters of the task may further include any member preferences (e.g., preferred brands, preferred third-party services 116, etc.). In some instances, the information may be provided through a member profile associated with the member 118. For instance, the representative may access the member profile associated with the member 118 to obtain the information related to the member 118. In an embodiment, the task facilitation service 102 can automatically populate the task template using the member profile.

In an embodiment, the representative can provide the information obtained from the member 118 for the task specified in the one or more messages exchanged between the member 118 and representative to a task recommendation system 112 of the task facilitation service 102 to dynamically, and in real-time, identify any additional task parameters that may be required for generating one or more proposals for completion of the task. The task recommendation system 112 may be implemented using a computer system or as an application or other executable code implemented on a computer system of the task facilitation service 102. The task recommendation system 112, in an embodiment, provides the representative with an interface through which the representative may generate a task that may be presented to the member over a communications session corresponding to the task (e.g., via the application or web portal utilized by the member 118, etc.) and that may be completed by the representative and/or one or more third-party services 116 for the benefit of the member 118. For instance, the representative may provide a name for the task, any known parameters of the task as provided by the member (e.g., budgets, timeframes, task operations to be performed, etc.), and the like. As an illustrative example, if the member 118 transmits the message “Hey Russell, can you help with our move to Bayamon in 2 months,” the representative may evaluate the message and generate a task entitled “Move to Bayamon.” For this task, the representative may indicate that the timeframe for completion of the task is two months, as indicated by the member 118. Further, the representative may add additional information known to the representative about the member, as determined through the representative's own knowledge or through review of the member profile. For example, the representative may indicate any preferred moving companies, any budgetary constraints, and the like.

In an embodiment, the representative can provide the generated task to the task recommendation system 112 to determine whether additional member input is needed for creation of a proposal that may be presented to the member for completion of the task. The task recommendation system 112, for instance, may process the generated task and information corresponding to the member 118 from the user data storage 108 using a machine learning algorithm or artificial intelligence to automatically identify additional parameters for the task, as well as any additional information that may be required from the member 118 for the generation of proposals. For instance, the task recommendation system 112 may use the generated task, information corresponding to the member 118 (e.g., the member profile), and historical data corresponding to tasks performed for other similarly situated members as input to the machine learning algorithm or artificial intelligence to identify any additional parameters that may be automatically completed for the task and any additional information that may be required of the member 118 for defining the task. For example, if the task is related to an upcoming move to another city, the task recommendation system 112 may utilize the machine learning algorithm or artificial intelligence to identify similarly situated members (e.g., members within the same geographic area of member 118, members having similar task delegation sensibilities, members having performed similar tasks, etc.). Based on the task generated for the member 118, characteristics of the member 118 from the member profile stored in the user data storage 108 and data corresponding to these similarly situated members, the task recommendation system 112 may provide additional parameters for the task. As an illustrative example, for the aforementioned task, “Move to Bayamon,” the task recommendation system 112 may provide a recommended budget for the task, one or more moving companies that the member 118 may approve of (as used by other similarly situated members with positive feedback), and the like. The representative may review these additional parameters and select one or more of these parameters for inclusion in the task.

In an embodiment the task recommendation system 112 can use information in the task data storage 110 regarding the third-party services 116 to generate proposal recommendations for a task (e.g., information generated by the task coordination system 114 and stored in the task data storage 110). For example, previous performance on one or more previous tasks that are the same as, or similar to, a task may be used to determine the suitability of recommending a particular third-party or other entity associated with the task facilitation service 102 to perform a task. Such suitability may be referred to herein as a “suitability metric” and may be used herein to refer to the suitability of any recommendation from the task facilitation service that may be presented to a member. Similarly, other information about the third-party services 116 may be used to determine the suitability of recommending a particular third-party or other entity associated with the task facilitation service 102 to perform a task. For example, comparing the location of the third-party or other entity associated with the task facilitation service 102 to a location where the task is to be performed (e.g., the member's home) may be used to determine the suitability of recommending that third-party or other entity associated with the task facilitation service 102 to perform the task. Similarly, where budgetary considerations are a determining factor in performing a task, the task recommendation system 112 may use the previous and/or current rate of a particular third-party or other entity associated with the task facilitation service 102 stored in the task data storage 110 to determine the suitability of recommending that third-party or other entity associated with the task facilitation service 102 to perform the task.

In some embodiments, parameters associated with a particular third-party or other entity associated with the task facilitation service 102 can be compared against similar parameters of other third parties and other entities associated with the task facilitation service 102 to determine the suitability of recommending that third-party or other entity associated with the task facilitation service 102 to perform the task. For example, the cost associated with a particular third-party or other entity associated with the task facilitation service 102 as compared to the cost associated with other third parties and other entities associated with the task facilitation service 102 may be used by the task recommendation system 112 to determine the suitability of recommending that third-party or other entity associated with the task facilitation service 102 to perform the task. In another example, the cost associated with a particular third-party or other entity associated with the task facilitation service 102 as compared to the average cost of all other third parties and other entities associated with the task facilitation service 102 may be used by the task recommendation system 112 to determine the suitability of recommending that third-party or other entity associated with the task facilitation service 102 to perform the task. In an embodiment, the task recommendation system 112 can coordinate with the task coordination system 114 to determine the suitability of a particular third-party or other entity associated with the task facilitation service 102 to perform a task and/or to provide proposal recommendations for that task.

If the task recommendation system 112 determines that additional member input is required for the task, the task recommendation system 112 may provide the representative with recommendations for questions that may be presented to the member 118 regarding the task. Returning to the “Move to Bayamon” task example, if the task recommendation system 112 determines that it is important to understand one or more parameters of the member's home (e.g., square footage, number of rooms, etc.) for the task, the task recommendation system 112 may provide a recommendation to the representative to prompt the member 118 to provide these one or more parameters. The representative may review the recommendations provided by the task recommendation system 112 and, via a task-specific interface corresponding to the project or task, prompt the member 118 to provide the additional task parameters. This process may reduce the number of prompts provided to the member 118 in order to define a particular task, thereby reducing the cognitive load on the member 118. In some instances, rather than providing the representative with recommendations for questions that may be presented to the member 118 regarding the task, the task recommendation system 112 can automatically present these questions to the member 118 via the task-specific interface corresponding to the project or task. For instance, if the task recommendation system 112 determines that a question related to the square footage of the member's home is required for the task, the task recommendation system 112 may automatically prompt the member 118, via the task-specific interface corresponding to the project or task, to provide the square footage for the member's home.

In an embodiment, once the representative has obtained the necessary task-related information from the member 118 and/or through the task recommendation system 112 (e.g., task parameters garnered via evaluation of tasks performed for similarly situated members, task parameters garnered from the member profile associated with the member 118, etc.), the representative can utilize a task coordination system 114 of the task facilitation service 102 to generate one or more proposals for resolution of the task. The task coordination system 114 may be implemented using a computer system or as an application or other executable code implemented on a computer system of the task facilitation service 102. In some examples, the representative may utilize a resource library maintained by the task coordination system 114 to identify one or more third-party services 116 and/or resources (e.g., retailers, restaurants, websites, brands, types of goods, particular goods, etc.) that may be used for performance of the task for the benefit of the member 118 according to the one or more task parameters identified by the representative and the task recommendation system 112, as described above. A proposal may specify a timeframe for completion of the task, identification of any third-party services 116 or other entities associated with the task facilitation service 102 (if any) that are to be engaged for completion of the task, a budget estimate for completion of the task, resources or types of resources to be used for completion of the task, and the like. The representative may present the proposal to the member 118 via the task-specific interface corresponding to the project or task to solicit a response from the member 118 to either proceed with the proposal or to provide an alternative proposal for completion of the task.

In an embodiment, the task recommendation system 112 can provide the representative with a recommendation as to whether the representative should provide the member 118 with a proposal and provide the member with an option to defer to the representative with regard to completion of the defined task. For instance, in addition to providing member and task-related information to the task recommendation system 112 to identify additional parameters for the task, the representative may indicate its recommendation to the task recommendation system 112 to either present the member 118 with one or more proposals for completion of the task and to either present or omit an option to defer to the representative for completion of the task. The task recommendation system 112 may utilize the machine learning algorithm or artificial intelligence to generate the aforementioned recommendation. The task recommendation system 112 may utilize the information provided by the representative, as well as data for similarly situated members from the user data storage 108 and task data corresponding to similar tasks from a task data storage 110 (e.g., tasks having similar parameters to the submitted task, tasks performed on behalf of similarly situated members, etc.), to determine whether to recommend presentation of one or more proposals for completion of the task and whether to present the member 118 with an option to defer to the representative for completion of the task.

If the representative determines that the member is to be presented with an option to defer to the representative for completion of the task, the representative may present this option to the member over the chat session. The option may be presented in the form of a button or other graphical user interface (GUI) element that the member may select to indicate its approval of the option. For example, the member may be presented with a “Run With It” button to provide the member with an option to defer all decisions related to performance of the task to the representative. If the member 118 selects the option, the representative present a proposal that has been selected by the representative for completion of the task on behalf of the member 118 and may proceed to coordinate with one or more third-party services 116 for performance and completion of the task according to the proposal. Thus, rather than allowing the member 118 to select a particular proposal for completion of the task, the representative may instead select a particular proposal on behalf of the member 118. The proposal may still be presented to the member 118 in order for the member 118 to verify how the task is to be completed. Any actions taken by the representative on behalf of the member 118 for completion of the task may be recorded in an entry corresponding to the task in the task data storage 110. Alternatively, if the member 118 rejects the option and instead indicates that the representative is to provide one or more proposals for completion of the task, the representative may generate one or more proposals, as described above.

In an embodiment, a representative may recommend one or more curated experiences that may be appealing to the member 118 to take their mind off of urgent matters and to spend more time on themselves and their families. As noted above, during an onboarding process, a member 118 may be prompted to indicate any of its interests or hobbies that the member 118 finds enjoyable. Further, as the representative continues its interactions with the member 118 over the chat session, the representative may prompt the member 118 to provide additional information regarding its interests in a natural way. For instance, a representative may ask the member 118 “what will you be doing this weekend?” Based on the member response, the representative may update the member profile corresponding to the member 118 to indicate the member's preferences. Thus, over time, the representative and the task facilitation service 102 may develop a deeper understanding of the member's interests and hobbies.

In an embodiment, the task facilitation service 102 generates, in each geographic market in which the task facilitation service 102 operates, a set of experiences that may be available to members. For each available experience, the task facilitation service 102 can generate a template that includes both the information required from a member 118 to plan the experience on behalf of the member 118 and a skeleton of what the proposal for the experience recommendation will look like when presented to the member 118. This may make it easier for a representative to complete definition of task(s) associated with the experience. In some instances, the template may incorporate data from various sources that provide high-quality recommendations, such as travel guides, food and restaurant guides, reputable publications, and the like.

In an embodiment, the task recommendation system 112, periodically (e.g., monthly, bi-monthly, etc.) or in response to a triggering event (e.g., a set number of tasks are performed, member request, etc.), selects a set of experiences that may be recommended to the member 118. If the member 118 selects a particular experience recommendation corresponding to an experience that the member 118 would like to have curated on its behalf, the task recommendation system 112 or representative may generate one or more new tasks related to the curation of the selected experience recommendation.

Similar to the process described above for the completion of a task for the benefit of a member 118, the representative can generate one or more proposals for curation of a selected experience. For instance, the representative may generate a proposal that provides, amongst other things, a list of days/times for the experience, a list of possible venues for the experience (e.g., parks, movie theaters, hiking trails, etc.), a list of possible meal options and corresponding prices, options for delivery or pick-up of meals, and the like. The various options in a proposal may be presented to the member 118 via a task-specific interface corresponding to the selected experience.

Based on the member responses to the various options presented in the proposal, representative may indicate that it is starting the curation process for the experience. Further, the representative may provide information related to the experience that may be relevant to the member 118. For example, if the member 118 has selected an option to pick-up food from a selected restaurant for a weekend picnic, the representative may provide detailed driving directions from the member's home to the restaurant to pick up the food (this would not be presented if the member 118 had selected a delivery option), detailed driving directions from the restaurant to the selected venue, parking information, a listing of the food that is to be ordered, and the total price of the food order. The member 118 may review this proposal and may determine whether to accept the proposal. If the member 118 accepts the proposal, the representative may proceed to perform various tasks to curate the selected experience.

Once a member 118 has selected a particular proposal for a particular task, or has selected a button or other GUI element associated with the particular task to indicate that it wishes to defer to the representative for performance of the task, if the task is to be completed using third-party services 116, the representative may coordinate with one or more third-party services 116 for completion of the task for the benefit of the member 118. For instance, the representative may utilize a task coordination system 114 of the task facilitation service 102 to identify and contact one or more third-party services 116 for performance of a task. As noted above, the task coordination system 114 may include a resource library that includes detailed information related to third-party services 116 and other entities that may be available for the performance of tasks on behalf of members of the task facilitation service 102. For example, an entry for a third-party service in the resource library may include contact information for the third-party service, any available price sheets for services or goods offered by the third-party service, listings of goods and/or services offered by the third-party service, hours of operation, ratings or scores according to different categories of members, and the like. The representative may query the resource library to identify the one or more third-party services that are to perform the task and determine an estimated cost for performance of the task. In some instances, the representative may contact the one or more third-party services 116 to obtain quotes for completion of the task and to coordinate performance of the task for the benefit of the member 118.

In some instances, the resource library may further include detailed information corresponding to other services and other entities that may be associated or affiliated with the task facilitation service 102 and that are contracted to perform various tasks on behalf of members of the task facilitation service 102. These other services and other entities may provide their services or goods at rates agreed upon with the task facilitation service 102. Thus, if the representative selects any of these other services or other entities from the resource library, the representative may be able to determine the particular parameters (e.g., price, availability, time required, etc.) for completion of the task.

In an embodiment, for a given task, the representative can query the resource library to identify one or more third-party services and other services/entities affiliated with the task facilitation service 102 from which to solicit quotes for completion of the task. For instance, for a newly created task, the representative may transmit a job offer to these one or more third-party services and other services/entities. The job offer may indicate various characteristics of the task that is to be completed (e.g., scope of the task, general geographic location of the member 118 or of where the task is to be completed, desired budget, etc.). Through an application or web portal provided by the task facilitation service 102, a third-party service or other service/entity may review the job offer and determine whether to submit a quote for completion of the task or to decline the job offer. If a third-party service or other service/entity opts to reject the job offer, the representative may receive a notification indicating that the third-party service or other service/entity has declined the job offer. Alternatively, if a third-party service or other service/entity opts to bid to perform the task (e.g., accepts the job offer), the third-party service or other service/entity may submit a quote for completion of the task. This quote may indicate the estimated cost for completion of the task, the time required for completion of the task, the estimated date in which the third-party service or other service/entity is available to begin performance of the task, and the like.

The representative may use any provided quotes from the third-party services and/or other services/entities to generate different proposals for completion of the task. These different proposals may be presented to the member 118 through the task-specific interface corresponding to the particular task that is to be completed. If the member 118 selects a particular proposal from the set of proposals presented through the task-specific interface, the representative may transmit a notification to the third-party service or other service/entity that submitted the quote associated with the selected proposal to indicate that it has been selected for completion of the task. Accordingly, the representative may utilize a task coordination system 114 to coordinate with the third-party service or other service/entity for completion of the task, as described in greater detail herein.

In some instances, if the task is to be completed by the representative 106, the representative 106 may utilize the task coordination system 114 of the task facilitation service 102 to identify any resources that may be utilized by the representative 106 for performance of the task. The resource library may include detailed information related to different resources available for performance of a task. As an illustrative example, if the representative 106 is tasked with purchasing a set of filters for the member's home, the representative 106 may query the resource library to identify a retailer that may sell filters of a quality and/or price that is acceptable to the member 118 and that corresponds to the proposal accepted by the member 118. Further, the representative 106 may obtain, from the user data storage 108, available payment information of the member 118 that may be used to provide payment for any resources required by the representative 106 to complete the task. Using the aforementioned example, the representative 106 may obtain payment information of the member 118 from the user data storage 108 to complete a purchase with the retailer for the set of filters that are to be used in the member's home.

In an embodiment, the task coordination system 114 uses a machine learning algorithm or artificial intelligence to select one or more third-party services 116 and/or resources on behalf of the representative for performance of a task. For instance, the task coordination system 114 may utilize the selected proposal or parameters related to the task (e.g., if the member 118 has deferred to the representative for determination of how the task is to be performed), as well as historical task data from the task data storage 110 corresponding to similar tasks as input to the machine learning algorithm or artificial intelligence. The machine learning algorithm or artificial intelligence may produce, as output, a listing of one or more third-party services 116 and/or other entities affiliated with the task facilitation service 102 that may perform the task with a high probability of satisfaction to the member 118. If the task is to be performed by the representative 106, the machine learning algorithm or artificial intelligence may produce, as output, a listing of resources (e.g., retailers, restaurants, brands, etc.) that may be used by the representative 106 for performance of the task with a high probability of satisfaction to the member 118.

In some instances, if the task cannot be completed by the third-party service or other service/entity according to the estimates provided in the selected proposal, the member 118 may be provided with an option to cancel the particular task or otherwise make changes to the task. For instance, if the new estimated cost for performance of the task exceeds the maximum amount specified in the selected proposal, the member 118 may ask the representative to find an alternative third-party service or other service/entity for performance of the task within the budget specified in the proposal. Similarly, if the timeframe for completion of the task is not within the timeframe indicated in the proposal, the member 118 can ask the representative to find an alternative third-party service or other service/entity for performance of the task within the original timeframe. The member's interventions may be recorded by the task recommendation system 112 and the task coordination system 114 to retrain their corresponding machine learning algorithms or artificial intelligence to better identify third-party services 116 and/or other service/entity that may perform tasks within the defined proposal parameters.

In an embodiment, once the representative has contracted with one or more third-party services 116 or other services/entities for performance of a task, the task coordination system 114 may monitor performance of the task by these third-party services 116 or other services/entities. For instance, the task coordination system 114 may record any information provided by the third-party services 116 or other services/entities with regard to the timeframe for performance of the task, the cost associated with performance of the task, any status updates with regard to performance of the task, and the like. The task coordination system 114 may associate this information with the data record in the task data storage 110 corresponding to the task being performed. Status updates provided by third-party services 116 or other services/entities may be provided automatically to the member 118 via the application or web portal provided by the task facilitation service 102 and to the representative.

In an embodiment, if the task is to be performed by the representative 106, the task coordination system 114 can monitor performance of the task by the representative 106. For instance, the task coordination system 114 may monitor, in real-time, any communications between the representative 106 and the member 118 regarding the representative's performance of the task. These communications may include messages from the representative 106 indicating any status updates with regard to performance of the task, any purchases or expenses incurred by the representative 106 in performing the task, the timeframe for completion of the task, and the like. The task coordination system 114 may associate these messages from the representative 106 with the data record in the task data storage 110 corresponding to the task being performed.

As noted above, once a task has been completed, the member 118 may be prompted to provide feedback with regard to completion of the task. For instance, the member 118 may be prompted to provide feedback with regard to the performance and professionalism of the selected third-party services 116 in performance of the task. Further, the member 118 may be prompted to provide feedback with regard to the quality of the proposal provided by the representative and as to whether the performance of the task has addressed the underlying issue associated with the task. Using the responses provided by the member 118, the task facilitation service 102 may train or otherwise update the machine learning algorithms or artificial intelligence utilized by the task recommendation system 112 and the task coordination system 114 to provide better identification of tasks, better generation of proposals, better identification of third-party services 116 for completion of tasks for the benefit of the member 118 and other similarly-situated members, better identification of resources that may be provided to the representative 106 for performance of a task for the benefit of the member 118, and the like.

In an embodiment, the task recommendation system 112 may automatically update the member profile and the resource library in real-time based on member interaction with the proposal. For example, if the member 118 indicates, through a chat session or other communications session associated with the project or task for which the proposal was presented, that the proposal is unacceptable (e.g., does not include any appealing options, does not include appealing recommendations for the presented options, etc.), the task recommendation system 112 may update the member profile to indicate that the provided proposal for the particular task or project was not well received by the member 118. Thus, for similar projects or tasks, a representative may review the member profile and readily determine that the provided proposal options and/or proposal recommendations should not be used as the basis for new proposal options and/or proposal recommendations for the similar projects or tasks. Alternatively, if the member 118 selects a particular proposal recommendation for a proposal option associated with a project or task, and the member 118 provides positive feedback with regard to this proposal recommendation, the task recommendation system 112 may update the member profile to indicate that the provided proposal for the particular task or project was well received by the member 118 and that the proposal recommendation selected by the member 118 may be used for similar projects or tasks in the future. These updates may also be propagated to the resource library such that, for similar projects and tasks, other representatives may be able to readily identify proposal recommendations that may be well suited for proposal options associated with these similar projects and tasks.

It should be noted that for the processes described herein, various operations performed by the representative 106 may be additionally, or alternatively, performed using one or more machine learning algorithms or artificial intelligence. For example, as the representative 106 performs or otherwise coordinates performance of tasks on behalf of a member 118 over time, the task facilitation service 102 may continuously and automatically update the member profile according to member feedback related to the performance of these tasks by the representative 106 and/or third-party services 116. In an embodiment, the task recommendation system 112, after a member's profile has been updated over a period of time (e.g., six months, a year, etc.) or over a set of tasks (e.g., twenty tasks, thirty tasks, etc.), may utilize a machine learning algorithm or artificial intelligence to automatically and dynamically generate new tasks based on the various attributes of the member's profile (e.g., historical data corresponding to member-representative communications, member feedback corresponding to representative performance and presented tasks/proposals, etc.) with or without representative interaction. The task recommendation system 112 may automatically communicate with the member 118 to obtain any additional information required for new tasks and automatically generate proposals that may be presented to the member 118 for performance of these tasks. The representative 106 may monitor communications between the task recommendation system 112 and the member 118 to ensure that the conversation maintains a positive polarity (e.g., the member 118 is satisfied with its interaction with the task recommendation system 112 or other bot, etc.). If the representative 106 determines that the conversation has a negative polarity (e.g., the member 118 is expressing frustration, the task recommendation system 112 or bot is unable to process the member's responses or asks, etc.), the representative 106 may intervene in the conversation. This may allow the representative 106 to address any member concerns and perform any tasks on behalf of the member 118.

Thus, unlike automated customer service systems and environments, wherein these systems and environment may have little to no knowledge of the users interacting with agents or other automated systems, the task recommendation system 112 can continuously update the member profile to provide up-to-date historical information about the member 118 based on the member's automatic interaction with the system or interaction with the representative 106 and on the tasks performed on behalf of the member 118 over time. This historical information, which may be automatically and dynamically updated as the member 118 or the system interacts with the representative 106 and as tasks are devised, proposed, and performed for the member 118 over time, may be used by the task recommendation system 112 to anticipate, identify, and present appropriate or intelligent responses to member 118 queries, needs, and/or goals.

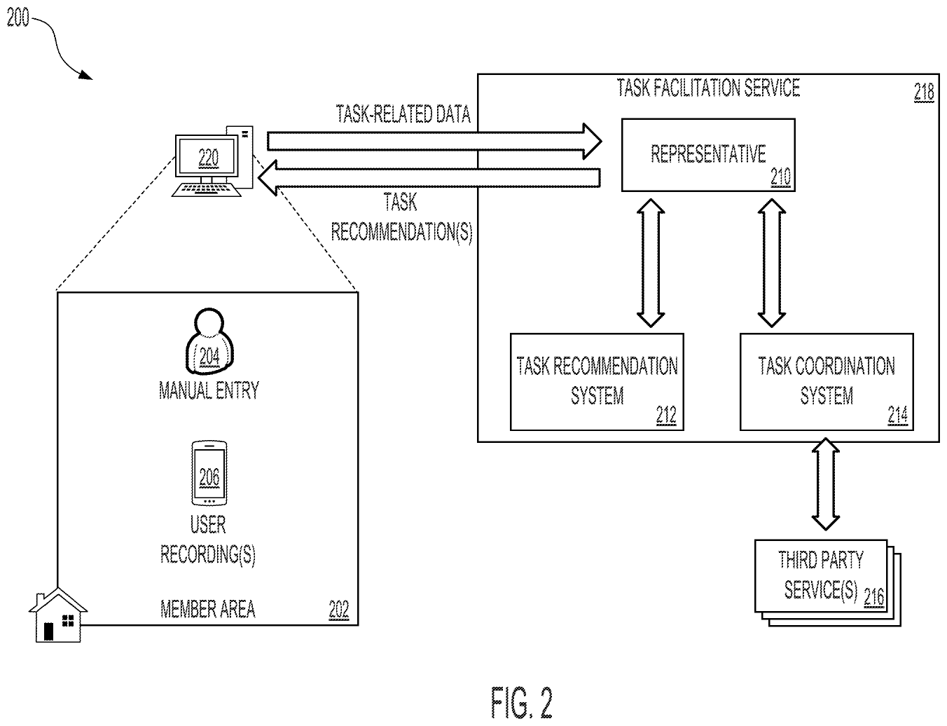

FIG. 2 shows an illustrative example of an environment 200 in which task-related data is collected and aggregated from a member area 202 to identify one or more tasks that can be recommended to the member for delegation and performance by the representative 210 and/or third-party services 216 in accordance with at least one embodiment. In the environment 200, a member, via a computing device 220 (e.g., laptop computer, smartphone, etc.), may transmit task-related data to the representative 210 assigned to the member to identify one or more tasks that may be performed for the benefit of the member (the computing device 220 is the same as the computing device 120 described herein at least in connection with FIG. 1). For example, in an embodiment, the member can manually enter one or more tasks that the member would like to delegate to the representative 210 for performance. The task facilitation service 218 may provide, to the member and via an application or web portal provided by the task facilitation service 218, a task template for manual entry 204 of a task that may be delegated to the representative 210 or that may otherwise be added to the member's list of tasks.

In an embodiment, the task template provided to the member may be tailored specifically according to the characteristics of the member identified by the task facilitation service 218 and defined in a member profile associated with the member. The member profile or model may define a set of attributes of the member that may be used by a representative 210 to determine how best to approach the member in conversation, in recommending tasks and proposals to the member, and in performance of the tasks for the benefit of the member. Based on these member attributes, the task facilitation service 218 may omit particular fields from the task template.

If the member submits, via the computing device 220 or through an interface provided by the task facilitation service 218, a completed task template corresponding to a task that is to be performed for the benefit to the member, the representative 210 assigned to the member may obtain the completed task template and initiate evaluation of the task to determine how best to perform the task for the benefit of the member. For instance, the representative 210 may evaluate the completed task template and generate a new task for the member corresponding to the task-related details provided by the member in the completed task template. Further, based on the representative's knowledge of the member (e.g., from interaction with the member, from the member profile, etc.), the representative 210 may determine whether to prompt the member for additional information that may be used to determine how best to perform the task for the benefit of the member. For instance, if the member has indicated that they wish to have their gutters cleaned but has not indicated when the gutters should be cleaned via the completed task template, the representative 210 may communicate with the member via an active communications session associated with the newly created task to inquire as to the timeframe for cleaning of the member's gutters. As another example, if the member has submitted a task without a particular budget for performance of the task, and the representative 210 knows (e.g., based on the member profile, personal knowledge of the member, etc.) that the member is budget-conscious, the representative 210 may communicate with the member to determine what the budget should be for performance of the task. Any information obtained in response to these communications may be used to supplement the member profile such that, for future tasks, this newly obtained information may be automatically retrieved from the member profile without requiring additional prompts to the member.

In an embodiment, a member, via a computing device 220, can submit one or more user recordings 206 that may be used to identify tasks that can be performed for the benefit of the member. For instance, a member may upload, to the task facilitation service 218, one or more digital images of the member area 202 that may be indicative of issues within the member area 202 for which tasks may be created. As an illustrative example, the member may capture an image of a broken baseboard that is in need of repair. As another illustrative example, the member may capture an image of a clogged gutter. The representative 210 may obtain these digital images and manually identify one or more tasks that may be performed to address the issues represented in the uploaded digital images. For instance, if the representative 210 receives a digital image that illustrates a broken baseboard, the representative 210 may generate a new task corresponding to the repair of the broken baseboard. Similarly, if the representative 210 receives a digital image that illustrates a clogged gutter, the representative 210 may generate a task corresponding to the cleaning of the member's gutters.

The one or more user recordings 206 may further include audio and/or video recordings within the member area 202 corresponding to possible issues for which tasks may be generated. These audio and/or video recordings may be reviewed by the representative 210 to identify any tasks that may be performed for the benefit of the member. Using the example of the broken baseboard described above, the member may record a video highlighting the broken baseboard while indicating “I would like to have this baseboard fixed soon as we're getting ready to sell the house.” This video, thus, may highlight an issue related to a broken baseboard and a level of urgency in having the baseboard repaired within a short timeframe due to the member selling their home.

In an embodiment, a representative 210 can generate one or more proposals for completion of any given task presented to the member via the application or web portal provided by the task facilitation service 218. A proposal may include one or more options (also referred to herein as “recommendations”) presented to a member that may be created and/or collected by a representative 210 while researching a given task. In some instances, a representative 210 may be provided with one or more templates that may be used to generate these one or more proposals. For example, the task facilitation service 218 may maintain proposal templates for different task types, whereby a proposal template for a particular task type may include various data fields associated with the task type. As an illustrative example, for a task associated with planning a birthday party, a representative 210 may utilize a proposal template corresponding to event planning. The proposal template corresponding to event planning may include data fields corresponding to venue options, catering options, entertainment options, and the like.

In an embodiment, the data fields within a proposal template can be toggled on or off to provide a representative 210 with the ability to determine what information is presented to the member in a proposal. For example, for a task associated with renting a balloon jump house for a party, a corresponding proposal template may include data fields corresponding to the location/address of a rental business, the business hours and availability of the rental business, an estimated cost, ratings/reviews for the rental business, and the like. The representative 210, based on its knowledge of the member's preferences, may toggle on or off any of these data fields. For example, if the representative 210 has established a relationship with the member whereby the representative 210, with high confidence, knows that the member trusts the representative 210 in selecting reputable businesses for its tasks, the representative 210 may toggle off a data field corresponding to the ratings/reviews for corresponding businesses from the proposal template. Similarly, if the representative 210 knows that the member is not interested in the location/address of the rental business for the purpose of the proposal, the representative 210 may toggle off the data field corresponding to the location/address for corresponding businesses from the proposal template. While certain data fields may be toggled off within the proposal template, the representative 210 may complete these data fields to provide additional information that may be used by the task facilitation service 218 to supplement a resource library of proposals as described in greater detail herein.

In an embodiment, the task facilitation service 218 utilizes a machine learning algorithm or artificial intelligence to generate recommendations for the representative 210 regarding data fields that may be presented to the member in a proposal. For example, the task facilitation service 218 may use, as input to the machine learning algorithm or artificial intelligence, a member profile or model associated with the member, historical task data for the member (e.g., previously completed tasks, tasks for which proposals have been provided, etc.), and information corresponding to the task for which a proposal is being generated (e.g., a task type or category, etc.). The output of the machine learning algorithm or artificial intelligence may define which data fields of a proposal template should be toggled on or off. For example, if the task facilitation service 218 determines, based on an evaluation of the member profile or model, historical task data for the member, and the information corresponding to the task for which the proposal is being generated, that the member is likely not interested in viewing information related to the ratings/reviews for the business nor the location/address of the business, the task facilitation service 218 may automatically toggle off these data fields from the proposal template. The task facilitation service 218, in some instances, may retain the option to toggle on these data fields in order to provide the representative 210 with the ability to present these data fields to the member in a proposal. For example, if the task facilitation service 218 has automatically toggled off a data field corresponding to the estimated cost for a balloon jump house rental from a particular business, but the member has expressed an interest in the possible cost involved, the representative 210 may toggle on the data field corresponding to the estimated cost.

In some instances, when a proposal is presented to a member, the task facilitation service 218 may monitor member interaction with the representative 210 and with the proposal to obtain data that may be used to further train the machine learning algorithm or artificial intelligence. For example, if a representative 210 presents a proposal without any ratings/reviews for a particular business based on the recommendation generated by the machine learning algorithm or artificial intelligence, and the member indicates (e.g., through messages to the representative 210, through selection of an option in the proposal to view ratings/reviews for the particular business, etc.) that they are interested in ratings/reviews for the particular business, the task facilitation service may utilize these feedback to further train the machine learning algorithm or artificial intelligence to increase the likelihood of recommending presentation of ratings/reviews for businesses selected for similar tasks or task types.

In an embodiment, the task facilitation service 218 maintains, via the task coordination system 214 (which is the same as the task coordination system 114 described herein at least in connection with FIG. 1), a resource library that may be used to automatically populate one or more data fields of a particular proposal template. The resource library may include entries corresponding to businesses and/or products previously used by representatives for proposals related to particular tasks or task types or that are otherwise associated with particular tasks or task types. For instance, when a representative 210 generates a proposal for a task related to repairing a roof near Lynnwood, Wash., the task coordination system 214 may obtain information associated with the roofer selected by the representative 210 for the task. The task coordination system 214 may generate an entry corresponding to the roofer in the resource library and associate this entry with “roof repair” and “Lynnwood, Wash.” Thus, if another representative receives a task corresponding to repairing a roof for a member located near Lynnwood, Wash. (e.g., Everett, Wash.), the other representative may query the resource library for roofers near Lynnwood, Wash. The resource library may return, in response to the query, an entry corresponding to the roofer previously selected by the representative 210. If the other representative selects this roofer, the task coordination system 214 may automatically populate the data fields of the proposal template with the information available for the roofer from the resource library.

The representative 210, via a proposal template, may generate additional proposal options for businesses and/or products that may be used for completion of a task. For instance, for a particular proposal, the representative 210 may generate a recommended option, which may correspond to the business or product that the representative 210 is recommending for completion of a task. Additionally, in order to provide the member with additional options or choices, the representative 210 can generate additional options corresponding to other businesses or products that may complete the task. In some instances, if the representative 210 knows that the member has delegated the decision-making with regard to completion of a task to the representative 210, the representative 210 may forego generation of additional proposal options outside of the recommended option. However, the representative 210 may still present, to the member, the selected proposal option for completion of the task in order to keep the member informed about the status of the task.

In an embodiment, once the representative 210 has completed defining a proposal via use of a proposal template, the task facilitation service 218 may present the proposal to the member through the application or web portal provided by the task facilitation service 218. In some instances, the representative 210 may transmit a notification to the member to indicate that a proposal has been prepared for a particular task and that the proposal is ready for review via the application or web portal provided by the task facilitation service 218. The proposal presented to the member may indicate the task for which the proposal was prepared, as well as an indication of the one or more options that are being provided to the member. For instance, the proposal may include links to the recommended proposal option and to the other options (if any) prepared by the representative 210 for the particular task. These links may allow the member to navigate amongst the one or more options prepared by the representative 210 via the application or web portal.

For each proposal option, the member may be presented with information corresponding to the business (e.g., third-party service or other service/entity associated with the task facilitation service 218) or product selected by the representative 210 and corresponding to the data fields selected for presentation by the representative 210 via the proposal template. For example, for a task associated with a roof inspection at the member's home, the representative 210 may present for a particular roofer (e.g., proposal option) one or more reviews or testimonials for the roofer, the rate and availability for the roofer subject to the member's task completion timeframe (if any), the roofer's website, the roofer's contact information, any estimated costs, and an indication of next steps for the representative 210 should the member select this particular roofer for the task. In some instances, the member may select what details or data fields associated with a particular proposal are presented via the application or web portal. For example, if the member is presented with the estimated total for each proposal option and the member is not interested in reviewing the estimated total for each proposal option, the member may toggle off this particular data field from the proposal via the application or web portal. Alternatively, if the member is interested in reviewing additional detail with regard to each proposal option (e.g., additional reviews, additional business or product information, etc.), the member may request this additional detail to be presented via the proposal.

In an embodiment, based on member interaction with a provided proposal, the task facilitation service 218 can further train a machine learning algorithm or artificial intelligence used to determine or recommend what information should be presented to the member and to similarly-situated members for similar tasks or task types. As noted above, the task facilitation service 218 may use a machine learning algorithm or artificial intelligence to generate recommendations for the representative 210 regarding data fields that may be presented to the member in a proposal. The task facilitation service 218 may monitor or track member interaction with the proposal to determine the member's preferences regarding the information presented in the proposal for the particular task. Further, the task facilitation service 218 may monitor or track any messages exchanged between the member and the representative 210 related to the proposal to further identify the member's preferences. For example, if the member sends a message to the representative 210 indicating that the member would like to see more information with regard to the services offered by each of the businesses specified in the proposal, the task facilitation service 218 may determine that the member may want to see additional information with regard to the services offered by businesses associated with the particular task or task type. In some instances, the task facilitation service 218 may solicit feedback from the member with regard to proposals provided by the representative 210 to identify the member's preferences. This feedback and information garnered through member interaction with the representative 210 regarding the proposal and with the proposal itself may be used to retrain the machine learning algorithm or artificial intelligence to provide more accurate or improved recommendations for information that should be presented to the member and to similarly situated members in proposals for similar tasks or task types.

In some instances, each proposal presented to the member may specify any costs associated with each proposal option. These costs may be presented in different formats based on the requirements of the associated task or project. For instance, if a task or project corresponds to the purchase of an airline ticket, each proposal option for the corresponding proposal may present a fixed price for the airline ticket. As another illustrative example, a representative 210 can provide, for each proposal option, a budget for completion of the task according to the selected option (e.g., “will spend up to $150 on Halloween decorations for the party”). As yet another illustrative example, for tasks or projects where payment schedules may be involved, proposal options for a proposal related to a task or project may specify the payment schedule for each of these proposal options (e.g., “$100 for the initial consultation, with $300 for follow-up servicing,” “$1,500 up-front to reserve the venue, with $1,500 due after the event,” etc.).

If a member accepts a particular proposal option for a task or project, the representative 210 may communicate with the member to ensure that the member is consenting to payment of the presented costs and any associated taxes and fees for the particular proposal option. In some instances, if a proposal option is selected with a static payment amount (e.g., fixed price, “up to $X,” phased payment schedules with static amounts, etc.), the member may be notified by the representative 210 if the actual payment amount required for fulfillment of the proposal option exceeds a threshold percentage or amount over the originally presented static payment amount. For example, if the representative 210 determines that the member may be required to spend more than 120% of the cost specified in the selected proposal option, the representative 210 may transmit a notification to the member to re-confirm the payment amount before proceeding with the proposal option.

In an embodiment, if a member accepts a proposal option from the presented proposal, the task facilitation service 218 moves the task associated with the presented proposal to an executing state and the representative 210 can proceed to execute on the proposal according to the selected proposal option. For instance, the representative 210 may contact one or more third-party services 216 to coordinate performance of the task according to the parameters defined in the proposal accepted by the member.

In an embodiment, the representative 210 utilizes the task coordination system 214 to assist in the coordination of performance of the task according to the parameters defined in the proposal accepted by the member. For instance, if the coordination with a third-party service 216 may be performed automatically (e.g., third-party service 216 provides automated system for ordering, scheduling, payments, etc.), the task coordination system 214 may interact directly with the third-party service 216 to coordinate performance of the task according to the selected proposal option. The task coordination system 214 may provide any information (e.g., confirmation, order status, reservation status, etc.) to the representative 210. The representative 210, in turn, may provide this information to the member via the application or web portal utilized by the member to access the task facilitation service 218 or through other communication methods (e.g., e-mail message, text message, etc.) to indicate that the third-party service 216 has initiated performance of the task according to the selected proposal option. In an embodiment, if the representative 210 is performing the task for the benefit of a member, the representative 210 can provide status updates with regard to its performance of the task to the member via the application or web portal provided by the task facilitation service 218.

Once a task has been completed, the member may provide feedback with regard to the performance of the representative 210 and/or third-party services 216 that performed the task according to the proposal option selected by the member. For instance, the member may exchange one or more messages with the representative 210 over the chat session for the particular task to indicate its feedback with regard to the completion of the task. In an embodiment, the task facilitation service uses a machine learning algorithm or artificial intelligence to process feedback provided by the member to improve the recommendations provided by the task facilitation service 218 for proposal options, third-party services 216 or other services/entities, and/or processes that may be performed for completion of similar tasks.

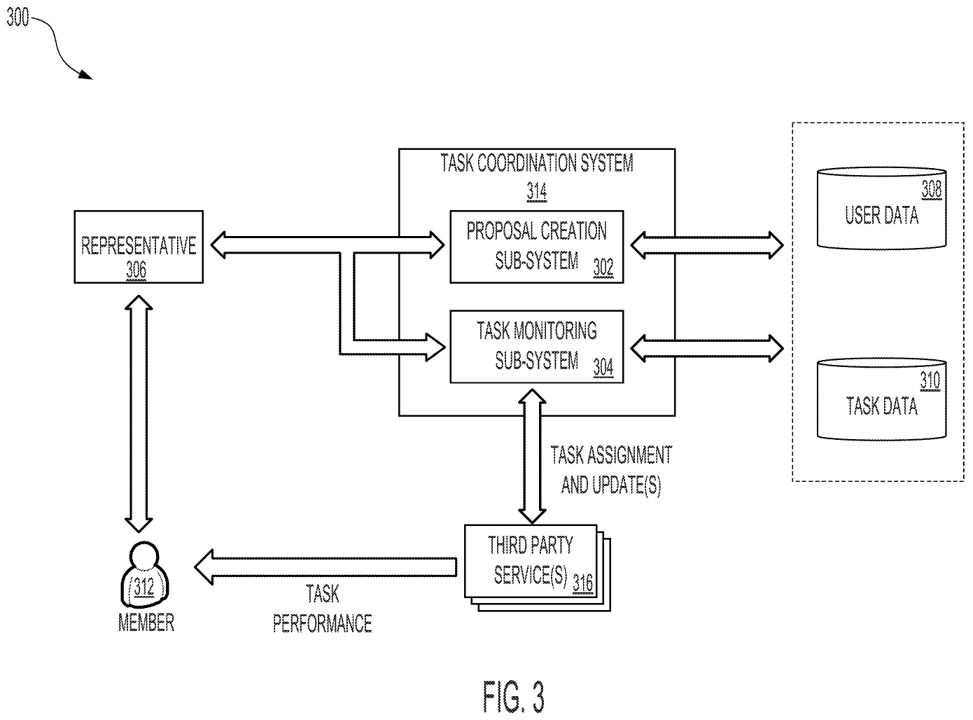

FIG. 3 shows an illustrative example of an environment 300 in which a task coordination system 314 assigns and monitors performance of a task for the benefit of a member 312 by a representative 306 and/or one or more third-party services 316 in accordance with at least one embodiment. In the environment 300, a representative 306 may access a proposal creation sub-system 302 of the task coordination system 314 to generate a proposal for completion of a task for the benefit of the member 312. The proposal creation sub-system 302 may be implemented using a computer system or as an application or other executable code implemented on a computer system of the task coordination system 314. Once the representative 306 has obtained the necessary task-related information from the member 312 and/or through the task recommendation system (e.g., task parameters garnered via evaluation of tasks performed for similarly situated members, etc.), the representative 306 can utilize the proposal creation sub-system 302 to generate one or more proposals for resolution of the task.

As noted above, a proposal may include one or more options presented to a member 312 that may be created and/or collected by a representative 306 while researching a given task. In some instances, a representative 306 may access, via the proposal creation sub-system 302, one or more proposal templates that may be used to generate these one or more proposals. For example, the proposal creation sub-system 302 may maintain, within the task data storage 310 or internally, proposal templates for different task types, whereby a proposal template for a particular task type may include various data fields associated with the task type. The task data storage 310 may be associated with a resource library. This resource library may maintain the various proposal templates for the creation of new proposals for completion of different tasks.

In an embodiment, the data fields within a proposal template can be toggled on or off to provide a representative 306 with the ability to determine what information is presented to the member 312 in a proposal. The representative 306, based on its knowledge of the member's preferences, may toggle on or off any of these data fields within the template. For example, if the representative 306 has established a relationship with the member 312 whereby the representative 306, with high confidence, knows that the member trusts the representative 306 in selecting reputable businesses for its tasks, the representative 306 may toggle off a data field corresponding to the ratings/reviews for corresponding businesses from the proposal template. Similarly, if the representative 306 knows that the member 312 is not interested in the location/address of a business for the purpose of the proposal, the representative 306 may toggle off the data field corresponding to the location/address for corresponding businesses from the proposal template. While certain data fields may be toggled off within the proposal template, the representative 306 may complete these data fields to provide additional information that may be used by the proposal creation sub-system 302 to supplement a resource library of proposals maintained by the task coordination system 314.

In an embodiment, the proposal creation sub-system 302 utilizes a machine learning algorithm or artificial intelligence to generate recommendations for the representative 306 regarding data fields that may be presented to the member 312 in a proposal. The proposal creation sub-system 302 may use, as input to the machine learning algorithm or artificial intelligence, a member profile or model associated with the member 312 from the user data storage 308, historical task data for the member 312 from the task data storage 310, and information corresponding to the task for which a proposal is being generated (e.g., a task type or category, etc.). The output of the machine learning algorithm or artificial intelligence may specify which data fields of a proposal template should be toggled on or off. The proposal creation sub-system 302, in some instances, may preserve, for the representative 306, the option to toggle on these data fields in order to provide the representative 306 with the ability to present these data fields to the member 312 in a proposal. For example, if the proposal creation sub-system 302 has automatically toggled off a data field corresponding to the estimated cost for completion of a task, but the member 312 has expressed an interest in the possible cost involved, the representative 306 may toggle on the data field corresponding to the estimated cost.

Once the representative 306 has generated a new proposal for the member 312, the representative 306 may present the proposal and any corresponding proposal options to the member 312. Further, the proposal creation sub-system 302 may store the new proposal in the user data storage 308 in association with the member profile. In some instances, when a proposal is presented to a member 312, the proposal creation sub-system 302 may monitor member interaction with the representative 306 and with the proposal to obtain data that may be used to further train the machine learning algorithm or artificial intelligence. For example, if a representative 306 presents a proposal without any ratings/reviews for a particular business based on the recommendation generated by the proposal creation sub-system 302, and the member 312 indicates (e.g., through messages to the representative 306, through selection of an option in the proposal to view ratings/reviews for the particular business, etc.) that they are interested in ratings/reviews for the particular business, the proposal creation sub-system 302 may utilize this feedback to further train the machine learning algorithm or artificial intelligence to increase the likelihood of recommending presentation of ratings/reviews for businesses selected for similar tasks or task types.

As noted above, the task coordination system 314 maintains a resource library that may be used to automatically populate one or more data fields of a particular proposal template. The resource library may include entries corresponding to businesses and/or products previously used by representatives for proposals related to particular tasks or task types or that are otherwise associated with particular tasks or task types. For instance, when a representative 306 generates a proposal for a task related to repairing a roof near Lynnwood, Wash., the proposal creation sub-system 302 may obtain information associated with the roofer selected by the representative 306 for the task. The proposal creation sub-system 302 may generate an entry corresponding to the roofer in the resource library and associate this entry with “roof repair” and “Lynnwood, Wash.” Thus, if another representative receives a task corresponding to repairing a roof for a member located near Lynnwood, Wash., the other representative may query the resource library for roofers near Lynnwood, Wash. The resource library may return, in response to the query, an entry corresponding to the roofer previously selected by the representative 306. If the other representative selects this roofer, the proposal creation sub-system 302 may automatically populate the data fields of the proposal template with the information available for the roofer from the resource library.

In an embodiment, the representative 306 can query the resource library to identify one or more third-party services and other services/entities affiliated with the task facilitation service from which to solicit quotes for completion of the task. For instance, for a newly created task, the representative 306 may transmit a job offer to these one or more third-party services 316 and other services/entities. The job offer may indicate various characteristics of the task that is to be completed (e.g., scope of the task, general geographic location of the member 312 or of where the task is to be completed, desired budget, etc.). Through an application or web portal provided by the task facilitation service, a third-party service or other service/entity may review the job offer and determine whether to submit a quote for completion of the task or to decline the job offer. If a third-party service or other service/entity opts to reject the job offer, the representative 306 may receive a notification indicating that the third-party service or other service/entity has declined the job offer. Alternatively, if a third-party service or other service/entity opts to bid to perform the task (e.g., accepts the job offer), the third-party service or other service/entity may submit a quote for completion of the task. This quote may indicate the estimated cost for completion of the task, the time required for completion of the task, the estimated date in which the third-party service or other service/entity is available to begin performance of the task, and the like.

The representative 306 may use any provided quotes from the third-party services 316 and/or other services/entities to generate different proposal options for completion of the task. These different proposal options may be presented as a proposal to the member 312 through the task-specific interface corresponding to the particular task that is to be completed. If the member 312 selects a particular proposal option from the set of proposal options presented through the task-specific interface, the representative 306 may transmit a notification to the third-party service or other service/entity that submitted the quote associated with the selected proposal option to indicate that it has been selected for completion of the task.

As noted above, the representative 306, via a proposal template, may generate additional proposal options for businesses and/or products that may be used for completion of a task. For instance, for a particular proposal, the representative 306 may generate a recommended option, which may correspond to the business or product that the representative 306 is recommending for completion of a task. Additionally, in order to provide the member 312 with additional options or choices, the representative 306 can generate additional options corresponding to other businesses or products that may complete the task. In some instances, if the representative 306 knows that the member 312 has delegated the decision-making with regard to completion of a task to the representative 306, the representative 306 may forego generation of additional proposal options outside of the recommended option. However, the representative 306 may still present, to the member 312, the selected proposal option for completion of the task in order to keep the member 312 informed about the status of the task.

Once the representative 306 has completed defining a proposal via use of a proposal template, the representative 306 may present the proposal to the member 312 through the application or web portal provided by the task facilitation service. In some instances, the representative 306 may transmit a notification to the member 312 to indicate that a proposal has been prepared for a particular task and that the proposal is ready for review via the application or web portal provided by the task facilitation service. The proposal presented to the member 312 may indicate the task for which the proposal was prepared, as well as an indication of the one or more options that are being provided to the member 312. For instance, the proposal may include links to the recommended proposal option and to the other options (if any) prepared by the representative 306 for the particular task. These links may allow the member 312 to navigate amongst the one or more options prepared by the representative 306 via the application or web portal. In some instances, the representative 306 may transmit the proposal to the member 312 via other communication channels, such as via e-mail, text message, and the like.

For each proposal option, the member may be presented with information corresponding to the business or product selected by the representative 306 and corresponding to the data fields selected for presentation by the representative 306 via the proposal creation sub-system 302. In some instances, the member 312 may select what details or data fields associated with a particular proposal are presented via the application or web portal. For example, if the member 312 is presented with the estimated total for each proposal option and the member 312 is not interested in reviewing the estimated total for each proposal option, the member 312 may toggle off this particular data field from the proposal via the application or web portal. Alternatively, if the member 312 is interested in reviewing additional detail with regard to each proposal option (e.g., additional reviews, additional business or product information, etc.), the member 312 may request this additional detail to be presented via the proposal.

As noted above, based on member interaction with a provided proposal, the proposal creation sub-system 302 may further train a machine learning algorithm or artificial intelligence used to determine or recommend what information should be presented to the member 312 and to similarly-situated members for similar tasks or task types. The proposal creation sub-system 302 may monitor or track member interaction with the proposal to determine the member's preferences regarding the information presented in the proposal for the particular task. Further, the proposal creation sub-system 302 may monitor or track any messages exchanged between the member 312 and the representative 306 related to the proposal to further identify the member's preferences. In some instances, the proposal creation sub-system 302 may solicit feedback from the member 312 with regard to proposals provided by the representative 306 to identify the member's preferences. This feedback and information garnered through member interaction with the representative 306 regarding the proposal and with the proposal itself may be used to retrain the machine learning algorithm or artificial intelligence to provide more accurate or improved recommendations for information that should be presented to the member 312 and to similarly situated members in proposals for similar tasks or task types. The proposal creation sub-system 302 may further use the feedback and information garnered through member interaction with the representative 306 to update a member profile or model within the user data storage 308 for use in determining recommendations for information that should be presented to the member 312 in a proposal.

In some instances, each proposal presented to the member 312 may specify any costs associated with each proposal option. These costs may be presented in different formats based on the requirements of the associated task or project. For instance, if the proposal corresponds to performance of the task by a third-party service or other service/entity associated with the task facilitation service, the proposal may include a quote submitted by the third-party service or other service/entity in response to the job offer from the representative 306. The quote may indicate any costs associated with different aspects of the task, as well as any additional fees that may be required for performance of the task (e.g., taxes, material costs, etc.). If a member 312 accepts a particular proposal option for a task or project, the representative 306 may communicate with the member 312 to ensure that the member is consenting to payment of the presented costs and any associated taxes and fees for the particular proposal option. In some instances, if a proposal option is selected with a static payment amount, the member 312 may be notified by the representative 306 if the actual payment amount required for fulfillment of the proposal option exceeds a threshold percentage or amount over the originally presented static payment amount.

In an embodiment, if a member 312 accepts a proposal option from the presented proposal, the task coordination system 314 moves the task associated with the presented proposal to an executing state and the representative 306 can proceed to execute on the proposal according to the selected proposal option. For instance, the representative 306 may contact one or more third-party services 316 and/or other services/entities associated with the task facilitation service to coordinate performance of the task according to the parameters defined in the proposal accepted by the member 312. Alternatively, if the representative 306 is to perform the task for the benefit of the member 312, the representative 306 may begin performance of the task according to the parameters defined in the proposal accepted by the member 312.

In an embodiment, the representative 306 utilizes a task monitoring sub-system 304 of the task coordination system 314 to assist in the coordination of performance of the task according to the parameters defined in the proposal accepted by the member 312. The task monitoring sub-system 304 may be implemented using a computer system or as an application or other executable code implemented on a computer system of the task coordination system 314. If the coordination with a third-party service 316 may be performed automatically (e.g., third-party service 316 provides automated system for ordering, scheduling, payments, etc.), the task monitoring sub-system 304 may interact directly with the third-party service 316 to coordinate performance of the task according to the selected proposal option. The task monitoring sub-system 304 may provide any information from a third-party service 316 to the representative 306. The representative 306, in turn, may provide this information to the member 312 via the application or web portal utilized by the member to access the task facilitation service. Alternatively, the representative 306 may transmit the information to the member 312 via other communication methods (e.g., e-mail message, text message, etc.) to indicate that the third-party service 316 has initiated performance of the task according to the selected proposal option.

In an embodiment, the task monitoring sub-system 304 can monitor performance of tasks by the representative 306 and/or the third-party services 316 for the benefit of the member 312. Further, once a task has been completed, the member 312 may provide feedback with regard to the performance of the representative 306 and/or third-party services 316 or other services/entities associated with the task facilitation service that performed the task according to the proposal option selected by the member 312. For instance, the member 312 may exchange one or more messages with the representative 306 over the task-specific chat session or other communications channel to indicate its feedback with regard to the completion of the task. In an embodiment, the task monitoring sub-system 304 provides the feedback to the proposal creation sub-system 302, which may use a machine learning algorithm or artificial intelligence to process feedback provided by the member 312 to improve the recommendations provided by the proposal creation sub-system 302 for proposal options, third-party services 316 or other services/entities, and/or processes that may be performed for completion of similar tasks. For instance, if the proposal creation sub-system 302 detects that the member is unsatisfied with the result provided by a third-party service 316 or other services/entities for a particular task, the proposal creation sub-system 302 may utilize this feedback to further train the machine learning algorithm or artificial intelligence to reduce the likelihood of the third-party service 316 or other services/entities being recommended for similar tasks and to similarly-situated members. As another example, if the proposal creation sub-system 302 detects that the member is pleased with the result provided by a representative 306 for a particular task, the proposal creation sub-system 302 may utilize this feedback to further train the machine learning algorithm or artificial intelligence to reinforce the operations performed by representatives for similar tasks and/or for similarly-situated members.

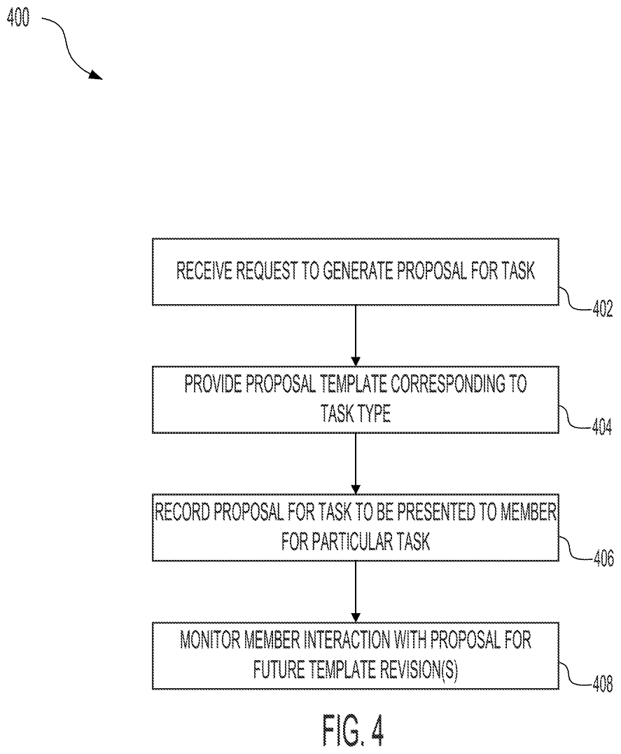

FIG. 4 shows an illustrative example of a process 400 for generating a proposal and monitoring member interaction with the generated proposal in accordance with at least one embodiment. The process 400 may be performed by one or more systems of the task facilitation service (e.g., the task recommendation system 112 and the task coordination system 114 of the task facilitation service 102, all of which are described herein at least in connection with FIG. 1). At step 402, the systems of the task facilitation service may receive a request to generate a proposal for a particular task. The request may be submitted by a representative, which may have received authorization from a member to perform a task for the benefit of the member. For instance, once the representative has obtained the necessary task-related information from the member and/or through the task recommendation system (e.g., task parameters garnered via evaluation of tasks performed for similarly situated members, etc.), the representative can utilize systems of the task facilitation service to generate one or more proposals for resolution of the task as described herein.

At step 404, the systems of the task facilitation service provide a proposal template corresponding to the task type to the representative. The proposal template may be provided via a user interface provided to the representative by the task facilitation service. As noted above, a proposal may include one or more options presented to a member that may be created and/or collected by a representative while researching a given task. In some instances, a representative may access, via a task recommendation system, one or more templates that may be used to generate these one or more proposals. For example, the task recommendation system may maintain proposal templates for different task types, whereby a proposal template for a particular task type may include various data fields associated with the task type. As described herein, in an embodiment the task recommendation system can interface with the task coordination system and/or with other systems of the task facilitation service to provide the proposal template (e.g., the proposal template corresponding to the task type) to the representative.

At step 406, the systems of the task facilitation service may record a proposal generated by the representative for a particular task so that the proposal can be presented to the member for the particular task. For instance, the task coordination system may add the proposal to a task data storage such that member interaction with the proposal may be recorded for further training of the aforementioned machine learning algorithms or artificial intelligence used to generate and maintain member profiles and to define individualized proposal templates for different task types and for different members. Additionally, the task coordination system may store the proposal in the user data storage in association with a member entry in the user data storage, as described above.

At step 408, the systems of the task facilitation service may monitor member interaction with the proposal to identify possible future proposal template revisions. As noted above, when a proposal is presented to a member, the task coordination system may monitor member interaction with the representative and with the proposal to obtain data that may be used to further train a machine learning algorithm or artificial intelligence utilized to define a proposal template for a particular member. For example, if a representative presents a proposal without any ratings/reviews for a particular business based on the recommendation generated by the task coordination system, and the member indicates (e.g., through messages to the representative, through selection of an option in the proposal to view ratings/reviews for the particular business, etc.) that they are interested in ratings/reviews for the particular business, the task coordination system may utilize this feedback to further train the machine learning algorithm or artificial intelligence to increase the likelihood of recommending presentation of ratings/reviews for businesses selected for similar tasks or task types.

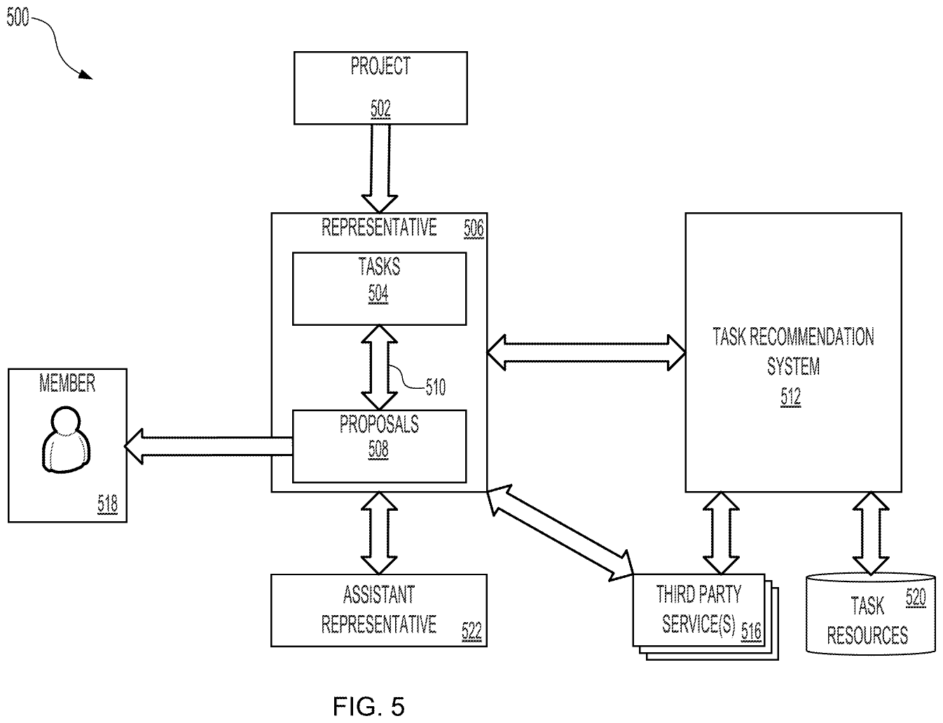

FIG. 5 shows an illustrative example of an environment 500 in which a proposal related to an individual task or tasks associated with a project is generated in accordance with at least one embodiment. In the environment 500, a project 502 may be received by a representative 506 that is associated with a task facilitation service. The project 502 may be associated with a member 518. In an embodiment, the project 502 or a project proposal (e.g., a proposal to generate a new project) is directly generated in response to a message from the member 518. For example, the member 518 may transmit a message to the representative 506 stating “I need to start a project for my parents' anniversary weekend” which may cause the representative 506 and/or a system of the task facilitation service to initiate a project to plan the anniversary weekend. The message transmitted by the member 518 may include less information (e.g., “I need to start a project to plan a weekend getaway”). Alternatively, the message transmitted by the member 518 may include more information (e.g., “I need to start a project to plan my parents' anniversary weekend on the weekend of May 20th”). The message transmitted by the member 518 may include very detailed information (e.g., “I need to start a project to plan my parents' anniversary weekend on the weekend of May 20^{th} with wine tasting and a surprise activity”). In some instances, the message transmitted by the member 518 may include no information (e.g., “I need to start a project”).

In some embodiments, a message can cause the representative and/or the task recommendation system 512 to initiate a project with varying degrees of initial information about the project. In some embodiments, the proposed project (also referred to herein as a “project proposal”) is then presented back to the member 518 for verification. For instance, the representative 506 or the task recommendation system 512 may create a project-specific interface through which the member 518 may be presented with the proposed project. This project-specific interface may be presented through the application or web portal provided by the task facilitation service. In some embodiments, the proposed project is not presented to the member if, for example, the representative 506 wishes to reduce the cognitive load of the member 518, the representative 506 has enough information to begin generating tasks and proposals for the project 502, and/or the representative 506 knows that the member 518 does not want to verify the project proposal (e.g., through evaluation of a member profile that includes member preferences and/or observations of previous member behavior).

It should be noted that, in some examples, the member 518 may request or otherwise submit a message to the representative 506 to initiate a singular task. For instance, the member 518 may transmit a message to the representative 506 (such as through an existing chat session or other communications channel provided by the task facilitation service) to request creation and performance of a singular task for the benefit of the member 518. As an illustrative example, if the member 518 transmits the message “I could use help in finding a mechanic to repair my vehicle,” the representative 506 may interpret this message as a request to create a singular task related to the scheduling of an appointment with a mechanic to repair the member's vehicle. Thus, as opposed to projects, which may comprise various tasks that need to be completed in order for these projects to be completed, a singular task may be performed independent of any project.

As noted above, the member 518 can also manually provide task-related data via a task template corresponding to a particular task category or type. Through this task template, the member 518 may provide a name for the task or project, a description of the task or project, a timeframe for performance of the task or project, and the like. In some instances, the task template provided to the member 518 may be tailored specifically according to the characteristics of the member 518 identified by the task facilitation service and to the characteristics corresponding to the particular task category or type associated with the selected task template. If the member 518 requests creation and performance of a task or project, the task facilitation service may generate a task- or project-specific interface through which the member 518 may be presented with the proposed task or project, respectively.

In an embodiment, the project proposal can include a recommendation by a system of the task facilitation service about whether to send the project proposal to the member 518 for approval before proceeding with generating tasks and proposals for the project 502 and for each of the tasks associated with the project 502. Such approval, if needed, causes a project proposal to become a project (e.g., the project 502). Such a recommendation may be based on stated or intuited preferences of the member, may be based on a behavioral history of the member (e.g., that the member always wants to review a project proposal or that the member never wants to review a project proposal), may be based on the current cognitive load on the member (e.g., that the member is a tax preparation CPA and it is April 5^{th}), may be based on the commonality of the project (e.g., that the member plans anniversary weekends for their parents every year), or may be based on a combination of these and other such factors as garnered from the member profile associated with the member 518. In an embodiment, the representative 506 makes the decision about whether to present the project proposal to the member 518 based on, for example, past interactions between the representative 506 and the member 518.

In some embodiments, the recommendation of whether to present the proposed project to the member for approval is based on a degree of predictability associated with the project proposal. For example, if the member asks the representative to start the project, the member can reasonably predict that the representative would move forward with the project and thus additional approval may not be needed. Conversely, if the project proposal is automatically generated by systems of the task facilitation service from the analysis of messages between the member and the representative, the member may have very little reason to predict that a proposal corresponding to a project is forthcoming and, thus, recommendation of an approval step may be more likely.

In some embodiments, the representative accepts the recommendation as to whether to seek approval for the project proposal (i.e., the representative decides to follow the recommendation and either proceeds with seeking approval for the proposed project when it is recommended or does not proceed with seeking approval for the proposed project when it is not recommended). In some embodiments, the representative rejects the recommendation as to whether to seek approval for the project proposal (i.e., the representative decides to not follow the recommendation and either proceeds with seeking approval for the proposed project when it is not recommended or does not proceed with seeking approval for the proposed project when it is recommended). Decisions by the representative to either accept or reject the recommendation of the task recommendation system 512 may be used by the task recommendation system 512 to inform future recommendations as to whether to seek approval from members for project proposals. Decisions by the representative 506 to either accept or reject the recommendation may be used to inform future recommendations for the member 518, for the type of project or task, for the entire system, or for a combination of these future recommendations.

In an embodiment, a project proposal is generated from context and/or analysis of other messages between the member 518 and the representative 506. For example, the member 518 may transmit a message to the representative 506 stating “my parents are having their 25^{th} anniversary in a few weeks” followed by another message stating “I really should plan something for them” causing the task recommendation system 512 to recommend that a project to plan an anniversary weekend be initiated. The recommendation to initiate the project may then be presented to the representative 506 by the task recommendation system 512 and the representative 506 may then present the proposed project to the member 518 for approval. In some embodiments, the proposed project is not presented back to the member if, for example, the representative 506 wishes to reduce the cognitive load of the member 518, the representative 506 has enough information to begin generating tasks and proposals for the project 502, and/or the representative 506 knows that the member 518 does not want or need to verify the project proposal by the factors such as those described above.

In an embodiment, a project proposal is generated automatically by the task recommendation system 512 from other information associated with the member 518. For example, the task facilitation service may have, within a member profile associated with the member 518, information that indicates the member's parents, their names, ages, and wedding date. Such information may be gathered from the member directly (e.g., through intake questions), may be gathered from previous messages exchanged between the member and the representative as described above, may be gathered from previous projects and/or tasks (e.g., planning the anniversary last year), or may be gathered from other information sources (e.g., public data, ancestry data, or other such information sources). The recommendation to initiate the project may then be presented to the representative 506 by the task recommendation system 512 and the representative 506 may then present the proposed project to the member 518 for approval or may not presented back to the member if, for example, the representative 506 wishes to reduce the cognitive load of the member 518, the representative 506 has enough information to begin generating tasks and proposals for the project 502, and/or the representative 506 knows that the member 518 does not want or need to verify the project proposal by the factors such as those described above.

In an embodiment, the project proposal is generated by the representative 506 based on knowledge about the member 518. For example, the representative may know that the member's parents have an upcoming anniversary based on a completely unrelated conversation and/or a conversation about an unrelated project or task (e.g., “I cannot be home to let the window cleaners in that day because it is my anniversary. Did you know that my Mom and Dad have the same anniversary? We did not plan it that way, it just happened.”). Such information about the member may not be stored in the member profile associated with the member 518. Alternatively, such information may be indicated within the member profile within a section corresponding to the representative's personal notes. These personal notes may only be visible to the representative 506 such that, if the member 518 accesses the member profile to add, remove, or otherwise modify any member information within, the representative's personal notes may be omitted from presentation to the member 518. As with the above project proposals, the representative 506 may then determine whether to present the proposed project to the member 518 for approval based on, for example, the cognitive load of the member, the representative having enough information to begin generating tasks and proposals for the project, and/or the representative 506 knowing that the member 518 does not want or need to approve the project proposal by the factors such as those described above.

In some embodiments, the task recommendation system 512 implements machine learning or artificial intelligence techniques to generate recommendations about whether to send the project proposal to the member 518 for approval, the project proposal from context and/or analysis of other messages between the member 518 and the representative 506, the project proposal from other information associated with the member, a project template, proposal options, proposal recommendations, and/or aspects of each of these recommendations and/or proposals. Such machine learning or artificial intelligence techniques may be used by the task recommendation system 512 to identify the relevant factors and to generate the proposals and/or recommendations that may be relevant to the member 518. For example, the task recommendation system 512 may implement a clustering algorithm to identify similar recommendations and/or parameters based on one or more relevant parameters (e.g., in an n-dimensional parameter space associated with the member, the proposal, the recommendation, etc.). In some instances, a dataset of characteristics of a plurality of members, recommendations, and/or proposals may be analyzed using a clustering algorithm to identify ways that different types of members that may interact with the task facilitation service in relation to various proposals and tasks to generate recommendations and/or proposals. Example clustering algorithms that may trained using sample member datasets are described herein. Based on the output of the machine learning algorithm, the task recommendation system 512 may generate the project proposals and/or the recommendations for seeking approval described herein. As may be contemplated, the use of such machine learning and/or artificial intelligence techniques and the results thereof may reduce the number of unnecessary interactions between the member 518 and the representative 506 and thus may better tailor the process of generating a project 502 that is tailored to the member's needs.

As may be contemplated, in some embodiments, the project proposal and/or the recommendations as to whether to send the project proposal to the member before proceeding can be generated by a combination of the methods described herein and/or other such methods. For example, the representative 506 may know that an event for the member 518 is coming up, the task recommendation system 512 may send an alert regarding the upcoming anniversary, and the context of previous messages between the member 518 and the representative 506 may indicate that the member 518 likes to plan surprise getaways for their parents. The combination of these elements may then be used to generate a project proposal which may or not then be presented to the member 518 for approval based on the factors such as those described above.

Once a project 502 is initiated by, for example, one or more of the methods described above, the representative 506 may then begin associating one or more tasks 504 with the project 502. In some embodiments, a project has a defined minimal set of information needed to begin associating one or more tasks 504 with the project 502. Examples of a defined minimal set of information needed to begin associating one or more tasks 504 with the project 502 may include, but may not be limited to, a date, a location, and a budget. As may be contemplated, different projects and/or different tasks may have different defined minimal sets of information needed to begin associating the one or more tasks with the project. For example, the scope and the nature of the information (i.e., the defined minimal set of information) that is needed to begin associating one or more tasks with a project to plan an anniversary weekend is different than the scope and nature of the information that is needed for a project to plan a move to a foreign country and both are different than the scope and nature of the information that is needed for a project to get a car serviced and new tires installed.

In an embodiment, the task recommendation system 512 can determine which additional information is needed to begin associating the one or more tasks 504 with the project 502. Such determination may be based on a template for the project and/or for templates for possible tasks associated with the project, as described herein. Such determination may also be based on previous tasks associated with the member (e.g., the member has had projects for previous anniversary weekends, or the member has had projects for previous weekend getaways, or the member has had projects for previous surprises for their parents) and/or information garnered from the member profile associated with the member 518. Such determination may also be based on similar tasks either associated with the member 518 or with other members (e.g., a birthday weekend project for the member 518 or an anniversary weekend for another member).

In an embodiment, the representative 506 determines which additional information is needed to begin associating the one or more tasks 504 with the project 502. Such determination may again be based on a template for the project and/or for templates for possible tasks associated with the project, as described herein. Such determination may also be based on previous tasks associated with the member (e.g., the member has had projects for previous anniversary weekends, or the member has had projects for previous weekend getaways, or the member has had projects for previous surprises for their parents). Such determination may also be based on similar tasks either associated with the member 518 or with other members (e.g., a birthday weekend project for the member 518 or an anniversary weekend for another member). Such determination may also be based on personal knowledge or experiences that the representative has about the member 518. In an embodiment, the task recommendation system 512 can automatically identify the portions of the member profile that may be used to obtain the additional information needed to begin associating the one or more tasks 504 with the project. For example, if the representative selects a template corresponding to an evening out at a restaurant, the task recommendation system 512 may automatically process the member profile to identify any information corresponding to the member's dietary preferences and restrictions that may be used to populate one or more fields within the template selected by the representative 506.

In an embodiment, the determination of which additional information is needed to begin associating the one or more tasks 504 with the project 502 is made by a combination of these and/or other such techniques. For example, the task recommendation system 512 may determine some of the additional information is needed to begin associating the one or more tasks 504 with the project 502, the representative 506 may determine some of the additional information is needed to begin associating the one or more tasks 504 with the project 502, and other techniques (e.g., external databases, environmental factors, demographics, etc.) may determine some of the additional information is needed to begin associating the one or more tasks 504 with the project 502.

Once it is determined which additional information is needed to begin associating the one or more tasks 504 with the project 502 (e.g., the defined minimal set of information), the additional information can be gathered. In an embodiment, the representative 506 gathers the additional information that may be needed to begin associating one or more tasks 504 with the project 502. For example, the representative may gather additional information as to which weekend the anniversary falls on, what the parents like to do, what the budget is, where the parents live, how far they might want to travel, etc.). In some instances, the representative 506 may obtain this additional information through manual evaluation of the member profile associated with the member 518. In an embodiment, the task recommendation system 512 may automatically identify the portions of the member profile that may be used to associate the one or more tasks 504 with the project 502. The representative 506 may review these automatically identified portions of the member profile to ensure that the association is performed accurately. If the representative 506 makes any changes to the information automatically identified by the task recommendation system 512 (based on the representative's personal knowledge of the member 118, etc.), the task recommendation system 512 may use these changes to automatically update the member profile to incorporate these changes. In some instances, if changes are to be made to the member profile as a result of the changes made by the representative 506, the task recommendation system 512 may prompt the member 518 to verify that the proposed change to the member profile is accurate. If the member 518 indicates that the proposed change is inaccurate, or the member 518 provides an alternative change, the task recommendation system 512 may automatically update the association and the member profile to reflect the accurate information, as indicated by the member 518.

In the example where the member sends a message stating “I need to start a project for my parents' anniversary weekend,” the representative 506 may need to determine which weekend that is, what the parents like to do, what the budget is, where the parents live, how far they might want to travel, and/or other such information. In an embodiment, the representative 506 sends messages to the member 518 requesting the additional information. However, as may be contemplated, such requests for additional information may unnecessarily increase the cognitive load on the member and it may be useful to minimize directly requesting the additional information.

In an embodiment, the representative 506 uses the task recommendation system 512 to determine some or all of the missing information for the project. For example, as described above, data associated with the member 518 stored in the member profile may be used to determine one or more elements of missing information (e.g., which weekend the anniversary is, what the parents like to do, what the budget is, where the parents live, how far they might want to travel, and/or other such information). Additionally, other information intuited from the analysis of previous conversations between the member and the representative may be used to determine one or more other elements of missing information and/or may be used to verify determined elements of missing information. Such known and missing information may be referred to herein as “project parameters.” Such known and missing information may also be referred to herein as “task parameters” when, for example, the project parameters are directly related to particular tasks 504 associated with the project 502. As may be contemplated, other systems of the task facilitation service such as those described herein may be used to identify and obtain the missing information for the project 502.

In the example where the project initially includes less information (e.g., “I need to start a project to plan a weekend getaway”), the representative 506 may have more missing information for the project and may, in some embodiments, use additional sources including, but not limited to, soliciting information directly from the member 518, reviewing the member profile associated with the member 518, or looking at external data sources. The techniques described above in the previous example (e.g., data associated with the member stored in the member profile and/or information intuited from the analysis of previous conversations between the member and the representative) may also be used to reduce or eliminate the amount of information that is solicited directly from the member, thereby minimizing the cognitive load on the member.

In the example where the project initially includes more information (e.g., “I need to start a project to plan my parents' anniversary weekend on the weekend of May 20th”) or where the project is generated by the task recommendation system 512 and/or by the member from a more complete set of information, any missing information associated with the project may also use additional sources including, but not limited to, soliciting information directly from the member 518 and/or reviewing the member profile associated with the member 518. The techniques described above in the previous example (e.g., data associated with the member stored in the member profile and/or information intuited from the analysis of previous conversations between the member and the representative) may also be used to reduce or eliminate the amount of information that is solicited directly from the member.

In the example where the message transmitted by the member includes little to no information (e.g., “I need to start a project”), the representative may begin with soliciting information directly from the member 518 and then use that solicited information to determine as much of the missing information while minimizing the amount of information subsequently solicited directly from the member 518, thereby at least mitigating the cognitive load on the member 518. In some instances, any information obtained through this solicitation for information from member 518 may be used to supplement the member profile. For instance, if the member 518 indicates that they need to start a project for their parents' anniversary, and provided detailed information regarding their parents, the representative 506 may update the member profile associated with the member 518 to include this detailed information regarding the member's parents (if not present within the member profile).

In an embodiment, the task recommendation system 512 can automatically process member responses to the representative's solicitation of information to populate the member profile. For instance, the task recommendation system 512 can monitor, automatically and in real-time, messages exchanged between the member 518 and the representative 506 to identify any information that may be used to supplement the project 502 and to update the member profile. For instance, the task recommendation system 512 may utilize natural language processing (NLP) or other artificial intelligence to evaluate received messages or other communications from the member 518 to identify any information that may be used to supplement the project 502 and/or the member profile. In some instances, the task recommendation system 512 may utilize historical data corresponding to messages exchanged between members and representatives to train the NLP or other artificial intelligence to identify information that may be used to supplement the project 502 and the member profile.

It should be noted that each of these examples are for projects to plan an anniversary weekend for the member's parents and, accordingly, each has the same defined minimal set of information needed to begin associating the one or more tasks 504 with the project 502. The defined minimal set of information needed to begin associating the one or more tasks 504 with the project 502 is based on the nature and scope of the project. However, as each of the examples begins with a different set of provided information, the processes whereby the information is gathered to satisfy the defined minimal set of information needed to begin associating the one or more tasks 504 with the project 502 may be different in the different examples illustrated. It should also be noted that the defined minimal set of information needed to begin associating the one or more tasks 504 with the project 502 may not be all of the information needed to complete associating the one or more tasks 504 with the project 502. For example, a representative 506 may be able to begin associating one or more tasks with a project to for an anniversary weekend without knowing, for example, that the member's mother has special dietary requirements (e.g., that she is vegan). A task (or task component) associated with a project to plan an anniversary weekend may be to plan a special anniversary dinner for the parents. Later on in the proposal generation process, that task may be replaced by a task to plan a special anniversary dinner for the parents at a vegan restaurant.

With sufficient information to begin defining the tasks that will be performed by the representative 506 and/or one or more third-party services 516 or other services/entities affiliated with the task facilitation service on behalf of the member 518 to complete the project 502, the representative 506 can begin defining the tasks 504 that are to be performed in order to complete the project 502. In an embodiment, the representative 506 begins defining the tasks and generating one or more proposal options for completion of these tasks. In an embodiment, the proposal options define the tasks 504 that will be performed by the representative and/or one or more third-party services 516 and/or other services/entities affiliated with the task facilitation service on behalf of the member 518 to complete the project 502. In such an embodiment, there may be a “one-to-one” relationship between the proposal options and the tasks 504 (i.e., one proposal option corresponds to one task) or there may be a “one-to-many” relationship between the proposal options and the tasks 504 (i.e., one proposal option corresponds to a plurality of tasks) or there may be a “many-to-one” relationship between the proposal options and the tasks (i.e., a plurality of proposal option corresponds to a single task).

In an embodiment, the proposal options associated with the project 502 receive one or more proposal recommendations, which are recommendations for tasks 504 that will be performed by the representative 506 and/or one or more third-party services 516 and/or other services/entities affiliated with the task facilitation service on behalf of the member 518 to satisfy the proposal option and to complete the project 502. In an embodiment, proposal recommendations are obtained by the representative 506 from a task recommendation system 512. In an embodiment, proposal recommendations are generated by the representative 506 using information from a task recommendation system 512. In an embodiment, proposal recommendations are generated by the representative 506 using information from one or more third-party services 516 and/or other services/entities affiliated with the task facilitation service.

In an embodiment, proposal recommendations are generated by the representative 506 using information from task resources (e.g., user data storage 108 and user data storage 110, both described herein at least in connection with FIG. 1) provided the task recommendation system 512. In an embodiment, proposal recommendations are generated by the representative 506 using a combination of these and other such information sources. In an embodiment, proposal recommendations are generated by an assistant representative 522 using a combination of these and other such information sources. In such an embodiment, the assistant representative may be a junior representative, or may be another representative, or may be a bot configured to generate proposal recommendations using machine learning or artificial intelligence algorithms such as those described herein.

In some instances, the representative 506 may use a resource library maintained by the task facilitation service to obtain information corresponding to different third-party services 516, other services/entities affiliated with the task facilitation service, and tasks that may be performed for the particular type or category of project 502. For instance, an entry for a third-party service in the resource library may include contact information for the third-party service, any available price sheets for services or goods offered by the third-party service, listings of goods and/or services offered by the third-party service, hours of operation, ratings or scores according to different categories of members, and the like. The representative 506 may query the resource library to identify the one or more third-party services that are to perform the task and determine an estimated cost for performance of the task. In some instances, the representative may contact the one or more third-party services 516 to obtain quotes for completion of the task and to coordinate performance of the task for the benefit of the member 518.

In some instances, the resource library may further include detailed information corresponding to other services and other entities that may be associated or affiliated with the task facilitation service and that are contracted to perform various tasks on behalf of members of the task facilitation service. These other services and other entities may provide their services or goods at rates agreed upon with the task facilitation service. Thus, if the representative 506 selects any of these other services or other entities from the resource library, the representative 506 may be able to determine the particular parameters (e.g., price, availability, time required, etc.) for completion of the task.

In an embodiment, for a given task associated with the project 502, the representative 506 can query the resource library to identify one or more third-party services 516 and other services/entities affiliated with the task facilitation service from which to solicit quotes for completion of the task. For instance, for a newly created task, the representative 506 may transmit a job offer to these one or more third-party services 516 and other services/entities. The job offer may indicate various characteristics of the task that is to be completed (e.g., scope of the task, general geographic location of the member 518 or of where the task is to be completed, desired budget, etc.). Through an application or web portal provided by the task facilitation service, a third-party service or other service/entity may review the job offer and determine whether to submit a quote for completion of the task or to decline the job offer. If a third-party service or other service/entity opts to reject the job offer, the representative 506 may receive a notification indicating that the third-party service or other service/entity has declined the job offer. Alternatively, if a third-party service or other service/entity opts to bid to perform the task (e.g., accepts the job offer), the third-party service or other service/entity may submit a quote for completion of the task. This quote may indicate the estimated cost for completion of the task, the time required for completion of the task, the estimated date in which the third-party service or other service/entity is available to begin performance of the task, and the like. The representative may use any provided quotes from the third-party services and/or other services/entities to generate different proposals for completion of the task.

In an embodiment, once the proposal recommendations are received and/or generated, the representative 506 creates one or more proposals 508 using the proposal recommendations. A proposal may include a proposal recommendation for each of the proposal options. In an embodiment, proposal recommendations and/or proposals are ranked according to a number of criteria described herein. For example, a proposal recommendation may be ranked based on information obtained from a social media site, by the task facilitation service, by the representative 506, or based on cost, demographics, location, or other such criteria, or by a combination of these and/or other criteria. Similarly, in an embodiment, a proposal is ranked and/or marked as preferred. The ranking of a proposal may be based on an aggregation of the rankings of the proposal recommendations or it may be ranked using other ranking criteria such as those described herein.

In an embodiment, one or more of the proposals 508 are sent to the member 518 with or without the ranking and/or preferred designation. In an embodiment, the one or more of the proposals 508 are communicated to the member 518 and a process for accepting a proposal is initiated.

It should be noted that for the processes described herein, various operations performed by the representative 506 may be additionally, or alternatively, performed using one or more machine learning algorithms or artificial intelligence such as those described herein. For example, as the representative 506 and/or the task recommendation system 512 generate proposals, recommend proposals, coordinate tasks, and/or perform tasks on behalf of a member 518 over time, the task recommendation system 512 may continuously and automatically update the member profile according to feedback related to the generation of proposals, recommendation of proposals, coordination of tasks, and/or performance of tasks (by, for example, the representative 506, the task recommendation system 512, and/or the third-party services 516 or other services/entities affiliated with the task facilitation service).

In an embodiment, the task recommendation system 512, after the member profile associated with the member 518 has been updated over a period of time (e.g., six months, a year, etc.) or over a set of proposals, proposal recommendations, and tasks (e.g., twenty tasks, thirty tasks, etc.), may utilize a machine learning algorithm and/or artificial intelligence techniques to automatically and dynamically generate new proposals, proposal recommendations, and/or tasks based on the various attributes of the member profile (e.g., historical data corresponding to member-representative communications, member feedback corresponding to representative performance and presented tasks/proposals/recommendations, etc.) with or without representative interaction. The task recommendation system 512 may automatically communicate with the member 518 to obtain any additional information required for new projects and tasks and automatically generate proposals that may be presented to the member 518 for performance of these projects and tasks. The representative 506 may also monitor communications between the task recommendation system 512 and the member 518 to ensure that the conversation maintains a positive polarity (e.g., the member 518 is satisfied with its interaction with the task recommendation system 512, other systems of the task facilitation service, the representative 506, the assistant representative 522, other bots associated with the task facilitation services, etc.). If the representative 506 determines that the conversation has a negative polarity (e.g., the member 518 is expressing frustration or dissatisfaction, the task recommendation system 512 is unable to process the member's responses or asks, etc.), the representative 506 may intervene in the conversation. This may allow the representative 506 to address any member concerns and perform any tasks on behalf of the member 518, restoring a positive polarity.

Thus, unlike automated customer service systems and environments, wherein these systems and environment may have little to no knowledge of the users interacting with agents or other automated systems, the task recommendation system 512 can continuously update the member profile to provide up-to-date historical information about the member 518 based on the member's interaction with the system and/or interaction with the representative 506 and based on the proposals generated, the proposals recommended, and the tasks performed on behalf of the member 518 over time. This historical information, which may be automatically and dynamically updated as the member 518 and/or the systems of the task facilitation service interact with the representative 506 and as tasks are devised, proposed, recommended, and performed for the member 518 over time, may be used by the task recommendation system 512 to anticipate, identify, and present appropriate or intelligent responses to member 518 queries, needs, and/or goals.

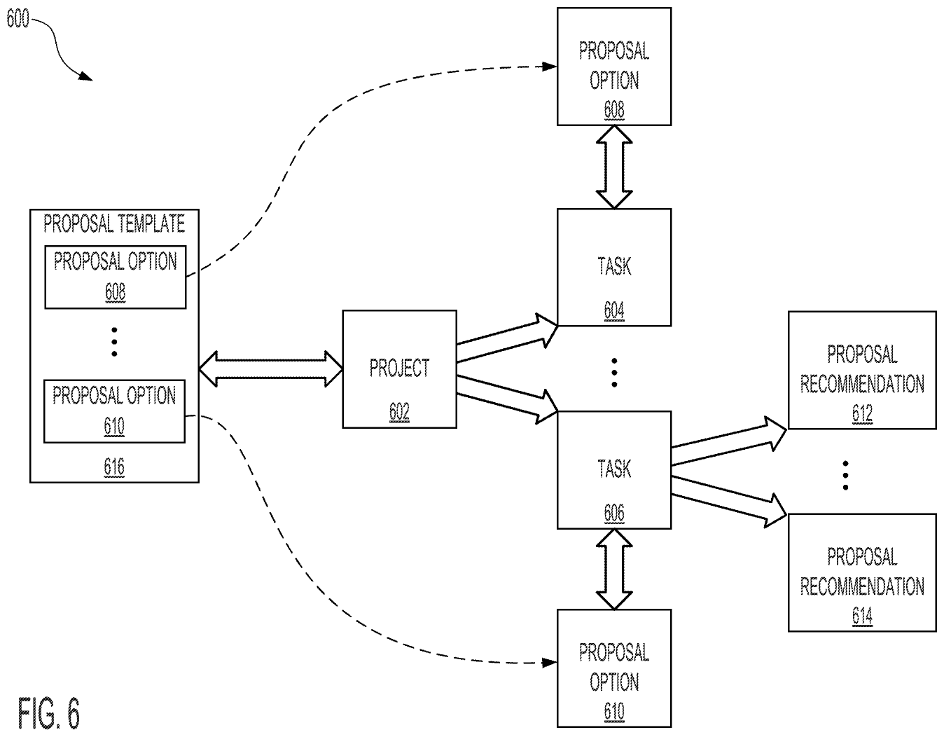

FIG. 6 shows an illustrative example of an environment 600 in which relationships between projects, tasks, proposal options, proposal templates, and proposal recommendations are shown in accordance with at least one embodiment. In an embodiment, the relationships between projects, tasks, proposal options, proposal templates, and proposal recommendations are used to rank proposals, which are then communicated to a member using systems and methods such as those described herein. In an embodiment, a project 602 (e.g., a project to plan a wedding anniversary weekend for a member's parents) is associated with one or more tasks (also referred to herein as task components) such as task 604 and task 606, which are in turn associated with proposal option 608 and proposal option 610 respectively. In such an embodiment, proposal option 608 and proposal option 610 are elements of proposal template 616, which is generated or selected for project 602.

Although illustrated here with a plurality of tasks, in some embodiments a project 602 has only a single task (e.g., task 604). For example, a project to get a member's car serviced may include only a single task corresponding to having the car serviced by a mechanic. In such embodiments, the project may have the single task, or the project and the single task may be the same (i.e., rather than a “has a” relationship, the project “is a” task and the task “is a” project). In such embodiments, the task may exist independently of a project so that, rather than presenting a proposal associated with a project as described herein, a proposal may be presented for the single task. In such embodiments, the single task may be one of a plurality of tasks that are to be performed for (or on behalf of) a member. Such single tasks may be grouped together in a “to do list” format that may also include one or more tasks that are associated with multi-task.

In an embodiment, a task (e.g., the task 604) is associated with a proposal option 608, which as used herein is an element of the proposal template 616. For example, for a project 602 to plan an anniversary weekend for a member's parents, the proposal template 616 used to define the tasks for the project may include a proposal option for a 2-night stay at a hotel (e.g., proposal option 608), a proposal option for a wine tasting (e.g., proposal option 610), a proposal option for a dinner in a restaurant (not depicted in example environment 600), and a proposal option for a surprise activity (also not depicted in example environment 600). In this example, each proposal option may have an associated task that is an element of the project so that the proposal option for the 2-night stay at the hotel may have an associated task to make a reservation at a hotel, the proposal option for the wine tasting may have an associated task to find an appropriate winery, the proposal option for dinner may have an associated task to find the restaurant and make a reservation, and the proposal option for the surprise activity to determine and schedule the surprise activity.

In an embodiment, a proposal option is associated with a plurality of tasks. For example, the proposal option for dinner may have an associated task to find the restaurant and another associated task to make a reservation at the restaurant. In another embodiment, a task associated with a proposal option has a plurality of sub-tasks. For example, a proposal option for dinner may have an associated task to find the restaurant and make the reservation and that task may have a plurality of sub-tasks (e.g., find the restaurant, make the reservation, make a parking reservation, determine the specials, ensure the restaurant has dishes for specific dietary requirements, etc.).

In an embodiment, a task (e.g., the task 606) has one or more proposal recommendations such as proposal recommendation 612 and proposal recommendation 614. For example, a task 606 (e.g., a task to find a wine tasting for the anniversary weekend for a member's parents) may have one or more proposal recommendations such as proposal recommendation 612 and proposal recommendation 614 to visit two different wineries near where the anniversary weekend will occur. As may be contemplated, for some tasks and in some locations there may be many options for proposal recommendations (e.g., to locate a winery for a wine tasting in Napa Valley) and for other tasks in other locations there may be only one proposal recommendation (e.g., to schedule a surprise activity in a location where the only option is bungee jumping). As may also be contemplated, for some tasks and in some location there may be no suitable options for proposal recommendations.

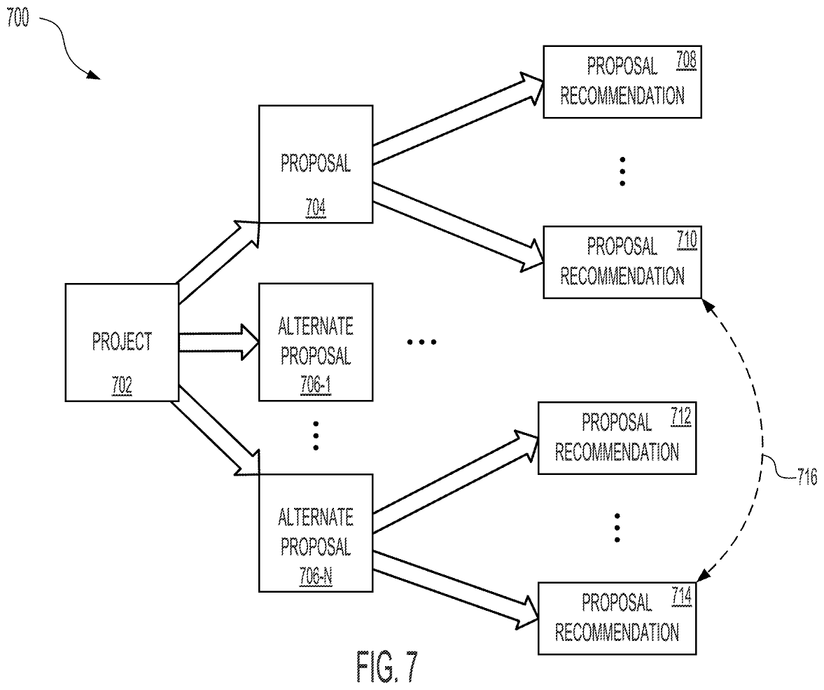

FIG. 7 shows an illustrative example of an environment 700 in which relationships between projects, tasks, proposals, and proposal recommendations are shown in accordance with at least one embodiment. As illustrated in FIG. 7, for a project 702 (which has a plurality of tasks associated with the project or which may be a single task) a proposal 704 may be generated and communicated using the systems and methods described herein. The proposal 704 may include one or more proposal recommendations (e.g., proposal recommendation 708 and proposal recommendation 710) where the proposal recommendations include a proposal recommendation directed to each of the tasks associated with the project. Although not illustrated in FIG. 7, each proposal recommendation may correspond to a task of the project and each task is generated from a proposal option associated with a proposal template as described herein.

In an embodiment, one or more alternate proposals 706-1-706-N are generated for the project 702. For example, for a task to find a place for dinner during the anniversary weekend for the member's parents, two different restaurant options may be available as proposal recommendations. In such an example, one proposal (e.g., proposal 704) may include a proposal recommendation for the first restaurant and one proposal (e.g., an alternate proposal of the one or more alternate proposals 706-1-706-N) may include a proposal recommendation for the second restaurant. Thus, each alternate proposal 706-1-706-N may correspond to different options for completion of a particular task or set of tasks associated with the project 702. These different options may serve as possible alternatives to the recommended option presented in the proposal 704 for completion of the particular task or set of tasks associated with the project 702.

Just as the proposal 704 includes one or more proposal recommendations (e.g., proposal recommendation 708 and proposal recommendation 710) where the proposal recommendations include a proposal recommendation directed to each of the tasks of the project, an alternate proposal of the one or more alternate proposals 706-1-706-N includes one or more proposal recommendations (e.g., proposal recommendation 712 and proposal recommendation 714) where the proposal recommendations also include a proposal recommendation directed to each of the tasks associated with the project.

In an embodiment, proposal recommendations can be presented to a member as part of more than one proposal. For example, proposal 704 includes proposal recommendation 708 and proposal recommendation 710 and an alternate proposal of the one or more alternate proposals 706-1-706-N includes a proposal recommendation 712 and a proposal recommendation 714. The dotted line 716 is an indicator that proposal recommendation 710 and proposal recommendation 714 are the same proposal recommendation. As an illustrative example, proposal 704 may include a proposal recommendation to attend a wine tasting at “Winery A” (e.g., proposal recommendation 708) and a proposal recommendation to have dinner at “Restaurant Z” (e.g., proposal recommendation 710) and an alternate proposal of the one or more alternate proposals 706 may include a proposal recommendation to attend a wine tasting at “Winery B” (e.g., proposal recommendation 712) but may also include a proposal recommendation to have dinner at “Restaurant Z” (e.g., proposal recommendation 714). In this example, proposal recommendation 710 and proposal recommendation 714 are the same, but in different proposals.

In an embodiment, one or more of the proposal recommendations are designated as a preferred recommendation. A preferred recommendation may be designated as such by the representative during proposal generation based on, for example, the representative's knowledge of the member's preferences. A preferred recommendation may also be designated as such due to one or more positive reviews of, for example, a third-party associated with the preferred recommendation. A preferred recommendation may also be designated as such by systems of the task facilitation service. A preferred recommendation may also be designated as such based on one or more other factors including, but not limited to, location, range of services available, promotional considerations (e.g., sponsored recommendations), demographics, political affiliation, or a combination of these and a plethora of other factors as may be contemplated. In some embodiments, a preferred recommendation is designated as such using a machine learning or artificial intelligence algorithm such as those described herein and based on one or more of the factors described above.

In an embodiment, based on member interaction with the proposal 704 and any alternate proposals 706-1-706-N, as well as with any corresponding proposal recommendations, the machine learning or artificial intelligence algorithm implemented to designate a preferred recommendation may be trained to more accurately designate preferred recommendations for different proposals. For instance, a proposal creation sub-system 302 (as described above in connection with FIG. 3) may monitor or track member interaction with the different proposals presented to the member to determine the member's preferences regarding the information presented in these proposals for a particular task or set of tasks. Further, the proposal creation sub-system 302 may monitor or track any messages exchanged between the member and the representative related to the different proposals and corresponding proposal recommendations to further identify the member's preferences. In some instances, the proposal creation sub-system 302 may solicit feedback from the member with regard to proposals provided by the representative to identify the member's preferences. This feedback and information garnered through member interaction with the representative regarding the different proposals and with the proposals themselves may be used to retrain the machine learning or artificial intelligence algorithm to more accurately designate preferred recommendations for the proposals presented to the member and other similarly-situated members. This feedback and information garnered through member interaction with the representative may be used to update a member profile or model associated with the member for use in determining preferred recommendations.

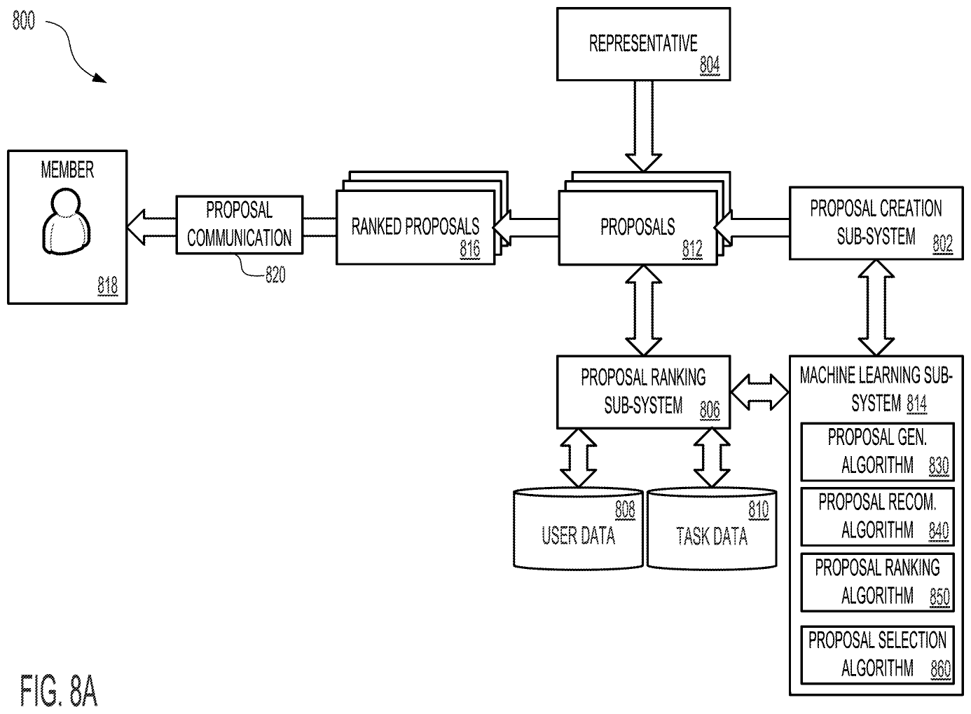

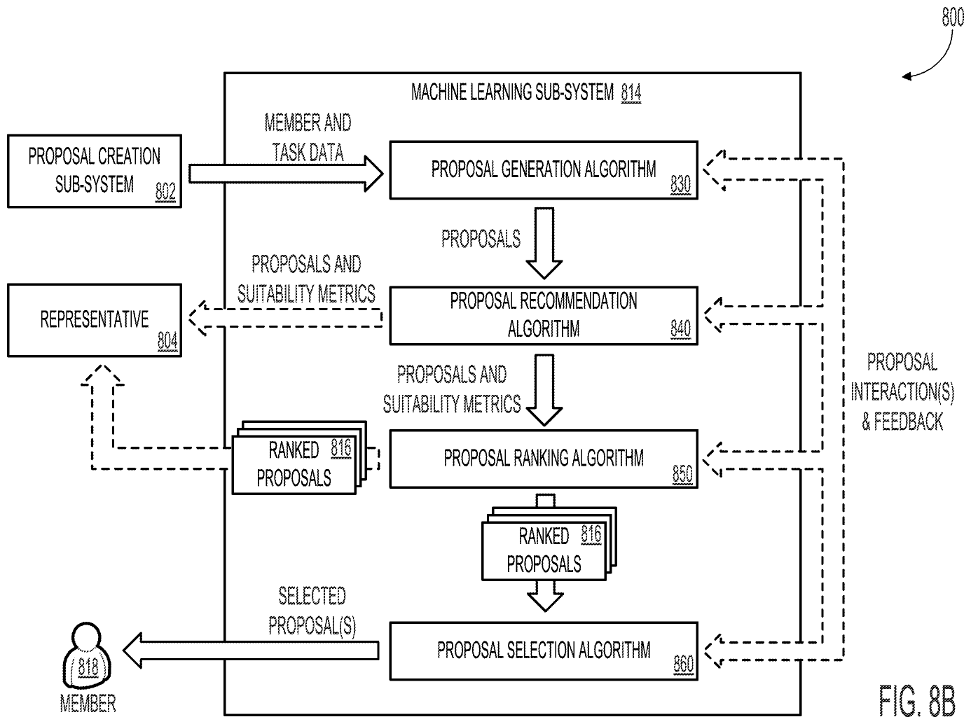

FIGS. 8A-8B show an illustrative example of an environment 800 in which ranked proposals are communicated to a member in accordance with at least one embodiment. In an embodiment, a proposal creation sub-system 802 generates proposals 812 using systems and methods such as those described herein. In an embodiment, the proposal creation sub-system 802 is a component of the task coordination system 114 described herein at least in connection with FIG. 1. In an embodiment, the proposal creation sub-system 802 is implemented as a component the task recommendation system 112 described herein at least in connection with FIG. 1.

As described above, the proposal creation sub-system 802 utilizes machine learning algorithms, artificial intelligence systems, and/or computational models to generate proposals 812 (illustrated in FIGS. 8A-8B as the proposal generation algorithm 830 implemented through the machine-learning sub-system 814). For example, as illustrated in FIG. 8B, the proposal creation sub-system 802 may use, as input to the proposal generation algorithm 830 member and task data corresponding to the member 818 and to the project or task that is to be performed for the benefit of the member, respectively. The member and task data may include, for example, a member profile or a model associated with the member and/or the member profile, historical task data for the member, and information corresponding to the project or task for which a proposal is being generated (i.e., the task parameters). In an embodiment, when a proposal is generated by the proposal generation algorithm 830, the proposal creation sub-system 802 monitors, in real-time, interaction with the task facilitation service to obtain data that can be used to further train the proposal generation algorithm 830. For example, if a proposal is generated by the proposal generation algorithm 830 and the representative 804 recommends some elements of the proposal over other elements, the proposal creation sub-system 802 may utilize this feedback to further train the proposal generation algorithm 830 to increase the likelihood of recommending preferred proposal elements.

As described above, when the proposal creation sub-system 802 generates the proposals 812, some or all of the proposal recommendations of the proposals 812 may be generated using a machine learning algorithm, an artificial intelligence system, and/or a computational model, such as the proposal recommendation algorithm 840 described herein in connection with FIGS. 8A-8B. In an embodiment, the proposal recommendations include one or more indications of the suitability of the proposal recommendations. Such indications of the suitability of the proposal recommendation (also referred to herein as a “suitability metric” for the proposal recommendation) may be automatically generated by the proposal creation sub-system 802 using the proposal recommendation algorithm 840.

In an embodiment, the representative 804 receives the proposals 812 and coordinates the ranking of the proposals so that the ranked proposals 816 can be communicated 820 to the member 818. In an embodiment, the representative 804 ranks the proposals 812 to produce the ranked proposals 816. In an embodiment, the representative 804 ranks the proposals 812 to produce the ranked proposals 816 using the suitability metrics so that, for example, a proposal with a high suitability metric may be ranked higher than a proposal with a lower suitability metric. In an embodiment, the representative selects proposal recommendations from a proposal (e.g., one of the proposals 812) and/or selects proposal recommendations from one or more alternate proposals of the proposals 812 to produce the ranked proposals 816 using the suitability metrics.

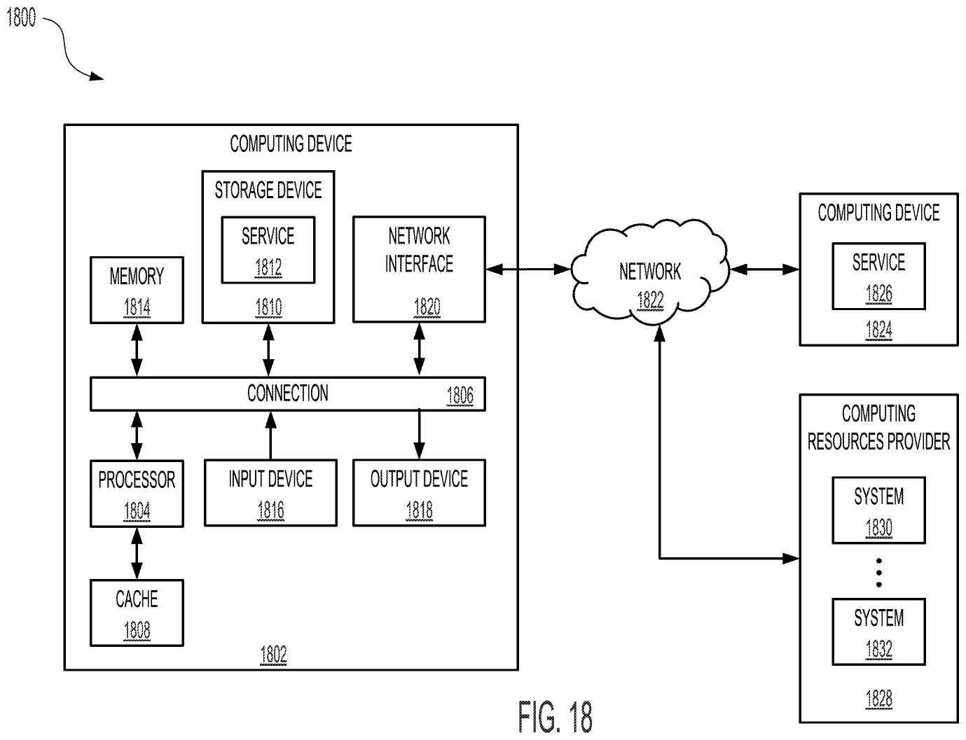

In an embodiment, a proposal ranking algorithm 850 is used to automatically rank the proposals so that the ranked proposals 816 can be communicated 820 to the member 818. In an embodiment, the ranking algorithm ranks the proposals 812 to produce the ranked proposals 816 using the suitability metrics so that, for example, a proposal with a high suitability metric may be ranked higher than a proposal with a lower suitability metric. In an embodiment, the proposal ranking sub-system 806 is implemented using a computer system such as the computing device 1802 described herein at least in connection with FIG. 18. In an embodiment, the proposal ranking sub-system 806 is implemented as an application or as other executable code implemented on a computer system of the task facilitation service.

In an embodiment, the machine learning sub-system 814 implements the proposal ranking algorithm 850, which may be a machine learning algorithm, an artificial intelligence system, and/or a computational model, to automatically rank the proposals so that the ranked proposals 816 can be communicated 820 to the member 818. In an embodiment, the proposal ranking sub-system 806 uses member profiles corresponding to different members associated with the task facilitation service as input to the proposal ranking algorithm 850 to rank the proposals. In an embodiment, the proposal ranking sub-system 806 uses project and/or task data as input to the proposal ranking algorithm 850 to rank the proposals. In an embodiment, the proposal ranking sub-system 806 uses data from previously generated proposals for the member 818 and/or for other members as input to the proposal ranking algorithm 850 to rank the proposals. In an embodiment, the proposal ranking sub-system 806 uses data obtained from the third-party services 116 as described herein at least in connection with FIG. 1 and/or other services/entities affiliated with the task facilitation service as input to the proposal ranking algorithm 850 to rank the proposals. The proposal ranking sub-system 806 may obtain member profiles, project and/or task data, data from previously generated proposals, third-party service data, and/or other such data from the user datastore 808 and the task datastore 810.

As illustrated in FIGS. 8A-8B, the proposal ranking sub-system 806 may use a machine learning sub-system 814, which may implement the proposal ranking algorithm 850, to rank the proposals so that the ranked proposals 816 can be communicated 820 to the member 818. In an embodiment, the machine learning sub-system 814 is a component of the proposal ranking sub-system 806. In an embodiment, the machine learning sub-system 814 is a component of the task recommendation service 102 described herein at least in connection with FIG. 1. In an embodiment, the machine learning sub-system 814 is a third-party service running, for example, as a service such as the service 1826 and operating on a computing device such as the computing device 1824, both of which are described herein at least in connection with FIG. 18. In an embodiment, the machine learning sub-system 814 is a service provided by a computing resources provider such as the computing resources provider 1828 described herein at least in connection with FIG. 18. In such an embodiment, the machine learning sub-system 814 may be running on a system such as the system 1830 and/or the system 1832, both of which are described herein at least in connection with FIG. 18.

In an illustrative example of how the proposal ranking sub-system 806 may use a machine learning sub-system 814 to implement a proposal ranking algorithm 850 to rank the proposals so that the ranked proposals 816 can be communicated 820 to the member 818, a project for a Parents' Anniversary Weekend may include a first proposal for a Wine Tasting Weekend, a second proposal for a different Wine Tasting Weekend, and a third proposal for a Ski Weekend. The first proposal may include preferred proposal recommendations for a 2-night stay, a Wine Tasting, and a Dinner and may include a recommendation for a Surprise Activity that is not preferred. The second proposal may include preferred proposal recommendations for the Wine Tasting and the Surprise Activity and may include recommendations for the Dinner and the Surprise Activity that are not recommended. The third proposal (for the Ski Weekend) may include preferred recommendations for the 2-night stay, a Ski Area, a Dinner, and a Surprise Activity but a Ski Weekend itself may not be preferred by the member and/or the member's parents. In this example, the proposal ranking algorithm 850 may rank the Wine Tasting Weekend proposals higher than the Ski Weekend and the first proposal for a Wine Tasting Weekend (with three preferred proposal recommendations) as higher than the second proposal for a Wine Tasting Weekend (with two preferred proposal recommendations) as lower than the first proposal, but higher than the third proposal (for the Ski Weekend).

In an embodiment, the representative 804 receives the output of the proposal ranking sub-system 806 and selects the proposals (i.e., the ranked proposals 816) to communicate to the member 818. For example, the representative 804 may examine each of the proposals and/or the proposal recommendations and, based on one or more suitability metrics, either select or deselect one or more proposals using systems and methods such as those described herein. In some instances, the representative 804 may either select or deselect the associated proposal based on their own personal knowledge of the member 818 (e.g., prior knowledge of the member's preferences, prior communications exchanged between the representative 804 and the member 818, examination of the member profile associated with the member 818, etc.). In an embodiment, the representative's selection or deselection of the associated proposal may be used to dynamically update the proposal ranking algorithm 850 described above. For example, if the representative 804 selects a particular proposal that does not have a high suitability metric and/or was not ranked highly by the proposal ranking algorithm 850, the proposal ranking sub-system 806 may use this feedback as an indication that the proposal ranking algorithm 850 may not have accurate ranked the proposals presented to the representative 804. Accordingly, the proposal ranking sub-system 806 may update the proposal ranking algorithm 850 such that, for similar projects and/or tasks, similar proposals are ranked more highly. As another illustrative example, if the representative 804 selects a particular proposal that has a high suitability metric and/or has been ranked highly by the proposal ranking algorithm 850, the proposal ranking sub-system 806 may use this feedback to reinforce the proposal ranking algorithm 850.

In an embodiment, the representative's selection or deselection of an associated proposal may be used to dynamically update, in real-time, the ranking of the set of proposals that may be communicated to the member 818 for a particular project or task. As noted above, if the representative 804 selects a particular proposal that does not have a high suitability metric and/or was not ranked highly by the proposal ranking algorithm 850, the proposal ranking sub-system 806 may use this feedback to update the proposal ranking algorithm 850 such that, for similar projects and/or tasks, similar proposals are ranked more highly. The newly updated proposal ranking algorithm 850 may again process the set of proposals for the particular project or task to dynamically, and in real-time, provide a new ranking of the set of proposals.

In some instances, if the representative 804 modifies one or more proposals (including any corresponding proposal recommendations) for a particular project or task, the proposal ranking algorithm 850 may dynamically, and in real-time, process the set of proposals for the particular project or task (including the modified one or more proposals) to provide a new ranking for the set of proposals. For example, if the representative 804 modifies a proposal to include an additional preferred proposal recommendation, the proposal ranking algorithm 850 may dynamically, and in real-time, update the ranking for the set of proposals such that the modified proposal may have a higher ranking as a result of the modified proposal including an additional preferred proposal recommendation. As another illustrative example, if the representative 804 designates a particular proposal recommendation as no longer being preferred, the proposal ranking algorithm 850 may dynamically, and in real-time, update the ranking for the set of proposals such that proposals including the no longer preferred proposal recommendation may be ranked lower compared to other proposals that still include other preferred proposal recommendations. Thus, as changes are made to the proposals by the representative 804 or by the systems described herein for different tasks and projects, the proposal ranking algorithm 850 may dynamically, and in real-time, update corresponding proposal rankings for proposals associated with these different tasks and projects.

In an embodiment, the machine learning sub-system 814 implements a proposal selection algorithm 860 to select the proposals (i.e., the ranked proposals 816) to automatically communicate to the member 818 on behalf of the representative 804. In an embodiment, the proposal selection algorithm 860 is implemented as a machine learning algorithm, artificial intelligence system, and/or computational model such as those described herein. In an embodiment, the proposal ranking sub-system 806 uses data such as member profiles, project or task data, data from previously generated proposals, and/or data obtained from third-party services and/or other services/entities associated with the task facilitation service as input to the proposal selection algorithm 860 to automatically select the proposals (i.e., the ranked proposals 816) to communicate to the member 818. As may be contemplated, the proposal ranking sub-system 806 may obtain the data from the user datastore 808 and the task datastore 810. In an embodiment, the proposal selection algorithm 860 is implemented by another component of the task facilitation service.

In some instances, the proposal selection algorithm 860 may be implemented using classical algorithms that may be configured to automatically process the suitability metrics associated with the proposals and/or the proposal recommendations and the corresponding ranks provided by the proposal ranking sub-system 806 to identify which of these proposals and/or proposal recommendations are to be communicated to the member 818. For example, the proposal selection algorithm 860 may automatically select a set number of proposals having the highest rankings, where the set number may be determined based on the member's preferences (as defined in the member profile associated with the member 818, indicated by the representative 804, and the like). In some instances, the proposal selection algorithm 860 may apply a weight to each of the individual rankings and individual suitability metrics associated with the proposals in order to calculate an aggregate score for each proposal. The aggregated scores for the set of proposals may be used to select which proposals are to be selected for presentation to the member 818.

In an embodiment, when the ranked proposals 816 are communicated 820 to the member 818, the ranked proposals 816 are reformatted from a format provided to the representative 804 to a format suitable to communicate the proposals to the member 818. In an embodiment, information provided with the proposals 812 to enable the representative 804 and/or the proposal ranking sub-system 806 to produce the ranked proposals 816 is removed from the ranked proposals 816 before the ranked proposals 816 are communicated 820 to the member 818. For example, the proposal creation sub-system 802 may include information such as internal rankings of various service providers, contact information for professionals associated with the various proposals, or other such information. In such an example, that information may be removed from the ranked proposals 816 when the ranked proposals 816 are reformatted from a format provided to the representative 804 to a format suitable to communicate 820 the proposals to the member 818. In an embodiment, the ranked proposals 816 are reformatted by the representative 804. In an embodiment, the ranked proposals 816 are automatically reformatted by a system (or sub-system) of the task recommendation system.

In an embodiment, one or more algorithms associated with the proposal communication process are updated when the proposals have been ranked and/or selected. For example, as illustrated in FIG. 8B, the proposal recommendation algorithm 840 associated with the proposal creation sub-system 802 may be updated based on the proposal ranking and/or proposal selection. As may be contemplated, if a proposal is generated by the proposal recommendation algorithm 840 and that proposal is not ranked highly and/or not selected as a ranked proposal to communicate to the member 818, the proposal recommendation algorithm 840 may be updated to reflect that that proposal was not a good recommendation. Similarly, if a proposal is generated by the proposal recommendation algorithm 840 and that proposal is ranked highly and/or selected as a ranked proposal to communicate to the member 818, the proposal recommendation algorithm 840 may be updated to reflect that that proposal was a good recommendation.

Similarly, the proposal ranking algorithm 850 may be updated so that when a proposal is not selected as a ranked proposal to communicate to the member 818, the proposal ranking algorithm 850 may be updated to reflect that the proposal was not a good recommendation. Alternatively, when a proposal is selected as a ranked proposal to communicate to the member 818, the proposal ranking algorithm 850 may be updated to reflect that the proposal was a good recommendation. In an embodiment, the representative 804 provides a final verification of the ranked proposals before they are communicated to the member 818. In such an embodiment, the proposal generation algorithm 830, the proposal recommendation algorithm 840, the proposal ranking algorithm 850, and/or the proposal selection algorithm 860 may be updated based on this final verification by the representative 804.

In an embodiment, the proposal ranking algorithm 850 is updated dynamically, continuously, and in real-time so that, for example, when the proposals 812 are received from the proposal creation sub-system 802, the proposal ranking algorithm 850 may be updated in real-time. Similarly, when the proposals 812 are ranked by the proposal ranking sub-system 806, the proposal ranking algorithm 850 may be updated in real-time. As may be contemplated, when the proposals 812 and/or the ranked proposals 816 are selected (e.g., using the proposal selection algorithm 860), when the representative 804 provides a final verification of the ranked proposals 816 before they are communicated 820 to the member 818, and/or when the ranked proposals are communicated 820 to the member 818, the proposal ranking algorithm 850 may be updated in real time. In an embodiment, the proposal ranking algorithm 850 is continuously and/or dynamically updated so that the proposal ranking algorithm 850 may be updated several times during the processes illustrated in FIGS. 8A-8B and described herein. In such an embodiment, the proposal ranking algorithm 850 may be updated more than once during the steps of the processes illustrated in FIGS. 8A-8B and described herein. For example, when the proposals 812 are ranked by the proposal ranking sub-system 806, a plurality of steps may be undertaken to rank the proposals. In such an example and in an embodiment where the proposal ranking algorithm 850 is continuously and/or dynamically updated, the proposal ranking algorithm 850 may be updated several times (i.e., during one or more of the plurality of steps undertaken to rank the proposals).

It should be noted that the proposal generation algorithm 830, the proposal recommendation algorithm 840, the proposal ranking algorithm 850, and the proposal selection algorithm 860 may be updated in real-time as different proposals are generated and ranked for communication to different members associated with the task facilitation service. For example, the proposal generation algorithm 830, the proposal recommendation algorithm 840, the proposal ranking algorithm 850, and the proposal selection algorithm 860 may continuously, and collectively, generate and rank different proposals for different tasks/projects associated with the member 818 and other members simultaneously in real-time. Further, as proposals are communicated to different members, any feedback corresponding to the ranking and selection of these proposals may be used to dynamically update the proposal generation algorithm 830, the proposal recommendation algorithm 840, the proposal ranking algorithm 850, and the proposal selection algorithm 860 in real-time such that, for other tasks/projects being processed contemporaneously and in real-time, the proposal generation algorithm 830, the proposal recommendation algorithm 840, the proposal ranking algorithm 850, and the proposal selection algorithm 860 may provide accurate results (e.g., proposals, rankings, selections, etc.).

In an embodiment, other algorithms described herein for the systems and methods used to communicate ranked proposals to a member are also updated dynamically, continuously, and in real-time. For example, when the proposal creation sub-system 802 generates the proposals 812 using a proposal generation algorithm 830 and a proposal recommendation algorithm 840 (as described herein above), the proposal generation algorithm 830 and the proposal recommendation algorithm 840 may be updated in real-time and at the time that the proposal generation algorithm 830 and the proposal recommendation algorithm 840 are used by the proposal creation sub-system 802 to generate the proposals 812. Similarly, the proposal generation algorithm 830 and the proposal recommendation algorithm 840 may be updated continuously and/or dynamically so that, for example, the proposal generation algorithm 830 and the proposal recommendation algorithm 840 may be updated several times during the processes for proposal generation described herein. Accordingly, when the proposal creation sub-system 802 generates the proposals 812 using the proposal generation algorithm 830 and the proposal recommendation algorithm 840 and a plurality of steps is undertaken to generate the proposals (as described herein), the proposal generation algorithm 830 and the proposal recommendation algorithm 840 may be updated several times (i.e., dynamically, continuously, and in real-time) during the plurality of steps undertaken to generate the proposals.

In another example of other algorithms that may be updated dynamically, continuously, and in real-time, when proposal ranking sub-system 806 implements, through the machine learning sub-system 814, a proposal selection algorithm 860 to select the proposals (as described herein above), the proposal selection algorithm 860 may also be updated in real-time and at the time that the proposal selection algorithm 860 is used by the proposal ranking sub-system 806 to select the proposals. Similarly, the proposal selection algorithm 860 may also be updated continuously and/or dynamically so that the proposal selection algorithm 860 may be updated several times during the processes for proposal selection (e.g., when the proposal ranking sub-system 806 selects the proposals 812, the proposal selection algorithm 860 may be updated several times during the steps undertaken to select the proposals).

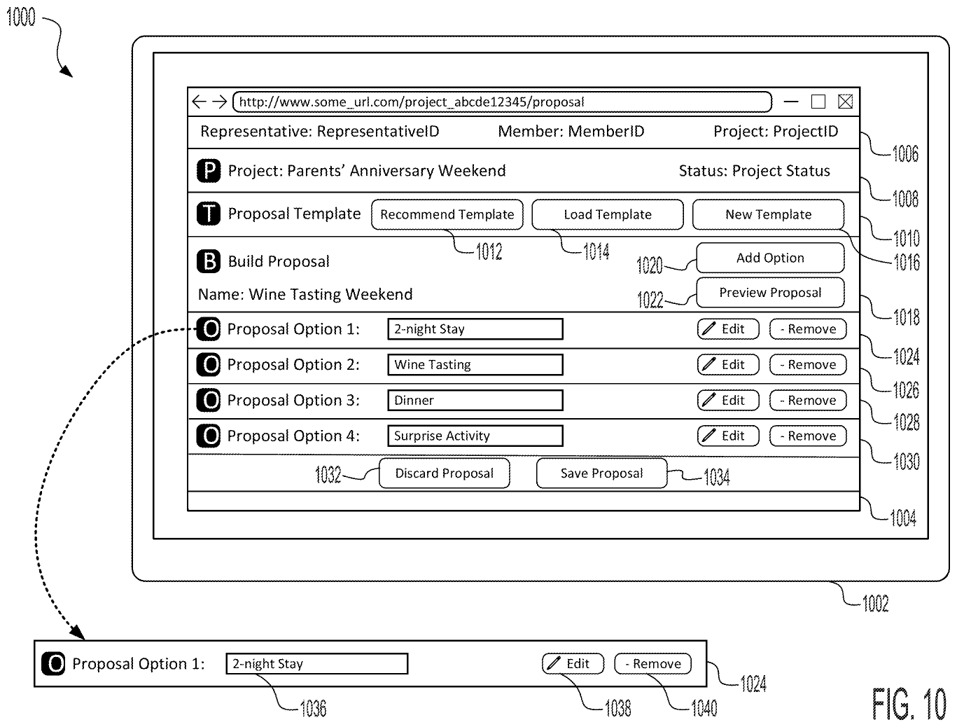

In an embodiment, the representative 804 interacts with the proposals 812 and/or the ranked proposals 816 using an application associated with the task facilitation service such as those described herein. In an embodiment, the proposals 812 and the ranked proposals 816, are communicated to the representative 804 via a network such as the network 1822 and displayed using an application running on a computing device such as the computing device 1802, both of which are described herein at least in connection with FIG. 18. The application used to display the proposals 812 and/or the ranked proposals 816 is described in more detail herein (see, for example, FIGS. 10-12). Interactions between the proposal creation sub-system 802, the machine learning sub-system 814, the proposal ranking sub-system 806, the user data 808, the task data 810, the representative 804, and/or other systems of the task facilitation service may also be facilitated by applications running on various computing devices and communicated using various networks such as those described herein.

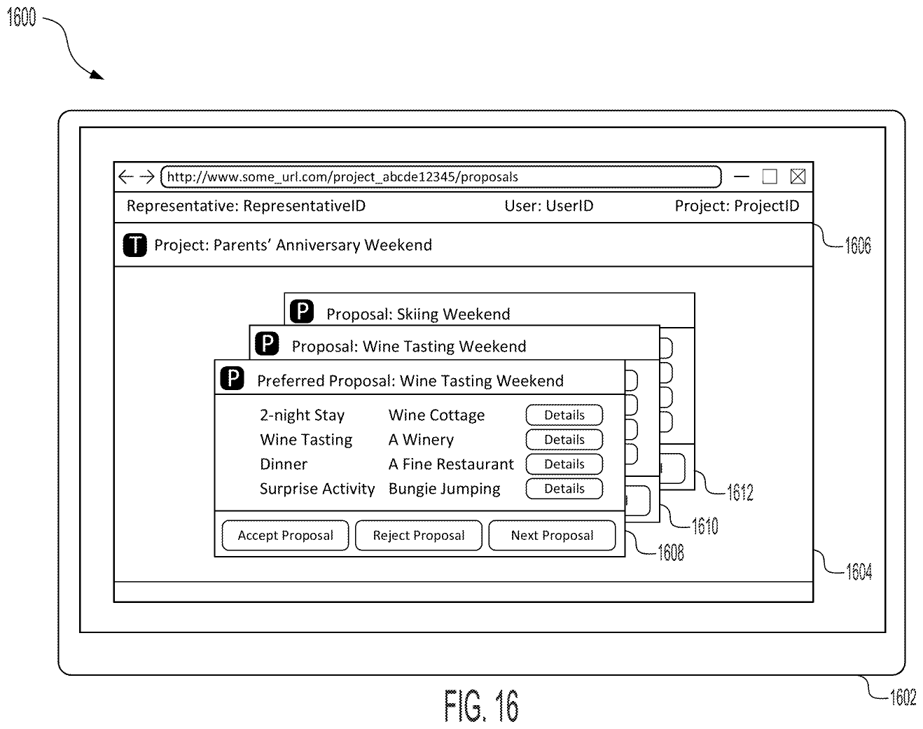

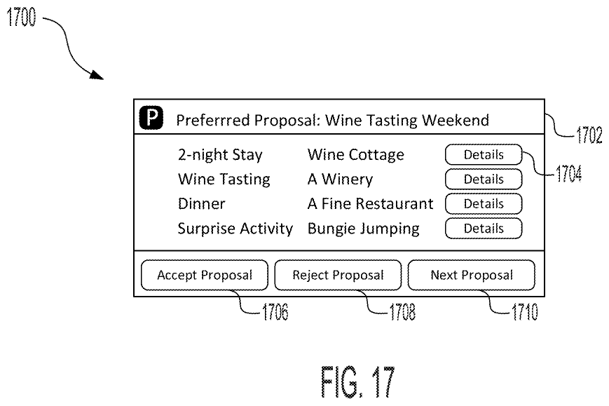

In an embodiment, the ranked proposals 816 are communicated 820 to the member 818. As described herein, in an embodiment, the ranked proposals 816 are communicated 820 to the member 818 via a network such as the network 1822 and displayed using an application running on a computing device such as the computing device 1802, both of which are described herein at least in connection with FIG. 18. The application used to display the ranked proposals 816 is described in more detail herein (see, for example, FIG. 16 and FIG. 17).

In an embodiment, the proposals 812 are sent directly to the member 818 without ranking, selecting, or reformatting by the representative 804 and without any ranking, selecting, or reformatting by systems or methods such as those described herein. In an embodiment, the ranked proposals 816 are ranked by the proposal ranking sub-system 806 and sent directly to the member 818 without any selecting or reformatting by the representative 804 and without any selecting or reformatting by systems or methods such as those described herein. In an embodiment, the ranked proposals are selected using the proposal selection algorithm 860 and sent to the member 818 without any reformatting by the representative 804 and without any reformatting by systems or methods such as those described herein. In an embodiment, the proposal communication process from proposal generation (e.g., by the proposal creation sub-system 802) to ranked proposal communication 820 to the member 818 is an automatic process, managed by systems and sub-systems of the task recommendation service such as those described herein.

As may be contemplated, the proposal communication process from proposal generation (e.g., by the proposal creation sub-system 802) to ranked proposal communication 820 to the member 818 is an automatic process, managed by systems and sub-systems of the task recommendation service such as those described herein and, as such, various operations performed by the representative 804 may be additionally, or alternatively, performed using one or more machine learning algorithms or artificial intelligence such as those described herein. For example, as proposals are generated, recommended, ranked, selected, and reformatted over time, systems of the task facilitation service may continuously and automatically update the member profile associated with the member 818 according to feedback related to that generation of proposals, recommendation of proposals, ranking of proposals, selecting of proposals, and reformatting of proposals as well as the coordination of tasks and/or performance of tasks.

In an embodiment and after a member profile associated with the member 818 has been updated over a period of time or over a set of proposals, proposal recommendations, elements of the proposal creation sub-system 802 and/or the proposal ranking sub-system 806 utilize machine learning algorithms, artificial intelligence systems, and/or computational models to automatically and dynamically generate new proposals, proposal rankings, proposal selections, and/or proposal formatting based on the various attributes of the member profile with or without the interaction of the representative 804. In an embodiment, the proposal creation sub-system 802 and/or the proposal ranking sub-system 806 automatically communicate with the member 818 to obtain information required for projects and can automatically generate, rank, select, and format proposals that may be presented to the member 818 for performance of tasks associated with the proposals. The representative 804 may also monitor communications between systems and sub-systems of the task facilitation service (e.g., the proposal creation sub-system 802 and/or the proposal ranking sub-system 806) and the member 818 to ensure that the conversation maintains a positive polarity as described herein. This may allow the representative 804 to address any member concerns and perform any tasks on behalf of the member 818, restoring a positive polarity to the conversation.

As described herein, member preferences (including dynamically evolving member preferences) may be used by proposal creation sub-system 802, the proposal ranking sub-system 806, and/or the machine learning sub-system 814 to automatically and dynamically generate new proposals, proposal rankings, proposal selections, and/or proposal formatting and also to dynamically, continuously, and in real-time update various algorithms used to generate new proposals, rank proposals, select proposals, and/or format proposals. For example, to reduce the cognitive load on members and their families in performing various tasks, ranked proposals 816 may be communicated 820 to the member 818 with only a minimal amount of information needed for the member to evaluate the proposal, thereby not overly burdening the member with extraneous information and, accordingly, reducing the cognitive load on members. In such an example, ranked proposals 816 may be formatted so that they are communicated 820 to the member broadly (e.g., “For your Parents' Anniversary Weekend, we propose A Wine Tasting Weekend”) with details about the proposal recommendations, proposal ranking, alternate proposals and/or other such information communicated to the member if requested by the member 818. In such an example, formatting the ranked proposals 816 so that they are communicated 820 broadly to the member 818 may be as a result of standing member preferences, or may be as a result of the member specifying minimal involvement with the proposal generation when defining the parameters of the task, or may be a result of the representative 804 knowing that the member 818 is currently very busy, or may be as a result of other systems and/or sub-systems of the task facilitation service determining that the member would prefer minimal information for this project and/or proposal recommendation. As may be contemplated, member preferences may evolve dynamically and one aspect of reducing the cognitive load on a member is for systems and/or sub-systems of the task facilitation service to dynamically respond to and/or anticipate those evolving preferences.

Accordingly, unlike automated customer service systems and environments, wherein these systems may have little to no knowledge of the users interacting with agents or other automated systems, systems and/or sub-systems of the task facilitation service (e.g., the proposal creation sub-system 802 and/or the proposal ranking sub-system 806) can continuously update the member profile to provide up-to-date information about the member 818. This up-to-date information may be based on the member's interaction with the systems and/or sub-systems of the task facilitation service and/or interaction with the representative 804. This up-to-date information may also be based on the proposals generated, the proposals recommended, the proposals selected, and/or the tasks performed on behalf of the member 818 over time. This information may be automatically and dynamically updated as the member 818 interacts with systems and/or sub-systems of the task facilitation service and/or interacts with the representative 804. This information may also be automatically and dynamically updated as proposals are generated, recommended, selected, formatted, and performed for the member 818 over time and this historical information may be used by the systems and/or sub-systems of the task facilitation service (e.g., the proposal creation sub-system 802 and/or the proposal ranking sub-system 806) to anticipate, identify, and present appropriate or intelligent responses to member 818 queries, needs, and/or goals.

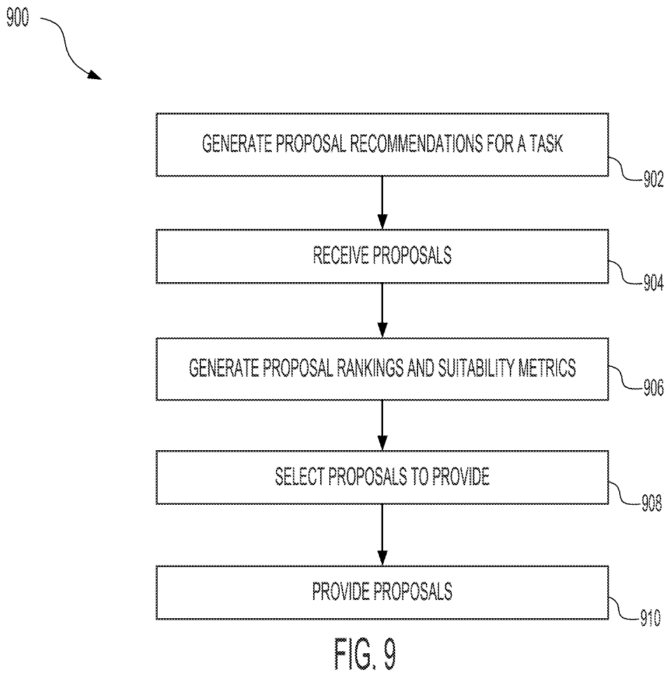

FIG. 9 shows an illustrative example of a process 900 for communicating proposal recommendations in accordance with at least one embodiment. Components of a task facilitation service such as the task facilitation service 102 described herein at least in connection with FIG. 1 may perform the example process 900 illustrated in FIG. 9. For example, the process 900 may be performed by a task coordination system and/or proposal creation sub-system of the task facilitation service (e.g., the task coordination system 314 and/or the proposal creation sub-system 302 of the task facilitation service, both of which are described herein at least in connection with FIG. 3).

At step 902 of the example process 900 for communicating proposal recommendations, components of the task facilitation service may automatically generate proposal recommendations for a task using systems and methods such as those described herein. In an embodiment, to generate the proposal recommendations, a proposal creation sub-system (as described above) trains a proposal recommendation algorithm using a dataset of sample task parameters and corresponding proposal recommendations. For example, task parameters may include a sample dataset of task parameters such as an allocated budget, a timeframe for completion of the task, preferred brands, preferred third-party services and/or other services/entities affiliated with the task facilitation service, and other task parameters. The dataset of sample task parameters used to train the proposal recommendation algorithm may be generated from actual tasks (e.g., previously proposed tasks), or may be generated from a hypothetical, theoretical, and/or idealized set of tasks, or may be generated from a combination of actual and hypothetical, theoretical, and/or idealized tasks. In some instances, the proposal recommendations may be generated by a representative associated with a particular member for which the task or project is being performed. For instance, the representative may generate proposal recommendations using information from task resources (e.g., user data storage 108 and user data storage 110, both described herein at least in connection with FIG. 1, a resource library, etc.) provided the task recommendation system. Proposal recommendations may additionally, or alternatively, be generated by an assistant representative using a combination of these and other such data sources.

At step 904 of the example process 900 for communicating proposal recommendations, components of the task facilitation service receive a set of proposals. As described herein, the set of proposals may be received from a proposal creation sub-system such as the proposal creation sub-system 302 described herein at least in connection with FIG. 3 using systems and methods such as those described herein.

At step 906 of the example process 900 for communicating proposal recommendations, components of the task facilitation service may generate proposal rankings and suitability metrics using systems and methods such as those described herein. As described herein, a suitability metric is a measure of the suitability of tasks in a proposal to satisfy the requirements of the project. For example, the suitability of recommending a task of bungie jumping as a surprise activity (as described herein) may be high for a member that enjoys adrenaline-based sports. Such a recommendation may have a high suitability metric. Conversely, the suitability of recommending a task of bungie jumping as a surprise activity (as described herein) may be low for a member that is afraid of heights. Such a recommendation may have a low suitability metric. In an embodiment, to generate the proposal rankings and suitability metrics for the tasks included in the proposals, the proposal ranking sub-system (as described herein) may train a proposal ranking algorithm using a dataset of sample proposal rankings and suitability metrics. As may be contemplated, the dataset of sample proposal rankings and suitability metrics may be generated from actual data (e.g., previous proposals and suitability metrics), or may be generated from a hypothetical set of proposals and suitability metrics, or may be generated from a combination of actual and hypothetical proposals and suitability metrics. In some instances, the proposal rankings and suitability metrics may be generated by a representative associated with a particular member for which the task or project is being performed. For instance, the representative may generate proposal rankings and suitability metrics based on their own personal knowledge of the member (e.g., prior knowledge of the member's preferences, prior communications exchanged between the representative and the member, examination of the member profile associated with the member, etc.).

At step 908 of the example process 900 for communicating proposal recommendations, components of the task facilitation service select a set of proposals from the ranked proposals to provide using systems and methods such as those described herein. For example, as described herein, a proposal selection algorithm may be used to select proposals from the ranked set of proposals. Alternatively, the proposals that are to be communicated to a member may be selected by a representative based on their personal knowledge of the member, as described above.

At step 910 of the example process 900 for communicating proposal recommendations, components of the task facilitation service provide the selected proposals to the member using systems and methods such as those described herein. For example, components of the task facilitation service may communicate the selected proposals to a member over a network so that the selected proposals may be displayed using an application running on a computing device of the member. The selected proposals, in an embodiment, are communicated to the member through a project or task-specific interface corresponding to the project or task for which the proposals are being provided.

It should be noted that the process 900 may include additional and/or alternative steps that may be performed to provide the selected proposals to a member for a particular project or task. For example, if the task facilitation service implements a recommendation algorithm and/or a ranking algorithm to generate proposal recommendations and proposal rankings, respectively, the task facilitation may update these algorithms in real-time. For example, a proposal that is not ranked highly and/or not selected may be used to update the recommendation algorithm so that subsequent recommendations will be less likely to recommend that proposal (e.g., for similar projects and/or for that member). Similarly, a proposal that is ranked highly but not selected may be used to update the ranking algorithm so that subsequent rankings will be less likely to rank that proposal highly (e.g., for similar projects and/or for that member and/or for similarly situated members).

FIG. 10 shows an illustrative example of an environment 1000 in which a proposal is generated in accordance with at least one embodiment. In an embodiment, the generated proposal is communicated to a member using systems and methods such as those described herein. In an embodiment, a computing device 1002 is used to display an application 1004. The application 1004, as illustrated in FIG. 10, may be accessed via a web portal provided by the task facilitation service. However, in some instances, the application 1004 may be provided via a standalone application provided by the task facilitation service and executed on the computing device 1002.

In an embodiment, a representative associated with a particular member interacts with systems of the task facilitation service via the computing device 1002. In an embodiment, the application 1004 displays user interface elements including, but not limited to, icons, text, buttons, dropdown lists, radio buttons, check boxes, and visual canvases to convey information obtained from systems of the task facilitation service, obtained from a member, obtained from a third-party or other service/entity affiliated with the task facilitation service, and/or obtained from other sources. In an embodiment, the application 1004 uses these user interface elements to obtain information from the representative and to provide the obtained information to systems of the task facilitation service, to the member, to a third-party or other service/entity affiliated with the task facilitation service, and/or to other information subscribers.

In an embodiment, the application 1004 receives the obtained information via a network interface (e.g., the network interface 1820 described herein at least in connection with FIG. 18) that is associated with the computing device 1002 (e.g., the computing device 1802, the computing device 1824, or a computing device associated with the computing resources provider 1828, all described herein at least in connection with FIG. 18). In an embodiment, the application 1004 provides the information obtained from the representative via the network interface that is associated with the computing device 1002.

In an embodiment, user interface elements of the application 1004 are used to display an information bar 1006 that specifies information including, but not limited to, an identifier of the representative, an identifier of the member, and an identifier of a current project or task for which one or more proposals are being generated. As illustrated in FIG. 10, the current project includes a plurality of tasks. However, in certain instances, a project may include a single task. Thus, the identifier of the current project may be an identifier of a particular project, may be an identifier of an individual task, or may be an identifier of an aggregate project that includes tasks from multiple sources (e.g., a “to do list” aggregate project as described herein). In some instances, the current project may include no tasks (i.e., is an empty project).

In an embodiment, user interface elements of the application 1004 are used to display a title bar 1008 that specifies information including, but not limited to, a name of the current project and the status of the current project. In an embodiment, the name of the current project is a short descriptive title associated with the project (e.g., “Parents' Anniversary Weekend”). In some instances, the name of the current project may be a default name assigned by the task facilitation service. In such an embodiment, the current project may also include a short description of the project that may, in some embodiments, also be displayed in the title bar 1008. In an embodiment, the status of the current project is selected from a list of possible statuses that may be stored by the systems of the task facilitation service. For example, the project status of the current project may be “open,” “closed,” “active,” “inactive,” “on track,” “behind,” or a combination of these and/or other such statuses. In an embodiment, the project status is selected from a predefined list. In an embodiment, the project status is a free-form field that can, for example, be entered by the representative using user interface elements of the application 1004.

In an embodiment, user interface elements of the application 1004 are used to display a proposal template bar 1010 that further specifies user interface elements that the representative can use to associate project and/or task templates with the current project. In the embodiment illustrated in FIG. 10, the proposal template bar 1010 includes a recommend template button 1012, a load template button 1014, and a new template button 1016.

In an embodiment, the recommend template button 1012 is used by the representative to obtain an automatically generated template for the current project. The automatically generated template may include one or more proposal options that can be used to define tasks for the current project using systems and methods such as those described herein (e.g., using a machine learning or artificial intelligence algorithm that analyzes data from other project templates, projects, tasks, and/or other such sources to provide the automatically generated template, etc.). In another embodiment, systems of the task facilitation service automatically generate a template without receiving a deliberate request to do so from the representative (e.g., using the recommend template button 1012). In such an embodiment, the automatically generated template may be automatically generated when the project is created, or may be automatically generated when the minimal set of information is obtained by the representative as described above, or may be automatically generated at some other point in the project generation process. In such an embodiment, the automatically generated template may also be generated using a machine learning or artificial intelligence algorithm that analyzes data from other project templates, projects, tasks, and/or other such sources to provide the automatically generated template.

In some instances, selection of the recommend template button 1012 may cause the systems of the task facilitation service to query the resource library to identify a proposal template that may correspond to the particular project or individual task and that may be recommended to the representative. As noted above, the task facilitation service maintains different proposal templates corresponding to different task types or categories within a resource library. Accordingly, based on any project and/or task-related information provided by the representative through the application 1004 regarding the particular project or individual task for which a proposal is being generated, the systems of the task facilitation service may automatically identify, from the resource library, a proposal template associated with a task category or type corresponding to the project or task identified by the representative through the application 1004.

In an embodiment, the load template button 1014 is used by the representative to load a template for the current project. The loaded template may, in some embodiments, be loaded from a resource library or other template repository maintained by the task facilitation service. As with the automatically generated template above, the loaded template may include one or more proposal options that can be used to define tasks for the current project-. In an embodiment, the representative can load a specific template based on their personal knowledge of the project or on one or more parameters associated with the project (e.g., the type of project, the member for which the project is being performed, etc.). For example, the representative may have a previously saved template for planning a weekend getaway from a previous project. In another example, the representative may load the template from a set of templates associated with the representative. For instance, if the representative selects the load template button 1014, the systems of the task facilitation service may query the resource library to identify any proposal associated with the representative. These may include any incomplete or previously completed proposal templates that the representative prepared for the member or other members associated with the representative. Further, these proposal templates may include any proposal templates that the representative has opted to save for future use and/or that have been customized by the representative based on the representative's own preferences (e.g., custom data fields, etc.).

In another example, the representative may load the template from a set of templates associated with the member. For instance, if the representative selects the load template button 1014, the systems of the task facilitation service may query the resource library to identify any proposal templates that are associated with the member. These proposal templates may include those templates previously used to generate proposals for projects and/or individual tasks performed for the benefit of the member. Information corresponding to these previously used proposal templates may be stored in the member profile associated with the member. Thus, in response to selection of the load template button 1014, the systems of the task facilitation service may automatically process the member profile to identify any other previously performed or active projects and tasks for which proposals have been generated. Based on these identified projects and tasks, the systems of the task facilitation service may determine which proposal templates were used to generate proposals for these projects and tasks. Subsequently, the systems of the task facilitation service may use the result of this determination to query the resource library in order to obtain these proposal templates for the representative.

In some instances, if the representative selects the load template button 1014, the systems of the task facilitation service may update the application 1004 to present a graphical representation of the resource library. Through this graphical representation of the resource library, the representative may be presented with various proposal templates that may be available to the representative for generating a proposal. Additionally, through this graphical representation of the resource library, the representative may submit a query to identify one or more proposal templates that may be relevant to the submitted query. For example, if the representative submits a query with the string “vehicle maintenance,” the systems of the task facilitation service may update the interface to provide any proposal templates that may be associated with the terms “vehicle,” “maintenance,” and/or “vehicle maintenance.” From these proposal templates, the representative may select an appropriate proposal template for generating a proposal associated with the particular project or individual task.

In an embodiment, the new template button 1016 is used by the representative to create a new template for the current project. In an embodiment, the new template is a blank template that does not initially include any proposal options. In an embodiment, the new template is a template shell which may include a partial set of proposal options. In an embodiment, the new template is based on an existing template. In such an embodiment, the new template button 1016 may cause the application 1004 to display an additional user interface element (not illustrated herein) usable to, for example, create a new blank template, a new template from a designated template shell, a new template based on one or more previous projects, a new template based on other templates of the task facilitation service, or a new template based on other such sources.

In an embodiment, user interface elements of the application 1004 are used to display a build proposal bar 1018 that further specifies user interface elements that the representative can use to add additional elements to a proposal and/or to display the proposal that is associated with the current project or individual task. In the embodiment illustrated in FIG. 10, the build proposal bar 1018 includes an add option button 1020 and a preview proposal button 1022. In the embodiment illustrated in FIG. 10, the build proposal bar 1018 also includes a name of the proposal. In an embodiment, the name of the proposal is a short descriptive title of the proposal (e.g., “Wine Tasting Weekend”). In an embodiment, the name of the proposal has a default name assigned by systems of the task facilitation service. In such an embodiment, a short description of the proposal may also be displayed in the build proposal bar 1018.

In an embodiment, the add option button 1020 is used by the representative to add a new proposal option to a proposal that is being generated for the current project. As previously discussed herein, proposal options for a proposal may come from a proposal template. For example, a proposal template for a wine tasting weekend may have proposal options for a two-night stay, a wine tasting, a dinner, and a surprise activity. In an embodiment, proposal options from a proposal template are more general so that, for example, a proposal template for a wine-tasting weekend may include a hotel stay (e.g., with unspecified length), a wine-tasting, a special meal, and a more-generally specified activity. In such an embodiment, the representative may then refine the proposal options to, for example, the two-night stay, the dinner, and the surprise activity. In an embodiment, proposal options from a proposal template can be even more general including, for example, only a “lodging” proposal option and one or more “activities” options. In such an embodiment, the representative may then refine the proposal options as described above. In an embodiment, the proposal template is empty and thus, has no proposal options. In such an embodiment, the representative may then refine the proposal options as described above.

One way that a representative may refine the proposal options of a proposal is by using the add option button 1020. For example, for a proposal template with only a “lodging” proposal option and one or more “activities” options, the representative may use the add option button 1020 to add a wine-tasting proposal option and a dinner proposal option. In an embodiment, a proposal option can be added from the resource library, which may maintain various proposal options, using the add option button 1020. In an embodiment, a proposal option can be added from one or more proposal templates maintained in the resource library using the add option button 1020. For example, a proposal option from a proposal template corresponding to a “surfing trip” may be added to a wine tasting proposal in order to provide a possible surfing excursion to the wine tasting weekend. In an embodiment, a proposal option can be added from other projects or tasks maintained in the resource library using the add option button 1020. Such other projects may be projects associated with the member, projects associated with other members that may be assigned to the representative, projects associated with other members of the task facilitation service, or projects from some other source. In an embodiment, custom options can be added to a proposal using the add option button 1020 so that, for example, a proposal option to go surfing may be added to a wine tasting weekend proposal directly. In an embodiment, proposal options may be recommended and/or added automatically using a machine learning algorithm that, for example, analyzes project and template data from previous projects and templates to generate proposal options suitably tailored to a particular project or project template.

In an embodiment, the user interface elements of the application 1004 are used to display one or more proposal option bars (e.g., the proposal option bar 1024, the proposal option bar 1026, the proposal option bar 1028, and the proposal option bar 1030) that further contain user interface elements that the representative can use to add additional elements or to edit proposal options for the proposal that is associated with the current project. In the embodiment illustrated in FIG. 10, a proposal bar (e.g., the proposal option bar 1024, illustrated in greater detail in the lower part of FIG. 10) a proposal option text field 1036, an edit proposal option button 1038, and a remove proposal option button 1040. In an embodiment, the proposal option text field 1036 includes the name of the proposal option (e.g., “2-night stay”). In some instances, the proposal option text field 1036 may include a short description of the proposal option (e.g., “2-night stay at a hotel in the wine region”). Alternatively, the name of the proposal option may have a default name assigned by systems of the task facilitation service. In addition to this default name, a short description of the proposal may also be displayed in the proposal option bar 1024.

In addition to using the add option button 1020 to refine the proposal options of a proposal, the representative may also refine the proposal options of a proposal options using the edit proposal option button 1038 and the remove proposal option button 1040. In an embodiment, the edit proposal option button 1038 is used by the representative to edit a corresponding proposal option. Such edits may include adding more specific details to the proposal option. For example, the general proposal template for a wine-tasting that includes a hotel stay with unspecified length described above may be edited using the edit proposal option button 1038 so that the representative may then refine the proposal options to a two-night stay. Such edits may also include providing custom proposal options to a proposal so that, for example, the representative may use the add option button 1020 to add a blank custom proposal option to the proposal and, using the edit proposal option button 1038 to refine the blank custom proposal option to incorporate a surfing expedition during the wine tasting weekend. In an embodiment, the remove proposal option button 1040 is also used to refine a proposal by providing a way for the representative to remove extraneous proposal options. For example, the member's parents may live near the winery and so the proposal option for a 2-night stay may not be necessary in that case.

It should be noted that proposal options may be associated with one or more tasks associated with a proposal. For example, a proposal option may be to provide a 2-night stay for the wine tasting weekend. Such a proposal option may be associated with a task to “find and book a 2-night stay in some sort of lodgings near wineries.” Such a task may be divided into further sub-tasks (e.g., determine location of the wineries, locate lodging near that location, book the hotel, verify registration, etc.). As may be contemplated, such tasks or sub-tasks may have dependencies between them. For example, the aforementioned task to “find and book a 2-night stay in some sort of lodgings near wineries” may be dependent on which wineries. Such dependencies and interdependencies may be explicitly denoted and/or may be implicit.

In an embodiment, the user interface elements of the application 1004 are used to provide other options for the representative to interact with proposals associated with a current project. In the embodiment illustrated in FIG. 10, user interface elements of the application 1004 include a preview proposal button 1022, a discard proposal button 1032, and a save proposal button 1034. In an embodiment, the preview proposal button 1022 is used by the representative to generate a view of the proposal associated with the current project. Such a view of the proposal may include the elements of the proposal (e.g., the proposal options) that have proposal recommendations and may also include elements of the proposal that do not have proposal recommendations. In an embodiment, the discard proposal button 1032 is used by the representative to delete the proposal. Further, the discard proposal button 1032 may cause the proposal to be deleted permanently. or to be marked (e.g., as inactive) but not deleted.

In an embodiment, the save proposal button 1034 is used by the representative to save the proposal so that, for example, the proposal can be further refined later. For instance, if the representative selects the save proposal button 1034, the systems of the task facilitation service may store the proposal within the resource library and in association with the representative and/or the particular project or individual task for which the proposal is being generated. In some examples, the representative may be prompted to assign a unique identifier to the proposal such that, at a later time, the representative may use the application 1004 to readily identify this proposal from any other proposals being generated by the representative or previously created for other projects and/or individual tasks.

It should be noted that user interface elements of the application 1004 may include additional functionality not illustrated in FIG. 10. For example, a representative may create a proposal with several proposal options. The representative may then decide to save the proposal as a template. Accordingly, the proposal template bar 1010 may be configured to include, for example, a “save as template” button that allows the representative to save the current proposal for a particular project or individual task as a template for future projects or individual tasks. In such an embodiment, the save as template button may cause some or all of the recommendations to be removed from the proposal so that the proposal can be saved as a proposal template with the proposal options. In an embodiment, the task facilitation service determines whether to save a proposal as a template based on, for example, common elements, high rankings of recommendations (described below), or other such factors. In an embodiment, a highly ranked proposal can be used as the basis for at least part of a curated experience as described above. In another embodiment, the application 1004 includes, for example, a “save proposal as” button that allows the representative to save a copy of the current proposal under a different designation so that, for example, the current proposal may be used as the basis for a new proposal for a closely related project. In an embodiment, one or more proposal options can be saved as a portion of a proposal template. In such an embodiment, a portion of one proposal template can be combined with a portion of a different proposal template to create a new proposal template. For example, parts of the wine tasting weekend project may be combined with parts of a hot air ballooning weekend to create a proposal template that includes both activities.

It should be noted that while the example environment 1000 illustrated in FIG. 10 shows a single proposal associated with a current project, a plurality of proposals may be associated with a project. In such an embodiment, some of the user interface elements of the application 1004 may apply to all of the proposals that are associated with the current project (e.g., the information bar 1006, the title bar 1008, the proposal template bar 1010, the recommend template button 1012, the load template button 1014, and/or the new template button 1016). In an embodiment, the proposal template bar 1010, the recommend template button 1012, the load template button 1014, and the new template button 1016 apply to all of the proposals that are associated with the current project. In an embodiment, each of the proposals that are associated with the current project has an associated proposal template bar 1010, recommend template button 1012, load template button 1014, and new template button 1016 so that, for example, different templates may be used for different proposals of a single project.

It should also be noted that the user interface elements of the application 1004 illustrated in FIG. 10 are illustrative examples and, as may be contemplated, different user interface elements, designs thereof, and/or arrangements thereof may be considered as within the scope of the present application. For example, the icon displayed in the title bar 1008 is merely an illustrative example.

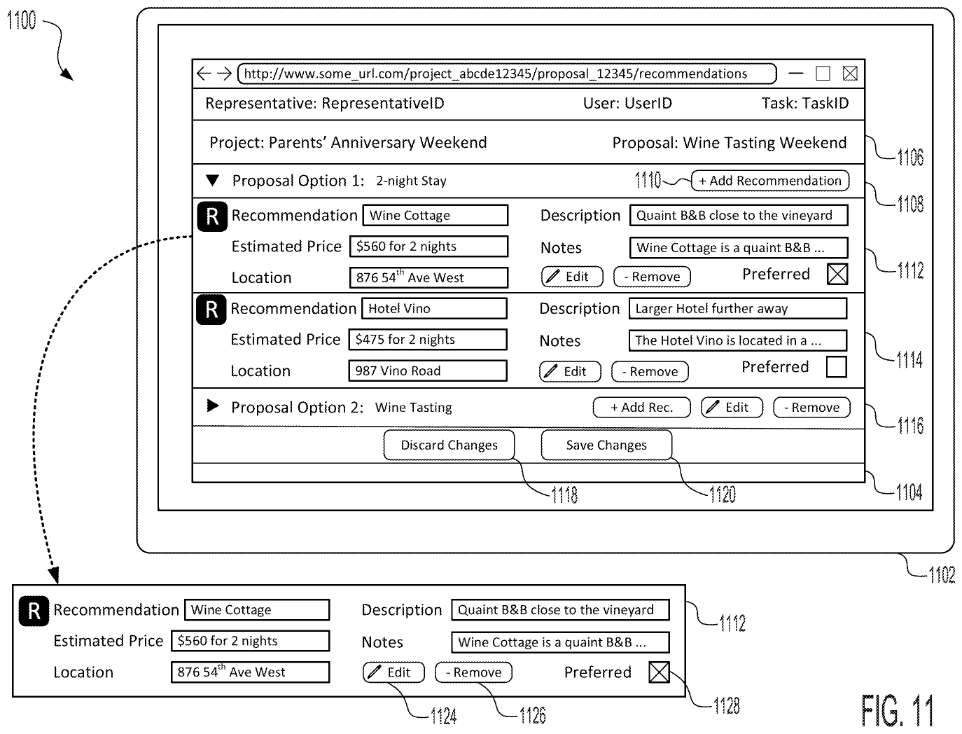

FIG. 11 shows an illustrative example of an environment 1100 in which proposal recommendations are edited in accordance with at least one embodiment. In an embodiment, the proposal recommendations are communicated to a member using systems and methods such as those described herein. In an embodiment, a computing device 1102 is used to display an application 1104. The application 1104, as illustrated in FIG. 11, may be accessed via a web portal provided by the task facilitation service. However, in some instances, the application 1104 may be provided via a standalone application provided by the task facilitation service and executed on the computing device 1102.

In an embodiment, a representative interacts with systems of the task facilitation service via the computing device 1102. In an embodiment, the application 1104 displays user interface elements including, but not limited to, icons, text, buttons, dropdown lists, radio buttons, check boxes, and visual canvases to convey information obtained from systems of the task facilitation service, obtained from a member, obtained from a third-party service or other service/entity affiliated with the task facilitation service, and/or obtained from other sources. In an embodiment, the application 1104 uses those user interface elements to obtain information from the representative and to provide the obtained information to systems of the task facilitation service, to the member, to a third-party, and/or to other information subscribers.

In an embodiment, the application 1104 receives the obtained information via a network interface (e.g., the network interface 1820 described herein at least in connection with FIG. 18) that is associated with the computing device 1102 (e.g., the computing device 1802, the computing device 1824, or a computing device associated with the computing resources provider 1828, all described herein at least in connection with FIG. 18). In an embodiment, the application 1104 provides the information obtained from the representative via the network interface that is associated with the computing device 1102.

In an embodiment, user interface elements of the application 1104 are used to display an information bar 1106 that specifies information including, but not limited to, an identifier of the representative, an identifier of the member, and an identifier of a current project or individual task for which the proposal is being prepared. In an embodiment, the current project includes a plurality of tasks. However, in certain instances, a project may include a single task. Thus, the identifier of the current project may be an identifier of a particular project, may be an identifier of an individual task, or may be an identifier of an aggregate project that includes tasks from multiple sources (e.g., a “to do list” aggregate project as described herein). In some instances, the current project may include no tasks (i.e., is an empty project).

In an embodiment, user interface elements of the application 1104 are used to display one or more proposal option dropdown bars (e.g., the proposal option dropdown bar 1108 and the proposal option dropdown bar 1116) that contain a name of a corresponding proposal option (e.g., “2-night Stay,” “Wine Tasting,” etc.) and one or more additional user interface elements that the representative can use to associate proposal recommendations with the proposal option. As an example, the proposal option dropdown bar 1108 includes an add recommendation button 1110, a recommendation canvas 1112, and a recommendation canvas 1114. Each of the recommendation canvases (e.g., the recommendation canvas 1112 and the recommendation canvas 1114) may include additional user interface elements, as described below.

In an embodiment, an add recommendation button 1110 is used by the representative to add a recommendation to perform tasks that may be performed by the representative and/or one or more third-parties on behalf of the member to satisfy the corresponding proposal option (e.g., “2-night Stay”) associated with the current project. In an embodiment, the add recommendation button 1110 is used to automatically generate a recommendation for the proposal option based on, for example, an analysis of the member profile associated with the member (e.g., the member's preferences, the member's budgetary constraints, the member's restrictions, etc.), past proposal options from members, or other such data (e.g., demographics, location, time of year, predicted weather, etc.). In an embodiment, the automatically generated recommendation is generated using a machine learning or artificial intelligence algorithm that analyzes data from, for example, the member profile associated with the member, past proposal options from members and other historical data corresponding to similar proposals and/or similarly-situated members, or other such data (e.g., demographics, location, time of year, predicted weather, etc.). In some instances, systems of the task facilitation service may automatically generate a recommendation without receiving a deliberate request to do so from the representative (e.g., using the add recommendation button 1110). For example, the automatically generated recommendation may be automatically generated when the project option is loaded. Alternatively, the recommendation may be automatically generated when the project option is created or when the minimal set of information is obtained by the representative as described above. In some examples, a recommendation may be automatically generated at some other point in the project option and/or the project recommended processes. The automatically generated recommendation may also be generated using a machine learning or artificial intelligence algorithm that analyzes data from, for example, the member profile, past proposal options from similarly-situated members, or other such data (e.g., demographics, location, time of year, predicted weather, etc.).

In an embodiment, the add recommendation button 1110 is used by the representative to load a recommendation for the project option. The loaded recommendation may, in some embodiments, be loaded from systems of the task facilitation service. As with the automatically generated recommendation above, the loaded recommendation includes a recommendation to perform tasks that may be performed by the representative and/or one or more third-parties on behalf of the member to satisfy the proposal option using systems and methods such as those described herein. In some instances, selection of the add recommendation button 1110 may cause the systems of the task facilitation service to query the resource library to identify various resources that may be used to generate a particular recommendation. For example, for a proposal option corresponding to a “2-night Stay” and a corresponding project related to an anniversary weekend for the member's parents, the systems of the task facilitation service may use information from the member profile (e.g., geographical location of the member's parents, budgetary constraints, any member or parental preferences, etc.), as well as any available information regarding the project (e.g., geographic location for the wine tasting weekend, etc.), to query the resource library for any recommendations that may satisfy the proposal option and the parameters of the proposal and project. These recommendations may correspond to available resources maintained in the resource library as provided by the representative, the member, or any other entities (e.g., other representatives, other members, third-party services, etc.). The resource library may thus server as a repository for different resources (e.g., guides, public search results, available third-party services, previously performed projects and tasks, etc.) that may be used to identify possible recommendations for different proposal options.

In an embodiment, the representative can load a specific recommendation based on the project option. For example, the representative may have a previously saved template for planning a weekend getaway from a previous project. Accordingly, the representative may load the recommendation from that previous template or project. In another example, the representative may load the recommendation from a set of recommendations associated with the representative. For instance, if the representative selects the add recommendation button 1110, the systems of the task facilitation service may query the resource library to identify any previously generated proposals associated with the representative. From these previously generated proposals, the systems of the task facilitation service may identify any recommendations associated with these previously generated proposals. These previously generated recommendations may be presented to the representative through the application 1104.

In another example, the representative may load the recommendation from a set of recommendations associated with the member. For instance, if the representative selects the add recommendation button 1110, the systems of the task facilitation service may query the resource library to identify any previously generated proposals associated with the member. These proposals may include recommendations previously provided to the member by the representative or any other representatives that may have prepared these proposals for the member. In some instances, information corresponding to these previously generated proposals may be stored in the member profile associated with the member. Thus, in response to selection of the add recommendation button 1110, the systems of the task facilitation service may automatically process the member profile to identify any previously performed or active projects and tasks for which proposals have been generated. Based on these identified projects and tasks, the systems of the task facilitation service may identify the corresponding proposals and recommendations.

In some instances, if the representative selects the add recommendation button 1110, the systems of the task facilitation service may update the application 1104 to present a graphical representation of the resource library. Through this graphical representation of the resource library, the representative may be presented with various recommendations that may be available to the representative for populating the particular proposal option from which the add recommendation button 1110 was selected. Additionally, through this graphical representation of the resource library, the representative may submit a query to identify one or more recommendations that may be relevant to the submitted query. For example, if the representative submits a query with the string “2-night Stay,” the systems of the task facilitation service may update the interface to provide any recommendations or resources that may be associated with the terms “2-night,” “stay,” and/or “2-night stay.” Further, in some instances, the systems of the task facilitation service may automatically augment the query with information garnered from the member profile (e.g., geographical location of the member's parents, budgetary restrictions or constraints, etc.) and from the project and/or task (e.g., location for the wine tasting weekend, etc.). From these recommendations and resources, the representative may select an appropriate recommendation for the particular proposal option.

In an embodiment, the add recommendation button 1110 is used by the representative to create a new recommendation for the current project option. For instance, in response to the selection of the add recommendation button 1110, a blank recommendation may be added to the proposal option. This blank recommendation may not initially include any specific recommendations to perform tasks that may be performed by the representative and/or one or more third-parties on behalf of the member to satisfy the proposal option. In some instances, selection of the add recommendation button 1110 may result in a recommendation shell being added to the proposal option. The recommendation shell may include a partial set of specific recommendations to perform tasks that may be performed by the representative and/or one or more third-parties on behalf of the member to satisfy the proposal option. In such an embodiment, the add recommendation button 1110 may cause the application 1104 to display an additional user interface element (not illustrated herein) to, for example, create a new blank recommendation, or create a new recommendation from a designated recommendation shell.

As described above, a recommendation canvas such as the recommendation canvas 1112 may include a plurality of user interface elements of the application 1104 that the representative may use to edit recommendations associated with a proposal option. For example, in the illustrated example shown in FIG. 11, the recommendation canvas 1112 includes one or more data fields for the recommendation to book the 2-night stay at the “Wine Cottage.” The data fields of the recommendation may be static fields (i.e., shared between recommendations of this type), may be unique fields (i.e., specific to this recommendation), may be custom data fields (i.e., may be created specifically for this instance of this recommendation), or may be some other type of data field. In an embodiment, a recommendation is based on a recommendation template, which may include data fields without set values. For example, a recommendation based on a recommendation template may include data fields for the name, estimated price, location, description, and notes but may not include values for those data fields.

In some instances, a recommendation may be based on a recommendation shell, which may include data fields with some set values and some unset values. For example, a recommendation based on a recommendation shell may include data fields for the name, estimated price, location, description, and notes and may also include values for the name, estimated price, and location but not for the description or notes. In an embodiment, the recommendation includes other data fields including, but not limited to, rating (e.g., from social media sites), manager or owner name, pictures of the property, pictures of rooms of the property, a link to an onsite restaurant, and other such data fields.

As may be contemplated, a plurality of proposal recommendations may be associated with a proposal option. In the example environment illustrated in FIG. 11, the proposal option dropdown bar 1108 includes the recommendation canvas 1112 (described above) and the recommendation canvas 1114. The recommendation canvas 1114 shows a different recommendation for the 2-night stay proposal option (at the “Hotel Vino”) which may have been generated using one of the methods described above with respect to the recommendation canvas 1112 (e.g., using the add recommendation button 1110).

In the example environment illustrated in FIG. 11, a recommendation canvas such a recommendation canvas 1112 includes additional user interface elements of the application 1104 that are used by the representative to generate recommendations for a proposal option. For example, the recommendation canvas 1112 includes an edit recommendation button 1124 and a remove recommendation button 1126. In an embodiment, the edit recommendation button 1124 is used by the representative to change values for the data fields of the recommendation to, for example, refine the recommendation. Such edits may include adding fields to a recommendation from a library of fields stored by systems of the task facilitation service in the resource library. Such edits may also include adding more specific details to the recommendation as custom fields. Such custom fields may be specific to the representative, to the project, to the proposal option, to one or more tasks associated with the proposal option, or to the recommendation. In some instances, if the representative adds a blank recommendation to the proposal option, the representative may use the edit recommendation button 1124 to refine the blank recommendation by adding and editing data fields associated with the recommendation. In an embodiment, the remove recommendation button 1126 is also used to refine a recommendation and/or to refine a set of recommendations by providing a way for the representative to remove extraneous recommendations for a proposal option. For example, one of the member's parents may have an allergy that precludes a particular lodging choice, thereby obviating a recommendation for that lodging choice.

In an embodiment, any edits submitted by the representative to a particular recommendation are recorded in the resource library for later use by the representative and any other representatives for similar proposal options and corresponding projects/tasks. For example, if the representative edits a blank recommendation to create a recommendation corresponding to a hotel option that the representative has recently learned about (e.g., through a public search for hotels near the wine tasting venue, through the representative's own knowledge, etc.), the recommendation and corresponding information may be recorded in the resource library. Another representative trying to identify a recommendation for lodging near the wine tasting venue (whether related to the wine tasting venue or other location within proximity of the venue) for a particular proposal option may be presented with this particular recommendation in response to a query submitted to the resource library.

In an embodiment, the edit recommendation button 1124 is used by the representative to open and edit a larger set of data fields for the recommendation (e.g., to retrieve a rating from social media sites, to edit the manager's or owner's name, to upload pictures of the property, to upload pictures of rooms of the property, to provide a link to an onsite restaurant, and/or to edit other such data fields). In an embodiment, the values for the data fields displayed in the recommendation canvas (e.g., the recommendation canvas 1112) can be edited by entering data directly into the displayed data fields.

In an embodiment, a preferred recommendation checkbox 1128 can be used by the representative to indicate that a proposal recommendation is a preferred proposal recommendation. In another embodiment, user interface elements of the application 1104 can be used to allow the representative to assign a ranking to the proposal recommendation. As described herein, proposal recommendations are recommendations to perform tasks that may be performed by the representative and/or one or more third-parties on behalf of the member to satisfy the proposal option. Accordingly, denoting a proposal recommendation as a preferred proposal recommendation and/or ranking a proposal recommendation may, in some embodiments, cause a preferred status or a higher ranking on the tasks that may be performed by the representative and/or one or more third-parties on behalf of the member to satisfy the proposal option to be conferred on the tasks using systems and methods described herein. Similarly, a proposal that includes one or more preferred recommendations and/or that includes one or more recommendations that ranked higher can also cause a preferred status or a higher ranking to be conferred on the proposal using systems and methods described herein. In an embodiment, the preferred status of a recommendation and/or the ranking of a recommendation can be automatically generated using a machine learning or artificial intelligence algorithm that analyzes data from, for example, the member's preferences, past proposal options from members, or other such data (e.g., demographics, location, time of year, predicted weather, etc.).

In an embodiment, elements of recommendations associated with a proposal option can be saved as templates or shells for subsequent proposal options. For example, the proposal option for a 2-night stay with the two recommendations and the designation of one a preferred recommendation illustrated in FIG. 11 may be saved and used as a template for or a shell for subsequent recommendations for the same or similar proposal options. In an embodiment, the representative can save the proposal option and recommendations to the resource library. In an embodiment, systems of the task facilitation service can automatically save a proposal option with recommendations and a preferred designation and/or a ranking to the resource library.

In an embodiment, the user interface elements of the application 1104 are used to provide other options for the representative to interact with proposal recommendations associated with a project option. In the embodiment illustrated in FIG. 11, user interface elements of the application 1104 include a discard changes button 1118, and a save changes button 1120. In an embodiment, the discard changes button 1118 is used by the representative to discard any changes made to the proposal options such as changes to the recommendations and, for example, return to a previous state. For example, the discard changes button 1118 may cause the changes to the recommendations associated with the proposal option to be discarded and the recommendations associated with the proposal option to be reverted to a previous state. In another example, the discard changes button 1118 may cause the changes to the recommendations associated with the proposal option the proposal to marked as, for example, inactive but not deleted.

In an embodiment, the save changes button 1120 is used by the representative to save the changes to the recommendations associated with the proposal option so that, for example, the recommendations associated with the proposal option can be refined later. Although not illustrated here, the user interface elements of the application 1104 may include a preview button not unlike the preview proposal button 1022 described herein at least in connection with FIG. 10, which may be used by the representative to generate a view of the proposal or a portion of the proposal associated with the current project. Such a view of the proposal or portion of the proposal may include the elements of the proposal (e.g., the proposal options) that have proposal recommendations and may also include elements of the proposal that do not have proposal recommendations.

It should be noted that while the example environment 1100 illustrated in FIG. 11 shows recommendations for a single set of recommendations for a single proposal option associated with a current project, in an embodiment a plurality of recommendations, proposal options, and proposals may be associated with a project. It should also be noted that the user interface elements of the application 1104 illustrated in FIG. 11 are illustrative examples and, as may be contemplated, different user interface elements, designs thereof, and/or arrangements thereof may be considered as within the scope of the present application. For example, the icon displayed in recommendation canvas 1112 is merely an illustrative example.

Although not illustrated in FIG. 11, in an embodiment there may be no acceptable and/or preferred recommendations for a proposal option. For example, a proposal option corresponding to making a dinner reservation on behalf of a member with a stated preference to only eat at vegan restaurants may not have any associated proposal recommendations in an area where no such restaurants exist. In such an example, the task facilitation service can generate alternative proposal options that may have associated recommendations using, for example, machine learning or artificial intelligence algorithms as described herein. For example, systems of the task facilitation service may generate a proposal option to pack a vegan picnic, which could then have a recommendation to get the picnic lunch from a vendor that is nearby or on the way to the winery location. In some embodiments, a proposal option with no associated recommendations can be automatically deleted so that it is, for example, not included in a proposal. In some embodiments a “null recommendation” (i.e., a recommendation to not perform any tasks) can be included in the proposal.

In an embodiment, a recommendation causes additional tasks and/or proposal options to be created. For example, as shown in recommendation canvas 1112, the “Wine Cottage” is located close to the vineyard and thus, either the vineyard or the “Wine Cottage” could have a shuttle or provide transportation for guests and visitors. Conversely, as shown in recommendation canvas 1114, the “Hotel Vino” is located further away from the vineyard and thus, it may be less likely that the vineyard or the “Hotel Vino” has a shuttle or provides transportation for guests and visitors. Accordingly, selection of this recommendation may require additional tasks to, for example, rent a car, book a ride-share, or otherwise find transportation between the hotel and the vineyard. Such additional tasks and/or proposal options may be generated by the representative or may be generated by the task facilitation service using machine learning and/or artificial intelligences techniques such as those described herein.

As may be contemplated, a recommendation and/or ranking of a recommendation can be used as the basis for, as a template for, or as a shell for subsequent recommendations. For example, a preferred recommendation for the “Wine Cottage” may increase the likelihood that the “Wine Cottage” is included and/or preferred in other proposals from the task facilitation service and, in some embodiments, can cause the “Wine Cottage” to be automatically recommended for other proposals for the member, for wine tasting weekends, for weekend getaways, or for weekends in the location where the vineyards are located.

It should be noted that for the systems, methods, interactions, and processes described herein in connection with, for example, FIGS. 10 and 11, various operations performed by the representative may be additionally, or alternatively, performed using one or more machine learning algorithms or artificial intelligence such as those described herein. For example, as the representative and/or the task recommendation system generate and/or suggest proposal templates, generate and/or suggest proposal options, generate and/or suggest recommendations, generate proposals, rank and/or designate proposals as preferred, coordinate tasks, and/or perform tasks on behalf of a member, systems of the task facilitation service may continuously and automatically update the member's profile and/or the member's preferences according to feedback related to those generations and/or suggestions.

In an embodiment, systems of the task facilitation service (e.g., the task recommendation system) may utilize a machine learning algorithm and/or artificial intelligence techniques such as those described herein to automatically and dynamically generate proposal templates, proposal options, recommendations, proposals, proposal rankings, and/or tasks based on the various attributes of the member profile with or without representative interaction. For example, the task recommendation system may automatically communicate with the member to obtain any additional information required for new projects and tasks and may automatically generate proposal templates, proposal options, recommendations, proposals, proposal rankings, or tasks based on that additional information. The representative may also monitor communications between the task recommendation system and the member to ensure that a conversation between the two maintains a positive polarity (e.g., the member is satisfied with its interaction with the task recommendation system, other systems of the task facilitation service, the representative, the assistant representative, and/or other bots associated with the task facilitation services). If the representative determines that the conversation has a negative polarity (e.g., the member is expressing frustration or dissatisfaction, the task recommendation system is unable to process the member's responses or asks, etc.), the representative may intervene in the conversation. This may allow the representative to address any member concerns and generate proposal options, generate recommendations, generate proposals, generate proposal rankings, and/or perform any tasks on behalf of the member.

Thus, as described above, unlike automated customer service systems and environments, wherein these systems and environment may have little to no knowledge of the users interacting with agents or other automated systems, systems of the task facilitation service such as the task recommendation system can continuously update the member profile to provide up-to-date historical information about the member based on the member's interaction with the systems of the task facilitation service and/or interaction with the representative and based on, for example, the proposals generated, the proposals recommended, and the tasks performed on behalf of the member over time. This historical information, which may be automatically and dynamically updated as the member and/or the systems of the task facilitation service interact with the representative and as proposal templates are generated and/or suggested, proposal options are generated and/or suggested, recommendations are generated and/or suggested, proposals are generated, proposals are ranked and/or designated as preferred, tasks are coordinated, and/or tasks are performed on behalf of the member, may be used by the task recommendation system to anticipate, identify, and present appropriate or intelligent responses to member queries, needs, and/or goals.

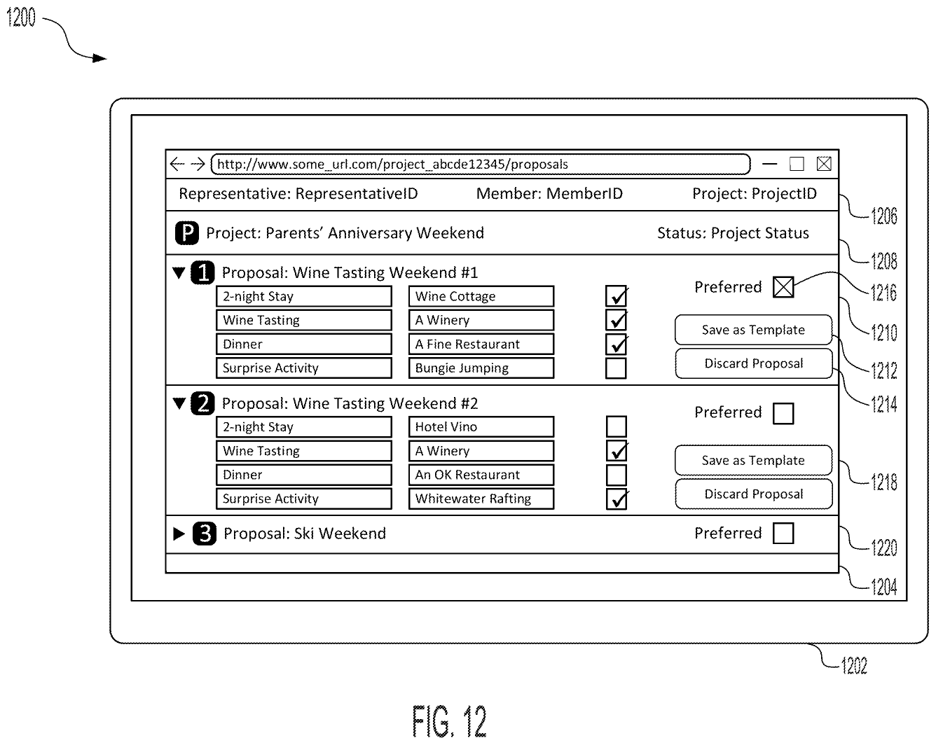

FIG. 12 shows an illustrative example of an environment 1200 in which proposals are compared and ranked in accordance with at least one embodiment. In an embodiment, a computing device 1202 is used to display an application 1204. In an embodiment, a representative interacts with systems of the task facilitation service via the computing device 1202. The application 1204 may display user interface elements including, but not limited to, icons, text, buttons, dropdown lists, radio buttons, check boxes, and visual canvases to convey information obtained from systems of the task facilitation service, obtained from a member, obtained from a third-party service or other service/entity affiliated with the task facilitation service, and/or obtained from other sources. The application 1204 may use these user interface elements to obtain information from the representative and to provide the obtained information to systems of the task facilitation service, to the member, to a third-party service or other service/entity affiliated with the task facilitation service, and/or to other information subscribers.

In an embodiment, the application 1204 receives the obtained information via a network interface (e.g., the network interface 1820 described herein at least in connection with FIG. 18) that is associated with the computing device 1202 (e.g., the computing device 1802, the computing device 1824, or a computing device associated with the computing resources provider 1828, all described herein at least in connection with FIG. 18). In an embodiment, the application 1204 provides the information obtained from the representative via the network interface that is associated with the computing device 1202.

The user interface elements of the application 1204 may be used to display an information bar 1206 that specifies information including, but not limited to, an identifier corresponding to the representative, an identifier corresponding to the member, and an identifier corresponding to the project. In an embodiment, the project includes a plurality of tasks and a plurality of proposals. Alternatively, in some instances, the project may include an individual task, wherein the project identifier may be an identifier of a project, may be an identifier of the individual task, or may be an identifier of an aggregate project that includes tasks from multiple sources (e.g., a “to do list” aggregate project as described herein). In an embodiment, the project includes no tasks (i.e., is an empty project).

In an embodiment, user interface elements of the application 1204 are used to display a title bar 1208 that specifies information including, but not limited to, a name of the project and the status of the project. The name of the project provided through the title bar 1208 may be a short descriptive title of the project (e.g., “Parent's Anniversary Weekend”). In some instances, the name of the project may be a default name assigned by systems of the task facilitation service. If the name assigned to the project is a default name, the project may also include a short description of the project that may also be displayed in the title bar 1208. In an embodiment, the status of the project is selected from a list of possible statuses that may be stored by the systems of the task facilitation service. For example, the project status of the project may be “open,” “closed,” “active,” “inactive,” “on track,” “behind,” or a combination of these and/or other such statuses. The project status, in some instances, may be selected from a predefined list. Alternatively, the project status may be defined through a free-form field that can, for example, be used by the representative using user interface elements of the application 1204 to define the project status.

In an embodiment, user interface elements of the application 1204 are used to display a first proposal 1210. In the example illustrated in FIG. 12, the first proposal 1210 includes a proposal title (e.g., “Wine Tasting Weekend #1”), a set of proposal options (e.g., “2-night Stay,” “Wine Tasting,” etc.), and a set of proposal recommendations for the proposal options (e.g., “Wine Cottage” for the “2-night Stay,” “A Winery” for the “Wine Tasting,” “A Fine Restaurant” for the “Dinner,” and “Bungie Jumping” for the “Surprise Activity”). The first proposal 1210 may further include an indication as to whether a particular proposal recommendation has a high suitability metric. For example, as illustrated in FIG. 12, a proposal recommendation having a high suitability metric may be graphically represented, through the application 1204, with a check mark or other binary indicator that may be used to denote a high suitability metric. In some instances, rather than providing a binary indicator corresponding to whether a particular proposal recommendation has a high suitability metric, the task facilitation service, through the application 1204, may provide a score or other scalar value that may denote the suitability metric for each of the proposal recommendations provided therein. For example, a proposal recommendation may be assigned a suitability score within a particular range (e.g., 0-100), where a higher value may denote a greater suitability of the proposal recommendation for the proposal.

A proposal recommendation may have a high suitability metric if the proposal recommendation is suited to the proposal option based on, for example, reviews of the entity associated with the proposal recommendation, member preferences (as defined in the member profile associated with the member for which the proposal is being prepared), and other such factors. For example, the first proposal 1210 may have a high suitability metric (indicated by a check mark or other value) for the “Wine Cottage,” “A Winery,” and “A Fine Restaurant” but may not have a high suitability metric for “Bungie Jumping.” The low suitability of “Bungie Jumping” may be due to one of the member's parents being afraid of heights, something that may be known about the member through other context, due to parameters specified by the member when defining the project, and/or through the member profile associated with the member. In an embodiment, the suitability metric can be indicated by a number (e.g., 0-10, 0-100, etc.), by a rating (e.g., from one to five stars), by a percentage, or by using some other such indication.

In an embodiment, the first proposal 1210 includes a button 1212 to save the proposal as a template. If the proposal is saved as a template, elements of the proposal may be used to construct a proposal template. The new template may be stored by the task facilitation service within a resource library for subsequent use by the representative, other representatives, and/or for other members. When a proposal is saved as a template, a proposal recommendation algorithm may be updated to indicate that the proposal in question was a good recommendation and to prefer that proposal and/or the decision making processes that led to that recommendation. In an embodiment, the first proposal 1210 includes a button 1214 to discard the proposal. When a proposal is discarded, the proposal recommendation algorithm may be updated to indicate that the proposal in question was not a good recommendation and to avoid that proposal and/or the decision making processes that led to that recommendation. In an embodiment, the first proposal 1210 includes a check box 1216 to mark the proposal as preferred. When a proposal is marked as preferred, the proposal recommendation algorithm may be updated to indicate that the proposal in question was a good recommendation and to prefer that proposal and/or the decision making processes that led to that recommendation.

In an embodiment, user interface elements of the application 1204 are used to display a second proposal 1218 and a third proposal 1220. The second proposal 1218 has different proposal recommendations but is also a proposal for a wine tasting weekend (e.g., “Wine Tasting Weekend #2”). The second proposal 1218 may have a different proposal recommendation for the “2-night Stay,” a different proposal recommendation for “Dinner,” and a different proposal recommendation for the “Surprise Activity.” As illustrated in FIG. 12, the different proposal recommendations for the second proposal 1218 have different suitability metrics. Further, the second proposal 1218 is not a preferred proposal. It should be noted that the different suitability metrics and/or the different preference of the second proposal 1218 may also be used to update the proposal recommendation algorithm based on the different suitability metrics and or the different preference of the second proposal 1218. In an embodiment, suitability metrics of individual recommendations are used to update the proposal recommendation algorithm. For example, the high suitability metric of “Whitewater Rafting” for the “Surprise Activity” (based on, for example, the member profile and/or task parameters) may be used to update the proposal recommendation algorithm. Similarly, the low suitability metric for “An OK Restaurant” (based on, for example, less than outstanding reviews) may also be used to update the proposal recommendation algorithm.

As illustrated in FIG. 12, the first proposal 1210 and the second proposal 1218 are both for wine tasting weekends and both are shown in an expanded view (as indicated by the down arrow). By contrast, the third proposal 1220 is shown in a collapsed view (as indicated by the sideways arrow) and is for a “Ski Weekend.” This different type of proposal (i.e., for a “Ski Weekend”) may be generated if, for example, the task parameters specified by the member for the “Parents' Anniversary Weekend” did not include a requirement for wine tasting. By contrast, if the task parameters specified by the member for the “Parents' Anniversary Weekend” did include a requirement for wine tasting, the proposal for a “Ski Weekend” may not be a good proposal. Such a proposal may be used to update the proposal recommendation algorithm to indicate that the proposal in question was not a good recommendation and to avoid that proposal and/or the decision making processes that led to that recommendation.

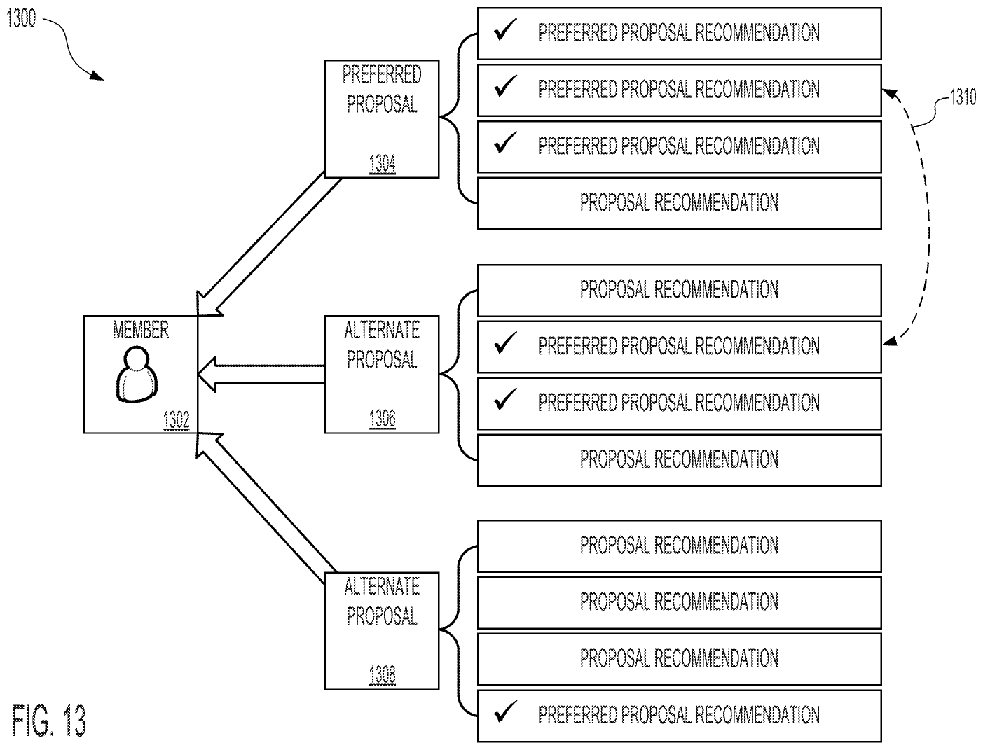

FIG. 13 shows an illustrative example of an environment 1300 in which preferred and alternate proposals are communicated to a member in accordance with at least one embodiment. In an embodiment, a member 1302 receives one or more proposals from a task facilitation service such as the task facilitation service 102 described herein at least in connection with FIG. 1. In an embodiment, the one or more proposals received from the task facilitation service are ranked proposals such as the ranked proposals 816 described herein at least in connection with FIGS. 8A-8B.

In the example illustrated in FIG. 13, the member 1302 receives a preferred proposal 1304, an alternate proposal 1306, and an alternate proposal 1308. In the example illustrated in FIG. 13, the preferred proposal 1304 has three preferred proposal recommendations and one proposal recommendation that is not preferred. The alternate proposal 1306 has two preferred proposal recommendations and two proposal recommendations that are not preferred. Further, the alternate proposal 1308 has one preferred proposal recommendation and three proposal recommendations that are not preferred. As may be contemplated, the example illustrated in FIG. 13 may be considered as a different representation of the example illustrated in FIG. 12 in that the preferred proposal 1304 shows an abstracted view of the first proposal 1210, the alternate proposal 1306 shows an abstracted view of the second proposal 1218, and the alternate proposal 1308 may show an abstracted view of the third proposal 1220.

For example, the preferred proposal 1304 is preferred as a result of the analogous first proposal 1210 including the check box 1216 to mark the proposal as preferred. Similarly, the preferred proposal 1304 has three preferred proposal recommendations and one proposal recommendation that is not preferred, similar to the analogous first proposal 1210, which has a high suitability metric (i.e., has indicated the proposal recommendation is preferred) for the “Wine Cottage,” “The Winery,” and “A Fine Restaurant” but does not have a high suitability metric (i.e., has not indicated the proposal recommendation is preferred) for “Bungie Jumping.” The alternate proposal 1306 has two preferred proposal recommendations and two proposal recommendations that are not preferred, similar to the analogous second proposal 1218, which has a high suitability metric (i.e., has indicated the proposal recommendation is preferred) for “A Winery,” and “Whitewater Rafting” but does not have a high suitability metric (i.e., has not indicated the proposal recommendation is preferred) for the “Hotel Vino” and “An OK Restaurant.” Details of the third proposal 1220 are not illustrated in FIG. 12 other than that the analogous third proposal 1220 is not preferred as the alternate proposal 1308 is also not preferred.

The example illustrated in FIG. 13 shows that a preferred proposal recommendation of the preferred proposal 1304 and a preferred proposal recommendation of the alternate proposal 1306 that are the same, as indicated by the dashed line 1310. This is akin to the proposal recommendation for “A Winery” that is in the first proposal 1210 and also in the second proposal 1218 illustrated in FIG. 12.

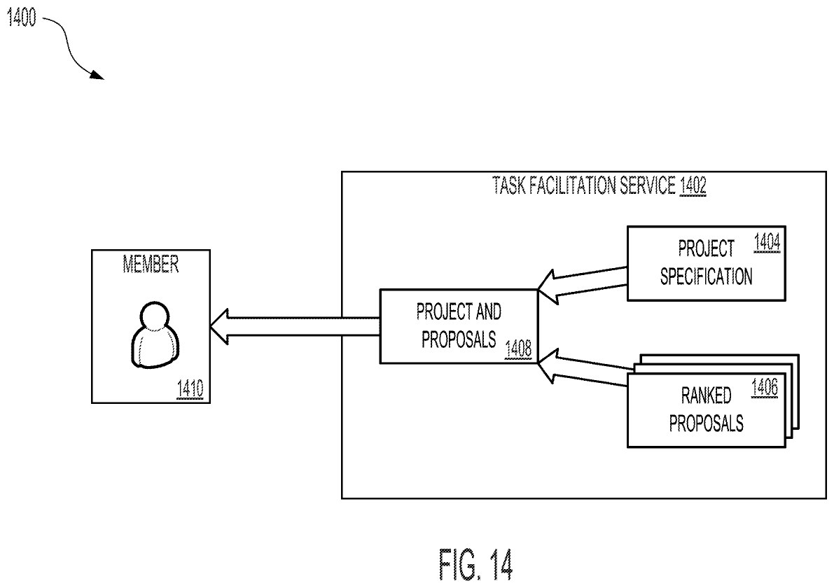

FIG. 14 shows an illustrative example of an environment 1400 in which proposals for a particular project are communicated to a member in accordance with at least one embodiment. In the example illustrated in FIG. 14, a task facilitation service 1402 combines the ranked proposals 1406 with the project specification 1404 into a formatted package that includes the project and proposals 1408 so that the formatted package that includes the project and proposals 1408 may be presented to the member 1410.

In an embodiment, the formatted package that includes the project and proposals 1408 is formatted such that a member with a plurality of pending projects can determine which of those pending projects the ranked proposals are responsive to on the assumption that the determination may not be clear from context. For example, a formatted package that includes the project and proposals 1408 that indicates to the member 1410 that “for the Parents' Anniversary Weekend Project, we have a first proposal for a Wine Tasting Weekend, a second proposal for a different Wine Tasting Weekend, and a third proposal for a Ski Weekend” may be clearer than merely presenting the proposals. As may be contemplated, other methods of formatting the communication of the proposals to the member 1410 including, but not limited to, those described herein may be considered as within the scope of the present disclosure. For instance, the task facilitation service 1402 may generate a project-specific interface for the particular project. Through this project-specific interface, the task facilitation service 1402 may present, to the member 1410, the project specification 1404 and the one or more ranked proposals 1406. Thus, through the application or web portal provided by the task facilitation service 1402, the member 1410 may be able to access different projects or tasks through specific interfaces that may isolate different projects or tasks from other projects or tasks that are to be performed for the member 1410.

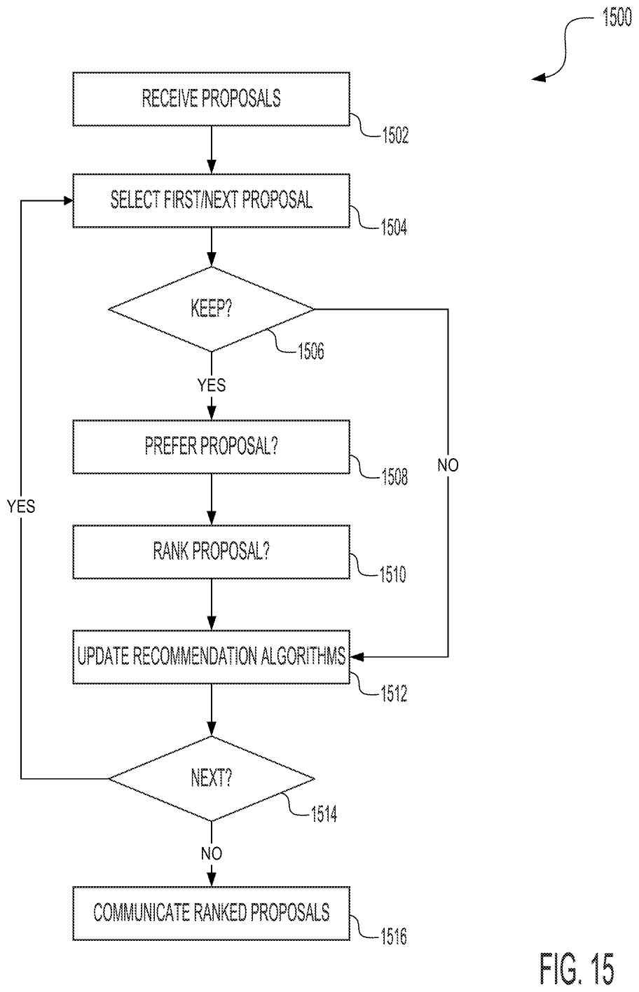

FIG. 15 shows an illustrative example of a process 1500 for ranking and communicating proposals to a member in accordance with at least one embodiment. Components of a task facilitation service such as the task facilitation service 102 described herein at least in connection with FIG. 1 may perform the example process 1500 illustrated in FIG. 15. For example, the process 1500 may be performed by a task coordination system and/or proposal creation sub-system of the task facilitation service (e.g., the task coordination system 314 and/or the proposal creation sub-system 302 of the task facilitation service, both of which are described herein at least in connection with FIG. 3).

At step 1502 of the example process 1500, components of the task facilitation service receive a set of proposals for a particular project or task. For example, components of the task facilitation service may receive a set of proposals from a proposal creation sub-system such as the proposal creation sub-system 302 described herein at least in connection with FIG. 3.

At step 1504 of the example process 1500, components of the task facilitation service select the first (or next) proposal from the set of proposals received from the proposal creation sub-system and, at step 1506 of the example process 1500, components of the task facilitation service determine whether to keep the selected proposal. If, at step 1506, components of the task facilitation service determine not to keep the selected proposal (the “NO” branch), the example process 1500 continues at step 1512, described below.

If, at step 1506, components of the task facilitation service determine to keep the selected proposal (the “YES” branch), at step 1508 of the example process 1500, components of the task facilitation service determine whether to prefer the selected proposal Additionally, at step 1510 of the example process 1500, components of the task facilitation service determine how to rank the proposal using a proposal ranking sub-system and/or a proposal ranking algorithm. In an embodiment, step 1508 (the determination of whether to prefer the proposal) and step 1510 (the determination of how to rank the proposal) can be combined into a single step that may be performed using the proposal ranking sub-system and/or the proposal ranking algorithm, as described herein.

At step 1512 of the example process 1500, components of the task facilitation service may update the various proposal recommendation algorithms described herein, based on the determinations of whether to keep or discard the selected proposal (step 1506), whether to prefer the proposal (step 1508), and/or how to rank the proposal (step 1510). Regardless of whether the example process for ranking proposals and for communicating those proposals to a member from step 1506 or from step 1510, the various proposal recommendation algorithms may be updated to reflect whether the set of proposals received from the proposal creation sub-system were well-selected (i.e., were good proposals) or were poorly-selected (i.e., were not good proposals). As may be contemplated, the set of proposals received from the proposal creation sub-system may include a mixture of well-selected and poorly-selected proposals.

At step 1514 of the example process 1500 for ranking communicating proposals to a member, components of the task facilitation service determine whether to process the next proposal. If, at step 1514, components of the task facilitation service determine to process the next proposal (the “YES” branch), the example process 1500 for ranking proposals and for communicating those proposals to a member continues at step 1504, described above.

If, at step 1514, components of the task facilitation service determine not to process the next proposal (the “NO” branch), at step 1516 of the example process 1500 for ranking proposals and for communicating those proposals to a member, components of the task facilitation service communicate the ranked proposals to the member using systems and methods such as those described herein. For example, the task facilitation service may update a project- or task-specific interface corresponding to the project or task for which the proposals were generated to present the ranked proposals.

It should be noted that the process 1500 may be performed using additional and/or alternative steps than those described above and illustrated in FIG. 15. For example, the determinations regarding whether to keep a particular proposal, mark a particular proposal as being preferred, and/or rank a particular proposal may be performed by a representative associated with the member for whom the proposals have been generated. In some instances, rather than using a trained machine learning algorithm or artificial intelligence to generate the aforementioned proposals, these proposals may be generated by the representative based on their personal knowledge of the member, as described above. The proposals generated by the representative may be evaluated using one or more classical algorithms that may be configured to automatically process the suitability metrics associated with the proposals and/or the proposal recommendations and the corresponding ranks provided by the proposal ranking sub-system to identify which of these proposals and/or proposal recommendations are to be communicated to the member. For example, the proposal selection algorithm may automatically select a set number of proposals having the highest rankings, where the set number may be determined based on the member's preferences. In some instances, these algorithms may apply a weight to each of the individual rankings and individual suitability metrics associated with the proposals in order to calculate an aggregate score for each proposal. The aggregated scores for the set of proposals may be used to select which proposals are to be selected for presentation to the member.

FIG. 16 shows an illustrative example of an environment 1600 in which communicated proposals are received by a member in accordance with at least one embodiment. In an embodiment, proposals are communicated to a member using systems and methods such as those described herein. In an embodiment, a computing device 1602 is used to display an application 1604. In an embodiment, a member interacts with systems of the task facilitation service via the computing device 1602. In an embodiment, the application 1604 displays user interface elements such as those described herein to convey information obtained from systems of the task facilitation service and presented to a member.

In an embodiment, the application 1604 receives the obtained information via a network interface (e.g., the network interface 1820 described herein at least in connection with FIG. 18) that is associated with the computing device 1602 (e.g., the computing device 1802, the computing device 1824, or a computing device associated with the computing resources provider 1828, all described herein at least in connection with FIG. 18). In an embodiment, the application 1604 provides the information obtained from the representative via the network interface that is associated with the computing device 1602.

In an embodiment, user interface elements of the application 1604 are used to display an information bar 1606 that specifies information including, but not limited to, an identifier of the representative, an identifier of the member, and an identifier of a current project, and a title of the project. In an embodiment, user interface elements of the application 1604 are used to display one or more proposals communicated to the member. In the example illustrated in FIG. 16, user interface elements of the application 1604 are used to display a preferred proposal 1608, a first alternate proposal 1610, and a second alternate proposal 1612. In the example illustrated in FIG. 16, each of the proposals (e.g., the preferred proposal 1608, the first alternate proposal 1610, and the second alternate proposal 1612) includes the proposal options and the corresponding proposal recommendations. In an embodiment, the displayed proposals include various other user interface elements including, but not limited to, buttons to obtain additional details about the proposal recommendations, a button to accept the proposal, a button to reject the proposal, a button to look at the next proposal, and other such user interface elements. Additional details about these user interface elements are described below, in connection with FIG. 17. In an embodiment, user interface elements of the application 1604 can be used to obtain additional information about the project such as, for example, information about the factors used to prefer the preferred proposal 1608.

FIG. 17 shows an illustrative example of an environment 1700 in which a communicated proposal is received by a member in accordance with at least one embodiment. In the example illustrated in FIG. 17, additional details about the proposals (e.g., the preferred proposal 1608, the first alternate proposal 1610, and/or the second alternate proposal 1612) described in connection with FIG. 16 are presented. A preferred proposal 1702 (which is the same as the preferred proposal 1608 described in connection with FIG. 16) includes proposal options and corresponding proposal recommendations as described herein (e.g., a proposal recommendation to stay in the “Wine Cottage” for the “2-night Stay” proposal option).

In an embodiment, the preferred proposal 1702 includes a button 1704 to obtain more details about the proposal recommendation and/or the proposal option. For example, if the member presses the button 1704 to obtain more details about the proposal recommendation (e.g., the proposal recommendation to stay in the “Wine Cottage” for the “2-night Stay” proposal option), additional information including, but not limited to, the location of the Wine Cottage, reviews of the Wine Cottage, and other such information may be displayed for the member. In an embodiment, the preferred proposal 1702 includes a button 1706 to accept the proposal, a button 1708 to reject the proposal, and a button 1710 to display the next proposal. The button 1706 to accept the proposal may, for example, provide information back to the task facilitation service that the proposal is accepted by the member. Similarly, the button 1708 to reject the proposal may, for example, provide information back to the task facilitation service that the proposal is not accepted by the member. The button 1710 to display the next proposal may, for example, neither accept nor reject the proposal but may instead save the proposal for later acceptance or rejection. As may be contemplated, the operations whereby the member accepts or rejects proposals may be used by elements of the task facilitation service to update recommendation, ranking, and selection algorithms such as those described herein.

In an embodiment, systems and/or sub-systems of the task facilitation service can solicit additional information from the member regarding the proposals and/or proposal recommendations. For example, when a member uses the button 1706 to accept the preferred proposal 1702, systems and/or sub-systems of the task facilitation service may solicit additional information from the member as to why that proposal was accepted. Similarly, when a member uses the button 1708 to reject the preferred proposal 1702, systems and/or sub-systems of the task facilitation service may solicit additional information from the member as to why that proposal was rejected.

In an embodiment, this additional information is solicited by the representative. In an embodiment, this additional information is solicited automatically by systems and/or sub-systems of the task facilitation service (e.g., a proposal creation sub-system, a proposal ranking sub-system, a machine learning sub-system, and/or other such systems and/or sub-systems of the task facilitation service). In an embodiment, this additional information is solicited by a system dedicated to soliciting such information. As may be contemplated, this additional information may be used by elements of the task facilitation service in addition to the determination of whether the member accepts or rejects a proposal (e.g., by using the button 1706 to accept the preferred proposal 1702 or by using the button 1708 to reject the preferred proposal 1702) to update the recommendation, ranking, and selection algorithms such as those described herein. As may also be contemplated, this additional information may be used by elements of the task facilitation service instead of the determination of whether the member accepts or rejects a proposal to update the recommendation, ranking, and selection algorithms such as those described herein

In an embodiment, the additional information can be extracted automatically, continuously, dynamically, and/or in real-time from interactions between the member and the representative, from interactions between the member and systems and/or sub-systems of the task facilitation service, from interactions between the member and various third-party services, from interactions between the representative and systems and/or sub-systems of the task facilitation service, from interactions between the representative and various third-party services, and/or from other such interactions. As may be contemplated, a member may opt out of such solicitation (e.g., to reduce the cognitive load on the member) or opt in to such solicitation. As may also be contemplated, systems and/or sub-systems of the task facilitation service may dynamically determine whether to solicit such additional information based on changing member preferences and/or changing member cognitive load (e.g., when the member is very busy).

FIG. 18 illustrates a computing system architecture 1800, including various components in electrical communication with each other, in accordance with some embodiments. The example computing system architecture 1800 illustrated in FIG. 18 includes a computing device 1802, which has various components in electrical communication with each other using a connection 1806, such as a bus, in accordance with some implementations. The example computing system architecture 1800 includes a processing unit 1804 that is in electrical communication with various system components, using the connection 1806, and including the system memory 1814. In some embodiments, the system memory 1814 includes read-only memory (ROM), random-access memory (RAM), and other such memory technologies including, but not limited to, those described herein. In some embodiments, the example computing system architecture 1800 includes a cache 1808 of high-speed memory connected directly with, in close proximity to, or integrated as part of the processor 1804. The system architecture 1800 can copy data from the memory 1814 and/or the storage device 1810 to the cache 1808 for quick access by the processor 1804. In this way, the cache 1808 can provide a performance boost that decreases or eliminates processor delays in the processor 1804 due to waiting for data. Using modules, methods and services such as those described herein, the processor 1804 can be configured to perform various actions. In some embodiments, the cache 1808 may include multiple types of cache including, for example, level one (L1) and level two (L2) cache. The memory 1814 may be referred to herein as system memory or computer system memory. The memory 1814 may include, at various times, elements of an operating system, one or more applications, data associated with the operating system or the one or more applications, or other such data associated with the computing device 1802.

Other system memory 1814 can be available for use as well. The memory 1814 can include multiple different types of memory with different performance characteristics. The processor 1804 can include any general purpose processor and one or more hardware or software services, such as service 1812 stored in storage device 1810, configured to control the processor 1804 as well as a special-purpose processor where software instructions are incorporated into the actual processor design. The processor 1804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1804 can be a microprocessor, a microcontroller, a digital signal processor (“DSP”), or a combination of these and/or other types of processors. In some embodiments, the processor 1804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1800, an input device 1816 can represent any number of input mechanisms, such as a microphone for speech, a touch-sensitive screen for gesture or graphical input, keyboard, mouse, motion input, pen, and other such input devices. An output device 1818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1800. In some embodiments, the input device 1816 and/or the output device 1818 can be coupled to the computing device 1802 using a remote connection device such as, for example, a communication interface such as the network interface 1820 described herein. In such embodiments, the communication interface can govern and manage the input and output received from the attached input device 1816 and/or output device 1818. As may be contemplated, there is no restriction on operating on any particular hardware arrangement and accordingly the basic features here may easily be substituted for other hardware, software, or firmware arrangements as they are developed.

In some embodiments, the storage device 1810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1810 can include hardware and/or software services such as service 1812 that can control or configure the processor 1804 to perform one or more functions including, but not limited to, the methods, processes, functions, systems, and services described herein in various embodiments. In some embodiments, the hardware or software services can be implemented as modules. As illustrated in example computing system architecture 1800, the storage device 1810 can be connected to other parts of the computing device 1802 using the system connection 1806. In an embodiment, a hardware service or hardware module such as service 1812, that performs a function can include a software component stored in a non-transitory computer-readable medium that, in connection with the necessary hardware components, such as the processor 1804, connection 1806, cache 1808, storage device 1810, memory 1814, input device 1816, output device 1818, and so forth, can carry out the functions such as those described herein.

The disclosed systems and service of a task facilitation service (e.g., the task facilitation service 102 described herein at least in connection with FIG. 1) can be performed using a computing system such as the example computing system illustrated in FIG. 18, using one or more components of the example computing system architecture 1800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for communicating proposals associated with a task facilitation service (e.g., the task facilitation service 102 described herein at least in connection with FIG. 1) described herein by, for example, executing code using a processor such as processor 1804 wherein the code is stored in memory such as memory 1814 as described herein. One or more of a user device, a provider server or system, a database system, or other such devices, services, or systems may include some or all of the components of the computing system such as the example computing system illustrated in FIG. 18, using one or more components of the example computing system architecture 1800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1814 can be coupled to the processor 1804 by, for example, a connector such as connector 1806, or a bus. As used herein, a connector or bus such as connector 1806 is a communications system that transfers data between components within the computing device 1802 and may, in some embodiments, be used to transfer data between computing devices. The connector 1806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1814 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1814 can also include magnetic or optical data storage media including read-only (e.g., CD ROM and DVD ROM) or otherwise (e.g., CD or DVD). The memory can be local, remote, or distributed.

As described above, the connector 1806 (or bus) can also couple the processor 1804 to the storage device 1810, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1806 can also couple the processor 1804 to a network interface device such as the network interface 1820. The interface can include one or more of a modem or other such network interfaces including, but not limited to those described herein. It will be appreciated that the network interface 1820 may be considered to be part of the computing device 1802 or may be separate from the computing device 1802. The network interface 1820 can include one or more of an analog modem, Integrated Services Digital Network (ISDN) modem, cable modem, token ring interface, satellite transmission interface, or other interfaces for coupling a computer system to other computer systems. In some embodiments, the network interface 1820 can include one or more input and/or output (I/O) devices. The I/O devices can include, by way of example but not limitation, input devices such as input device 1816 and/or output devices such as output device 1818. For example, the network interface 1820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1802 can be connected to one or more additional computing devices such as computing device 1824 via a network 1822 using a connection such as the network interface 1820. In such embodiments, the computing device 1824 may execute one or more services 1826 to perform one or more functions under the control of, or on behalf of, programs and/or services operating on computing device 1802. In some embodiments, a computing device such as computing device 1824 may include one or more of the types of components as described in connection with computing device 1802 including, but not limited to, a processor such as processor 1804, a connection such as connection 1806, a cache such as cache 1808, a storage device such as storage device 1810, memory such as memory 1814, an input device such as input device 1816, and an output device such as output device 1818. In such embodiments, the computing device 1824 can carry out the functions such as those described herein in connection with computing device 1802. In some embodiments, the computing device 1802 can be connected to a plurality of computing devices such as computing device 1824, each of which may also be connected to a plurality of computing devices such as computing device 1824. Such an embodiment may be referred to herein as a distributed computing environment.

The network 1822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1822 can be wired connections, wireless connections, or combinations thereof. Communications via the network 1822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1822, within the computing device 1802, within the computing device 1824, or within the computing resources provider 1828 can include information, which also may be referred to herein as content. The information may include text, graphics, audio, video, haptics, and/or any other information that can be provided to a user of the computing device such as the computing device 1802. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1802 and presented to a user of the computing device 1802 using forms that are perceptible via sight, sound, smell, taste, touch, or other such mechanisms. In some embodiments, communications over the network 1822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1802 and/or the computing device 1824 can be connected to a computing resources provider 1828 via the network 1822 using a network interface such as those described herein (e.g. network interface 1820). In such embodiments, one or more systems (e.g., system 1830 and system 1832) hosted within the computing resources provider 1828 (also referred to herein as within “a computing resources provider environment”) may execute one or more services to perform one or more functions under the control of, or on behalf of, programs and/or services operating on computing device 1802 and/or computing device 1824. Systems such as system 1830 and system 1832 may include one or more computing devices such as those described herein to execute computer code to perform the one or more functions under the control of, or on behalf of, programs and/or services operating on computing device 1802 and/or computing device 1824.

For example, the computing resources provider 1828 may provide a service, operating on system 1830 to store data for the computing device 1802 when, for example, the amount of data that the computing device 1802 exceeds the capacity of storage device 1810. In another example, the computing resources provider 1828 may provide a service to first instantiate a virtual machine (VM) on system 1832, use that VM to access the data stored on system 1832, perform one or more operations on that data, and provide a result of those one or more operations to the computing device 1802. Such operations (e.g., data storage and VM instantiation) may be referred to herein as operating “in the cloud,” “within a cloud computing environment,” or “within a hosted virtual machine environment,” and the computing resources provider 1828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as system 1830 and system 1832 may implement versions of various services (e.g., the service 1812 or the service 1826) on behalf of, or under the control of, computing device 1802 and/or computing device 1824. Such implemented versions of various services may involve one or more virtualization techniques so that, for example, it may appear to a user of computing device 1802 that the service 1812 is executing on the computing device 1802 when the service is executing on, for example, system 1830. As may also be contemplated, the various services operating within the computing resources provider 1828 environment may be distributed among various systems within the environment as well as partially distributed onto computing device 1824 and/or computing device 1802.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1802) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 900 for generating proposal recommendations for a task and for generating a ranking of those proposal recommendations that can be used to determine what proposals are to be presented to a member as illustrated in FIG. 9). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary operations (e.g., a computer-program product) may be stored in a computer-readable or machine-readable storage medium (e.g., a medium for storing program code or code segments) such as those described herein. A processor(s), implemented in an integrated circuit, may perform the necessary operations.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a completed task template corresponding to a task associated with a member, wherein the completed task template is associated with a task type;
automatically generating in real-time a set of proposals corresponding to the task, wherein the set of proposals are automatically generated based on the task type and a member profile associated with the member;
generating a ranking of the set of proposals, wherein the ranking is generated based on suitability metrics between the task and the set of proposals;
selecting one or more proposals from the set of proposals, wherein the one or more proposals are selected based on the ranking and the suitability metrics;
providing the one or more proposals; and
updating the member profile in real-time based on member interaction with the one or more proposals.

2. The computer-implemented method of claim 1, further comprising:
automatically processing the member profile in real-time to determine the suitability metrics between the task and the set of proposals.

3. The computer-implemented method of claim 1, wherein the one or more proposals are further selected based on a pre-defined number of proposals presentable for the task, and wherein the pre-defined number is determined based on the member profile.

4. The computer-implemented method of claim 1, further comprising:
automatically designating a preferred proposal from the one or more proposals, wherein the preferred proposal is automatically designated based on the ranking, the suitability metrics, and the member profile.

5. The computer-implemented method of claim 1, further comprising:
providing the suitability metrics with the one or more proposals.

6. The computer-implemented method of claim 1, further comprising:
monitoring the member interaction with the one or more proposals in real-time to determine one or more preferences corresponding to a presentation of the one or more proposals; and
automatically updating the member profile based on the one or more preferences.

7. The computer-implemented method of claim 1, further comprising:
detecting a modification to a subset of the set of proposals; and
automatically updating the ranking in real-time based on the modification.

8. A system, comprising:
one or more processors; and
memory storing thereon instructions that, as a result of being executed by the one or more processors, cause the system to:
receive a completed task template corresponding to a task associated with a member, wherein the completed task template is associated with a task type;
automatically generate in real-time a set of proposals corresponding to the task, wherein the set of proposals are automatically generated based on the task type and a member profile associated with the member;
generate a ranking of the set of proposals, wherein the ranking is generated based on suitability metrics between the task and the set of proposals
select one or more proposals from the set of proposals, wherein the one or more proposals are selected based on the ranking and the suitability metrics;
provide the one or more proposals; and
update the member profile in real-time based on member interaction with the one or more proposals.

9. The system of claim 8, wherein the instructions further include instructions that, as a result of being executed by the one or more processors, cause the system to:
automatically process the member profile in real-time to determine the suitability metrics between the task and the set of proposals.

10. The system of claim 8, wherein the one or more proposals are further selected based on a pre-defined number of proposals presentable for the task, and wherein the pre-defined number is determined based on the member profile.

11. The system of claim 8, wherein the instructions further include instructions that, as a result of being executed by the one or more processors, cause the system to:
automatically designate a preferred proposal from the one or more proposals, wherein the preferred proposal is automatically designated based on the ranking, the suitability metrics, and the member profile.

12. The system of claim 8, wherein the instructions further include instructions that, as a result of being executed by the one or more processors, cause the system to:
provide the suitability metrics with the one or more proposals.

13. The system of claim 8, wherein the instructions further include instructions that, as a result of being executed by the one or more processors, cause the system to:
monitor the member interaction with the one or more proposals in real-time to determine one or more preferences corresponding to a presentation of the one or more proposals; and
automatically update the member profile based on the one or more preferences.

14. The system of claim 8, wherein the instructions further include instructions that, as a result of being executed by the one or more processors, cause the system to:
detect a modification to a subset of the set of proposals; and
automatically update the ranking in real-time based on the modification.

15. A non-transitory, computer-readable storage medium storing thereon executable instructions that, as a result of being executed by a computer system, cause the computer system to:
receive a completed task template corresponding to a task associated with a member, wherein the completed task template is associated with a task type;
automatically generate in real-time a set of proposals corresponding to the task, wherein the set of proposals are automatically generated based on the task type and a member profile associated with the member;
generate a ranking of the set of proposals, wherein the ranking is generated based on suitability metrics between the task and the set of proposals
select one or more proposals from the set of proposals, wherein the one or more proposals are selected based on the ranking and the suitability metrics;
provide the one or more proposals; and
update the member profile in real-time based on member interaction with the one or more proposals.

16. The non-transitory, computer-readable storage medium of claim 15, wherein the executable instructions further comprising instructions that, as a result of being executed by a computer system, cause the computer system to:
automatically process the member profile in real-time to determine the suitability metrics between the task and the set of proposals.

17. The non-transitory, computer-readable storage medium of claim 15, wherein the one or more proposals are further selected based on a pre-defined number of proposals presentable for the task, and wherein the pre-defined number is determined based on the member profile.

18. The non-transitory, computer-readable storage medium of claim 15, wherein the executable instructions further comprising instructions that, as a result of being executed by a computer system, cause the computer system to:
automatically designate a preferred proposal from the one or more proposals, wherein the preferred proposal is automatically designated based on the ranking, the suitability metrics, and the member profile.

19. The non-transitory, computer-readable storage medium of claim 15, wherein the executable instructions further comprising instructions that, as a result of being executed by a computer system, cause the computer system to:
provide the suitability metrics with the one or more proposals.

20. The non-transitory, computer-readable storage medium of claim 15, wherein the executable instructions further comprising instructions that, as a result of being executed by a computer system, cause the computer system to:
monitor the member interaction with the one or more proposals in real-time to determine one or more preferences corresponding to a presentation of the one or more proposals; and
automatically update the member profile based on the one or more preferences.

21. The non-transitory, computer-readable storage medium of claim 15, wherein the executable instructions further comprising instructions that, as a result of being executed by a computer system, cause the computer system to:
detect a modification to a subset of the set of proposals; and
automatically update the ranking in real-time based on the modification.
